(19) United States
(12) Patent Application Publication
(10) Pub. No.: US 2005/0171863 A1
(43) Pub. Date: Aug. 4, 2005

(54) System and computerized method for classified ads

(76) Inventor: Philip A. Hagen, Washington, DC (US)

Correspondence Address: LITMAN LAW OFFICES, LTD, PO BOX 15035, CRYSTAL CITY STATION, ARLINGTON, VA, 22215, US

(21) Appl. No.: 11/098,672

(22) Filed: Apr. 5, 2005

Related U.S. Application Data
(63) Continuation-in-part of application No. 10/015,698, filed on Dec. 17, 2001.
(60) Provisional application No. 60/255,929, filed on Dec. 15, 2000.

(51) Int. Cl. G06F 17/60

(52) U.S. Cl. 705/26

(57) ABSTRACT

A system and/or computerized method for classified ads. The system is used for updating an ad profile, setting system variables, general variables, appearance variables, ad banner variables and multimedia variables, establishing a fee based ad arrangement, registering a user, setting up maintenance options and setting up a backup manager, a visibility options manager and a priority ranking options manager and setting up an affiliated Web site and an auto-notify function.

### CROSS-REFERENCE TO RELATED APPLICATIONS

This is a continuation-in-part of U.S. patent application Ser. No. 10/015,698, filed Dec. 17, 2001, which claims the benefit of U.S. Provisional Patent Application Ser. No. 60/255,929, filed Dec. 15, 2000, each of which is incorporated herein by reference.

### BACKGROUND OF THE INVENTION

1. Field of the Invention

The present invention relates to a system and/or computerized method for classified ads.

2. Description of Related Art

The expansion and development of the Internet has changed the way people do business. Many “bricks and mortar” businesses have found that they can efficient use the Internet regarding a wide host of business applications. One of the most pronounced changes is in the way buyers and sellers of merchandise do business and carry out buying transactions. This is also reflected in the prior art.

U.S. Pat. No. 5,592,375, issued Jan. 7, 1997 to Bardwell C. Salmon et al., describes a computer implemented system for brokering transactions between sellers and a buyer of goods or services, including a database, a seller interface and a buyer interface. The database contains information, including multimedia information, descriptive of the respective goods or services. The seller interface enables the sellers to interactively enter information, including multimedia information, into the database.

U.S. Pat. No. 5,745,882, issued Apr. 28, 1998 to Matthew J. Bixler et al., describes an interface for an electronic classified advertising system. The interface includes the capability for the user to enter search criteria for an item of interest, to save the search criteria and to be notified by the system when an item matching the search criteria is entered into the system.

U.S. Pat. No. 6,058,417, issued May 2, 2000 to Martin L. Hess et al., describes a method and system for information presentation and management in an online trading environment. Person-to-person commerce over the Internet is facilitated by providing prospective buyers the ability to quickly preview items for sale. Images are harvested from a plurality of sites based upon user supplied information. This information includes descriptions of items for sale and locations from which images that are to be associated with the items can be retrieved.

U.S. Pat. No. 6,128,651, issued Oct. 3, 2000 to Robert M. Cezar, describes a non-scrolling ad display that is lodged in a Web site to undertake centrally controlled and recorded ad displays for guaranteed minimum timed intervals. The system enables precise controlled advertising to each web page viewing browser and accurate advertising budget and programming, which can be monitored and upgraded to meet marketing needs.

U.S. Pat. No. 6,161,127, issued Dec. 12, 2000 to Robert M. Cezar et al., describes a central system controller that prepares a list of ads to be played, the list being prepared from an “ad played” database maintained at the system controller. This “to be played list” includes ad identity and an ad Internet address. This “to be played list” is first computed and thereafter lodged in the central system controller at peripheral Web servers for distribution to browsers.

Although each of these patents outline a business method patent that deals with advertising on the Internet, none of these patents have a real-time system that consider ads that are easier for sellers to enter and buyers to access than what is currently being done by the previously described patents. An Internet advertising patent that can do this would be clearly advantageous to current buyers and sellers of merchandise in the marketplace.

None of the above inventions and patents, taken either singularly or in combination, is seen to describe the instant invention as claimed. Thus a system and computerized method for classified ads solving the aforementioned problems is desired.

### SUMMARY OF THE INVENTION

The present invention is a system and/or computerized method for classified ads. The system is used for updating an ad profile, setting system variables, general variables, appearance variables, ad banner variables and multimedia variables, establishing a fee based ad arrangement, registering a user, setting up maintenance options and setting up a backup manager, a visibility options manager and a priority ranking options manager and setting up an affiliated Web site and an auto-notify function.

Accordingly, it is a principal aspect of the invention to provide a computer based system for presenting classified ads that is more convenient for end users to use.

It is another aspect of the invention to provide the ability to search all of the information in an ad using conventional text database techniques using the convenience of audio and video output.

It is a further aspect of the invention to search new ads in a real time system.

It is an aspect of the invention to provide improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a block diagram of the client/server architecture of the system according to the present invention.

FIG. 2 is a block diagram of the Web server executing the system according to the present invention.

FIG. 3A is a screen print-out of the different Ad Sections of the system according to the present invention.

FIG. 3B is a screen print-out of the Navigation structure of the system according to the present invention.

FIGS. 4A and 4B are a screen print-out of the Update Profile form according to the present invention.

FIGS. 5a and 5B are a screen print-out depicting the Control Panel of the system according to the present invention.

FIG. 6 is a screen print-out of the General Variables Section of the Control Panel according to the present invention.

FIGS. 7A, 7B, 7C, and 7D are a screen print-out of the General Variables Section of the Control Panel according to the present invention.

FIGS. 8A, 8B, and 8C are a screen print-out of the Appearance Variable Section of the Control Panel according to the present invention.

FIGS. 9A and 9B are a screen print-out of the Ad Banner Variables Section of the Control Panel according to the present invention.

FIG. 10 is a screen print-out of the Multimedia Variables Section of the Control Panel according to the present invention.

FIGS. 11A, 11B, 11C, 11D, and 11E are a screen print out of the Fee Based Options Section of the Control Panel according to the present invention.

FIGS. 12A and 12B are a screen print-out of the Registration Settings of the Control Panel according to the present invention.

FIGS. 13A and 13B are a screen print-out of the Maintenance Settings of the Control Panel according to the present invention.

FIG. 14 is a screen print-out of the Backup Manager Section of the Control Panel according to the present invention.

FIG. 15 is a screen print-out of the Visibility Options Section of the Control Panel according to the present invention.

FIG. 16 is a screen print-out of the Priority Ranking Options Section of the Control Panel according to the present invention.

FIGS. 17A, 17B, 17C, and 17D are a screen print-out of the Template editor of the Control Panel according to the present invention.

FIGS. 18A, 18B, and 18C are a screen print-out of a sample real estate ad according to the present invention.

FIGS. 19A, 19B, 19C, and 19D are a screen print-out of the Power Search form according to the present invention.

FIGS. 20A and 20B are a screen print-out of the Variable Settings Section for a specific category of the Control Panel according to the present invention.

FIGS. 21A, 21B, and 21C are a screen print-out of the Database Definition File according to the present invention.

FIG. 22 is a flow chart illustrating the template editor.

FIG. 23 is a flow chart illustrating the concept and creation of affiliate web sites.

FIG. 24 is a flow chart illustrating the auto-notify personal search agent.

Similar reference characters denote corresponding features consistently throughout the attached drawings.

### DETAILED DESCRIPTION OF THE PREFERRED EMBODIMENTS

The present invention is a system and/or computerized method for classified ads. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

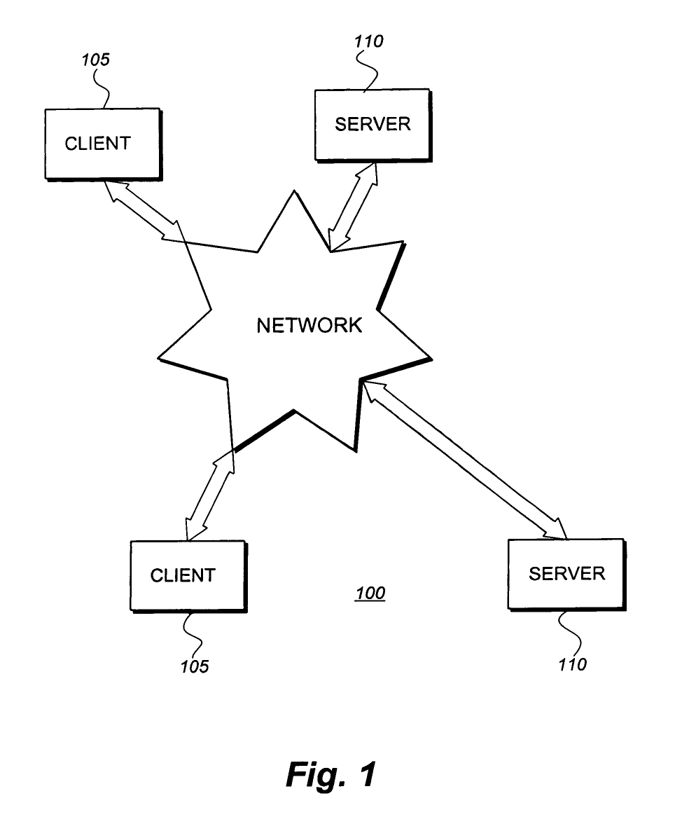

A preferred embodiment of the present invention is illustrated in FIG. 1, which is a simplified view of an exemplary client-server environment, such as the World Wide Web (the Web), in which online classified advertising may take place.

The architecture of the Web follows a conventional client-server model. The terms “client” and “server” are used to refer to a computer's general role as a requester of data (the client) or provider of data (the server). Web Clients 105 and Web Servers 110 communicate using a protocol such as Hypertext Transfer Protocol (HTTP). In the Web environment, Web browsers reside on clients and render Web documents (pages) served by the Web servers. The Client-Server model is used to communicate information between Clients 105 and Servers 110. Web Servers 110 are coupled to the Internet 100 and respond to document requests and/or other queries from Web Clients 105. When an end user selects a document by submitting its Uniform Resource Locator (URL), a Web browser, such as Netscape Navigator or Internet Explorer, opens a connection to a server and initiates a request (e.g., an HTTP get) for the document. The Server 110 delivers the requested document, typically in the form of a text document coded in a standard markup language such as Hypertext Markup Language (HTML).

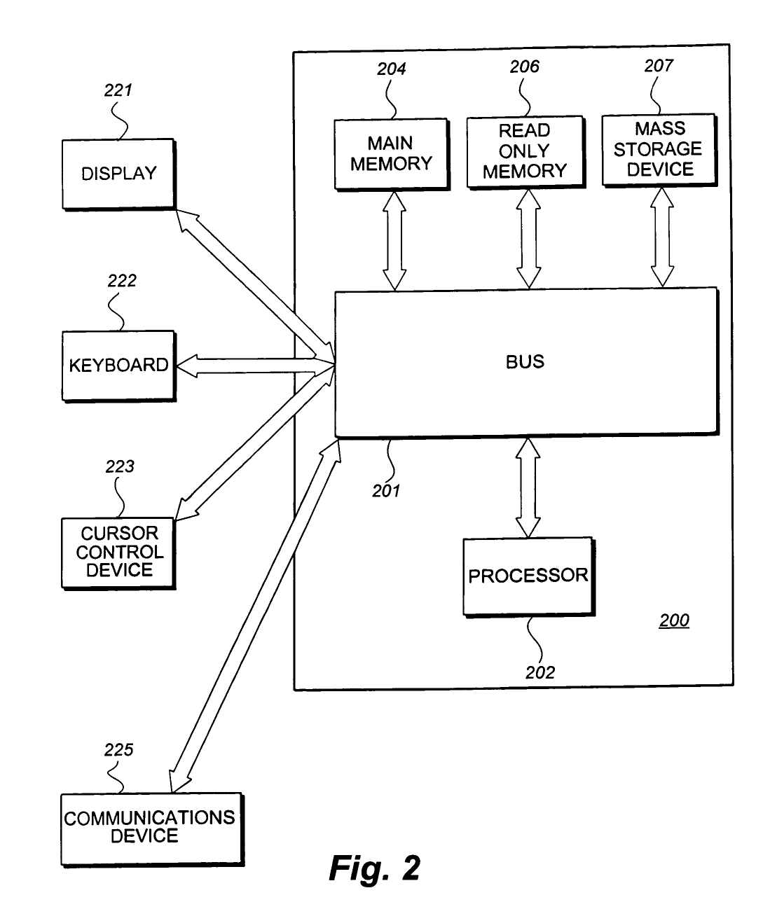

A computer Web Server 200 representing an exemplary server in which features of the present invention may be implemented will now be described with reference to FIG. 2. Computer Web Server 200 comprises a Bus or other communication means 201 for communicating information, and a processing means such as Processor 202 coupled with the Bus 201 for processing information. The computer Web Server 200 further comprises a random access memory (RAM) or other dynamic storage device 204 (referred to as main memory), coupled to the Bus 201 for storing information and instructions to be executed by processor 202. Main Memory 204 also may be used for storing temporary variables or other intermediate information during execution of instructions by the Processor 202. An exemplary form of a Processor 202 is an Intel Pentium III 866 megahertz processor. The computer Web Server 200 also comprises a read only memory (ROM) and/or other static storage device 206 coupled to the Bus 201 for storing static information and instructions for the Processor 202.

A Mass Storage Device 207 such as a magnetic disk or optical disc and its corresponding drive may also be coupled to the computer Web Server 200 for storing information and instructions. The computer Web Server 200 can also be coupled via Bus 201 to a Display 221, such as a cathode ray tube (CRT) or liquid crystal display (LCD), for displaying information to an end user. Typically, a Keyboard 222, including alphanumeric and other keys, may be coupled to the Bus 201 for communicating information and/or command selections to the Processor 202. Another type of end user input device is a Cursor Control Device 223, such as a mouse, a trackball, or cursor direction keys for communicating direction information and command selections to the Processor 202 and for controlling cursor movement on the Display 221.

A Communications Device 225 is also coupled to the Bus 201 for accessing remote servers via the Internet, for example. The Communications Device 225 may include a modem, a network interface card, or other commercially available network interface devices, such as those used for coupling to an Ethernet, token ring, or other type of network. In any event, in this manner, the computer Web Server 200 may be coupled to a number of clients and/or other servers via a conventional network infrastructure, such as a company's Intranet and/or the Internet, for example.

The computer Web Server 200 contains either variants of the Unix server operating system (including Linux and FreeBSD) or Windows NT/Windows 2000 server operating systems. The Web Server 200 has Perl 5 installed and functioning properly. The administrator also has the rights to upload files to the server using File Transfer Protocol (FTP) or some other method, and the administrator has the rights to run Common Gateway Interface (CGI) systems on the server. Some versions may also use specific Perl modules to use certain optional features such as real time credit card processing. Alternative system operating software is also expected to be available.

In the preferred embodiment, the steps of the present invention are embodied in machine-executable instructions. The instructions can be used to cause the general-purpose or special-purpose processor such as the computer Web Server 200 which is programmed with the instructions to perform the steps of the present invention.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

The instructions are contained in several types of distinct files: a main executable file named classifieds.cgi, database files, configuration files, backups of the configuration files, image files and library files. These instructions contained in the classifieds.cgi executable file are primarily off-loaded into separately loadable libraries that are accessed only as needed. This modularization greatly enhances the speed of the system. Furthermore, the output of the system is contained in separate files from the programming code.

As illustrated and described in greater detail below, the operation of this system presents unique features. The current system allows for easily customizable and configurable input and output for both administrators and end users. These customization and configuration tools are accessed from an integrated point and click web based interface. This makes the system an advancement in many areas of classified advertising such as posting and searching ads, categorization of ads and the administration of ads. While the embodiments of the system will be described with respect to an electronic classifieds application, the method and apparatus are equally relevant to other applications in which information is posted, categorized, transacted, administered and searched such as electronic message boards, electronic shopping carts, electronic auctions, electronic banner ad management, affiliate signup and tracking, electronic help desk, electronic calendars, electronic membership management, other types of databases, etc.

The operation of the system shown in FIG. 1 and FIG. 2 is outlined in the flow charts and illustrations of the remaining figures. The operations will be presented in the typical chronological order of installation, configuration by the administrator, end user activities and maintenance by the administrator.

The principal functions that the user may request depend upon whether the user is the administrator or an end user. In the following description, it will be assumed that an administrator (also known as “admin”) sets up a Web site medium in order to list items that are often found in newspaper classifieds such as tangible property (real estate, automobiles, etc.) or information. There are also non-administrative “end users” (hereinafter “end users” or “end user”) who wish to list property through this medium to other “end users” who want to interact with this property or information such as purchasing, renting, exchanging or merely viewing these items. However, the present invention is equally applicable to the purchasing, renting, viewing of any type of real or personal property such as boats and houses, to employment (i.e., listing of positions available or positions wanted), to personal ads, to the offering of services, to locating persons with specified knowledge or interests, etc.

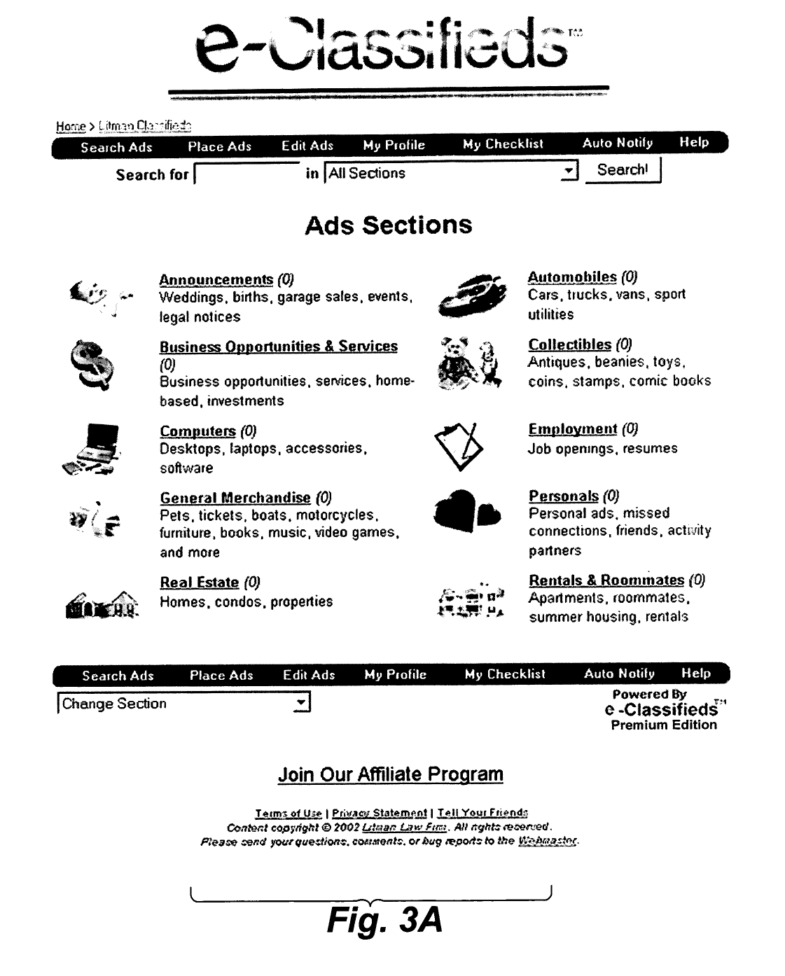

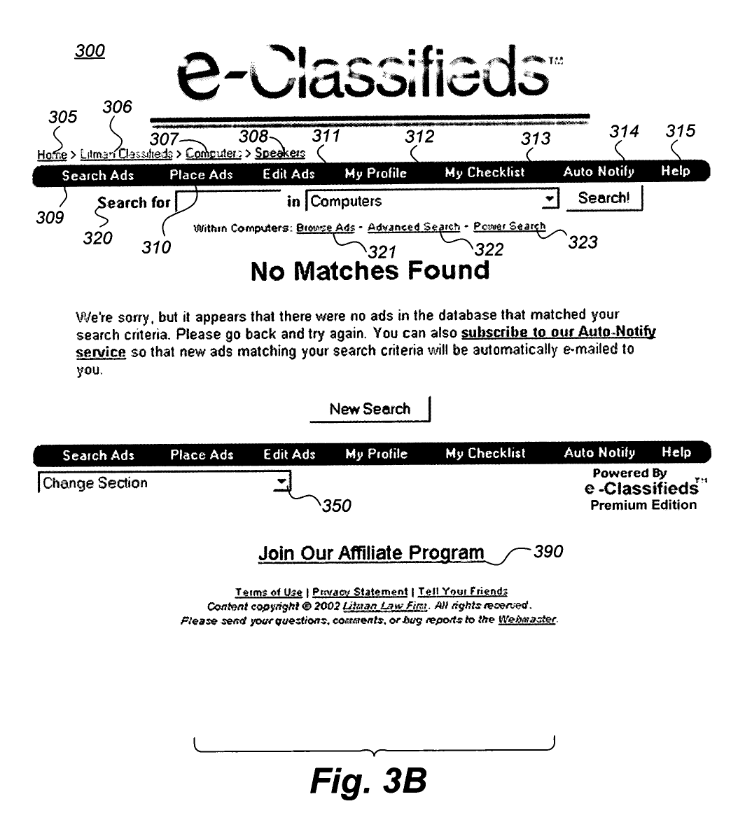

As illustrated in FIGS. 3A and 3B, all of the system functions are available from the Navigation Bars 300 that appear either at the top and/or the bottom of each page in default format, or along the left side of the page.

The system is navigated through a multi-tier hierarchical structure compromising a top level sections menu and lower tier categories menu(s). Above the navigation bars are links to the Overall Site Home Page 305 and the System's Home Page 306, the Current Section 307 and Category 308. A Sections Menu is also accessible from various other locations including a pull down menu 350.

The “Search Ads” link 309 takes the administrator or end user back to the front page, so that the administrator or end user can search for ads by section (category) and subcategory. The “Place Ads” link 310 allows the administrator or end user to post new ads to the system. The “Edit Ads” link 311 allows the administrator or end user to modify ads, renew ads, delete ads, or add or modify multimedia files to ads. The “My Profile” link 312 allows the administrator or end user to register for an account or to update registration information at any time.

The “My Checklist” link 313 will display all ads that the end user has added to the checklist (Ads that have been marked for future recall and viewing by the system). The “Auto Notify” link 314 allows the administrator or end user to create, modify, or delete a personal search agent that automatically sends new ads by e-mail that match pre-defined criteria. The “Help” link 315 causes a pop-up help window to appear. In many areas of the system, this contains context-sensitive help information related to the topic or page that the administrator or end user is on (such as help on placing ads when the end user is on the ads posting form).

Beneath or within the navigation bar is a Search Box 320 that allows the administrator or end user to search for ads by keywords within any or all sections. Beneath this search box are three more links. To quickly see all ads, just click on the “Browse Ads” link 321. For more advanced searches by keywords, including Boolean options, case-sensitive searching, date-range searching, and searching for ads with photos, click on the “Advanced Search” link 322. For powerful full database searches on specific criteria and within specific ranges, click on the “Power Search” link 323. The navigation bar includes navigation arrows and buttons below the search results to help end users quickly jump to different sections of the search results without having to keep hitting the “Next” button.

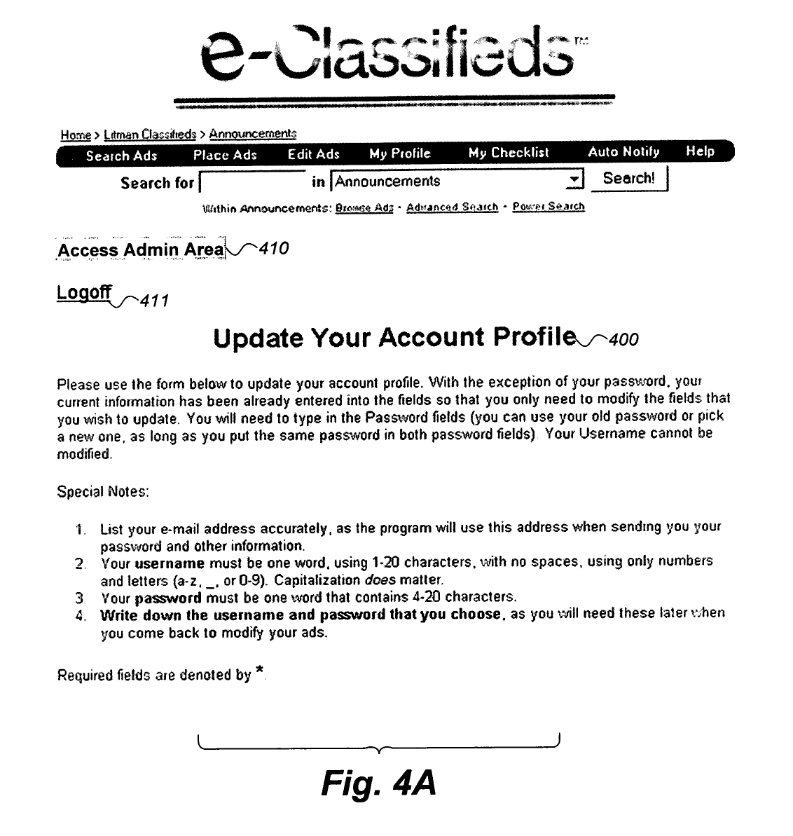

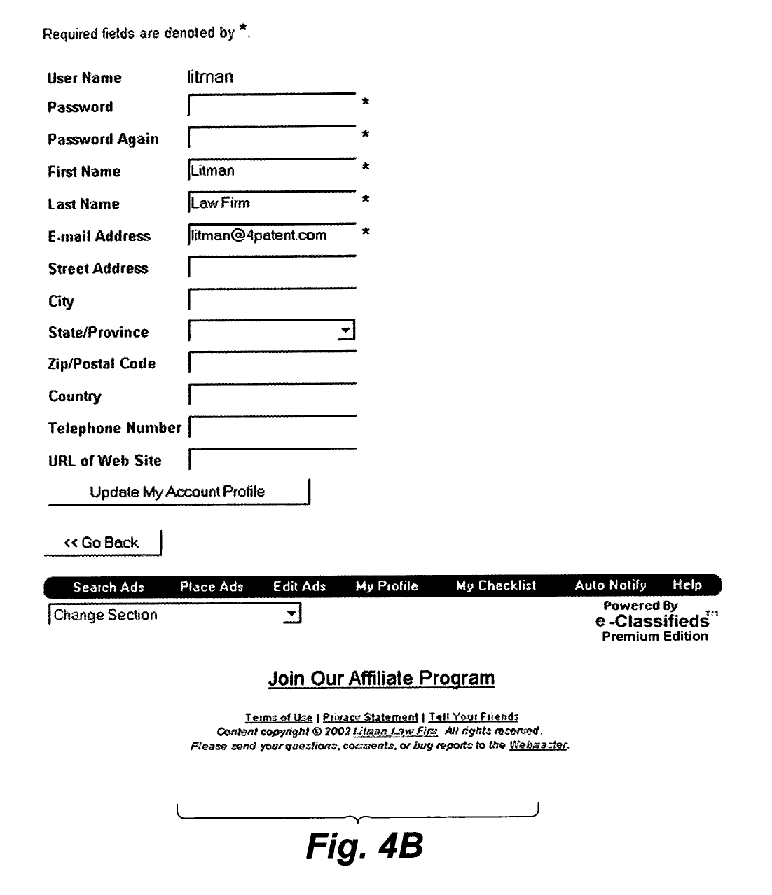

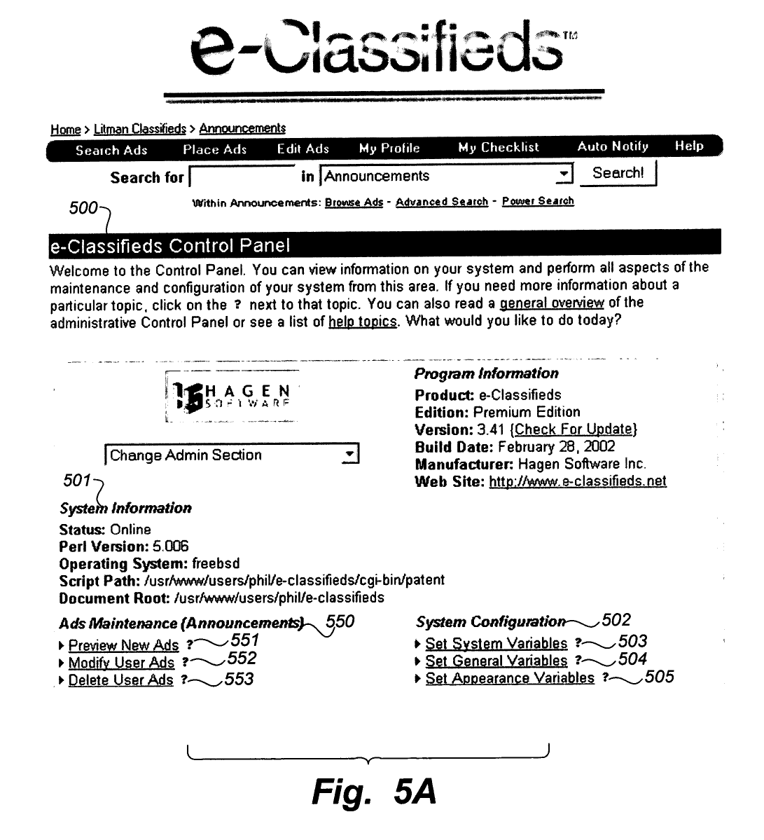

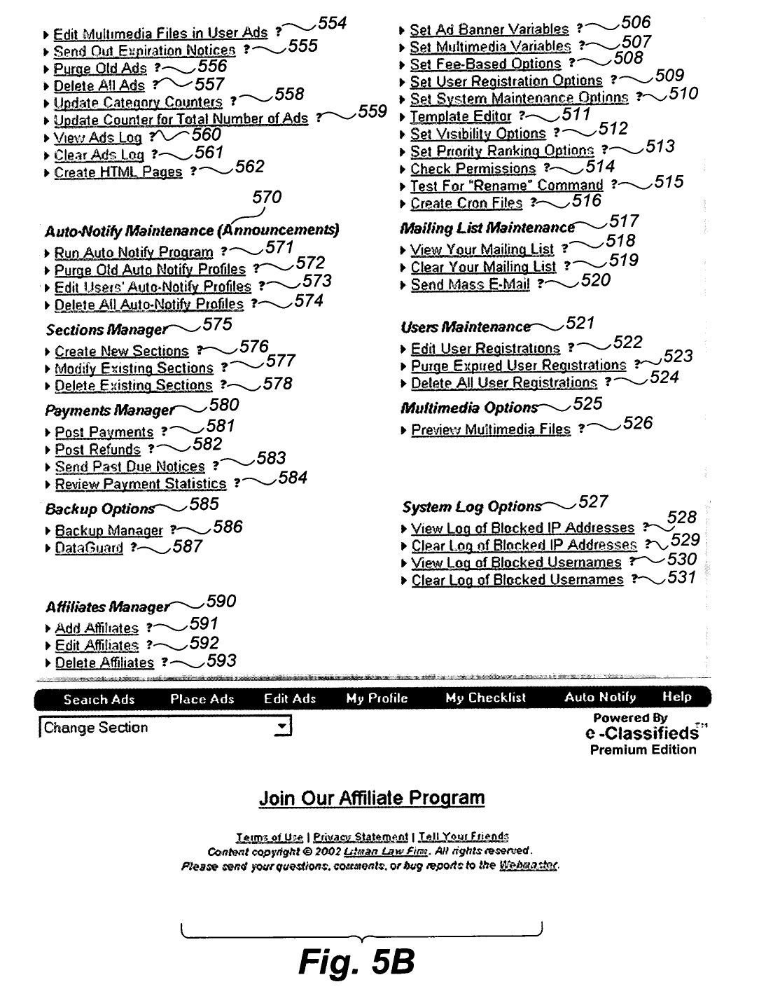

The control panel 500 (see FIGS. 5A and 5B) enables an administrator to maintain and configure all aspects of the system. The various options are divided into groups of related functions within the control panel 500. The administrator needs to log in as the administrator to access the control panel and these functions. The administrator can access the control panel 500 by clicking on the “My Profile” link 312 in the navigation bar. If the administrator has not already logged in, the administrator is prompted to do so. The administrator enters his or her username and password in the logon form. After logging in, the administrator will see the “Update Profile” page 400 as illustrated in FIGS. 4A and 4B. The “Access Admin Area” link 410 located near the top of the page is clicked in order to access the control panel. Located underneath the “Access Admin Area” Link 410 is a “Logoff” Link 411 which provides for greater security when accessing the system at remote locations such as airports.

As illustrated in FIGS. 5A and 5B and described in greater detail below, the control panel 500 enables the administrator (and not the end user) to set system variables, general variables, appearance variables, ad banner variables, multimedia variables, fee-based options, end user registration options, and system maintenance options. It also allows the administrator to add, modify, or remove sections, edit templates, set visibility and priority ranking options, perform various diagnostic tests, approve new ads posted by end users, approve new multimedia files uploaded by end users, modify any ad posted by any end user, delete any ad posted by any end user, send out expiration notices by e-mail to end users whose ads are about to expire, purge old ads, update various counters, view and clear various logs, build static HTML pages for ads, run the Auto-Notify system, purge old Auto-Notify profiles that have expired, edit end users' auto-notify profiles, manage the user registration database, backup important data files, add, modify, or delete affiliate Web sites, view the mailing list, clear the mailing list, and send a mass e-mail to end users who have signed up for the mailing list by clicking the checkbox on the “Post an Ad” form.

The System Information section 501 of the control panel 500 provides information about the system that the administrator is using, such as the name of this version, the version number, and the build date for this version. The administrator can also check for updates to the particular version of the system by clicking on the “Check For Update” link next to the version number.

The System Configuration section 502 of the control panel 500 enables the administrator to define the various settings for the system including the System Variables 503, General Variables 504, Appearance Variables 505, Ad Banner Variables 506, Multimedia Variables 507, Fee Based Options 508, User Registration Options 509, System Maintenance Options 510, Template Editor 511, Visibility Options 512, and Priority Ranking Options 513. The administrator can also Check Permissions 514, Test for the “rename” Command 515 and Create Cron Files 516. The variables contained in the system configuration section are described in greater detail below.

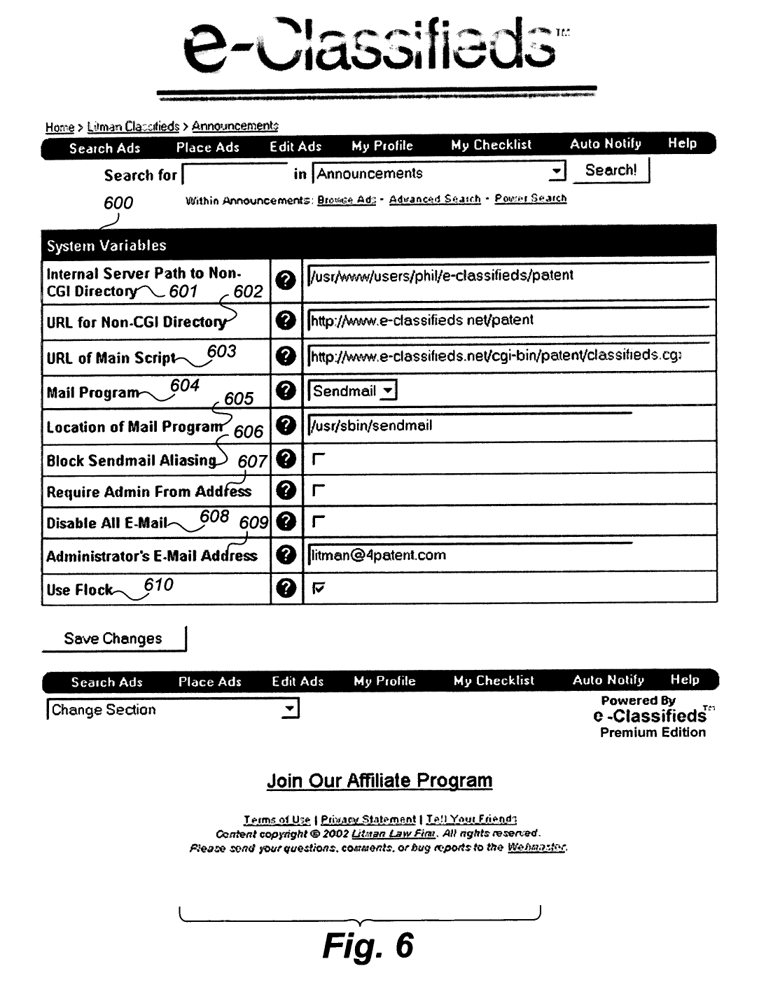

An exemplary form 600 of the setting system variables section is illustrated in FIG. 6. The Internal Server Path to Non-CGI Directory 601 variable specifies the full internal server path (not a URL) to this directory that the administrator created outside of the CGI-bin. This is the directory that the “graphics”, “html”, “pending”, and “upload” directories can be stored beneath. These directories store the various graphic buttons and icons used by the system (the “graphics” subdirectory), the HTML pages for the ads if the administrator is using this option (the “html” subdirectory), and the multimedia files that end users upload with their ads once the uploads have been approved by the system (the “pending” and “upload” directories). The administrator can also create a directory under the “html” directory for each language that the administrator is using (“english” is the default directory).

The URL for Non-CGI Directory 602 is set to the URL of the directory that the administrator specified above as the location where the “graphics”, “html”, “pending”, and “upload” subdirectories are stored. The trailing slash is not added at the end. The System URL 603 points to the full URL of the main executable file (usually, the “classifieds.cgi” file). The Mail Program 604 is set to the correct mail system for the server. There are four valid values here:

Sendmail indicates that the administrator is running on a Unix server and that the administrator will be using the sendmail system.

Blat indicates that the administrator is running on a Windows NT/2000 server and that the administrator will be using the Blat mail system.

Windmail indicates that the administrator is running on a Windows NT/2000 server and that the administrator will be using the Windmail system.

SMTP (Simple Mail Transport Protocol) indicates that the administrator wants to use the sockets-based e-mail subroutines. These can be used on either Unix or Windows NT Web servers, provided that the administrator has an SMTP mail server and that the administrator has properly specified it in the Location of Mail Program variable below.

The Block Sendmail Aliasing 606 is applicable if the administrator is using the Unix sendmail system. The administrator has the option of telling sendmail not to use the alias list for the Unix server. This is a security measure to keep outsiders from using the alias list of the Web server. Thus, in most cases, the administrator wants to check this box. If e-mail addresses are being aliased on the server, however, then the administrator ensures this box is unchecked, in order to allow aliasing.

The Require Admin From Address 607 variable applies if the administrator is having problems with certain routines (such as posting, modifying, or deleting ads), which could be because the server does not allow outgoing e-mail messages to have a FROM address of anyone that is not known to the server. If the administrative e-mail address that the administrator is using for this system is known to the server, the administrator can try setting the following variable equal to “on” by checking this box, and this may fix the problem. The Disable All E-Mail 608 variable disables all e-mailing by the system. Normally, the administrator leaves this box unchecked, but if the administrator is having problems installing the system or with certain functions, these problems may relate to the e-mail features, so the administrator can temporarily turn off all e-mailing by checking this box.

The Administrator's E-Mail Address 609 variable specifies the e-mail address of the administrator. The Use Flock 610 variable applies if the administrator is running on a Unix/Linux server and the system supports the flock utility for file-locking. Flock is available on almost all Unix/Linux servers. If the administrator is running on a Windows NT server, or if the administrator is not sure whether the system supports flock, the administrator can uncheck this box so that the system uses its own built-in file-locking routines.

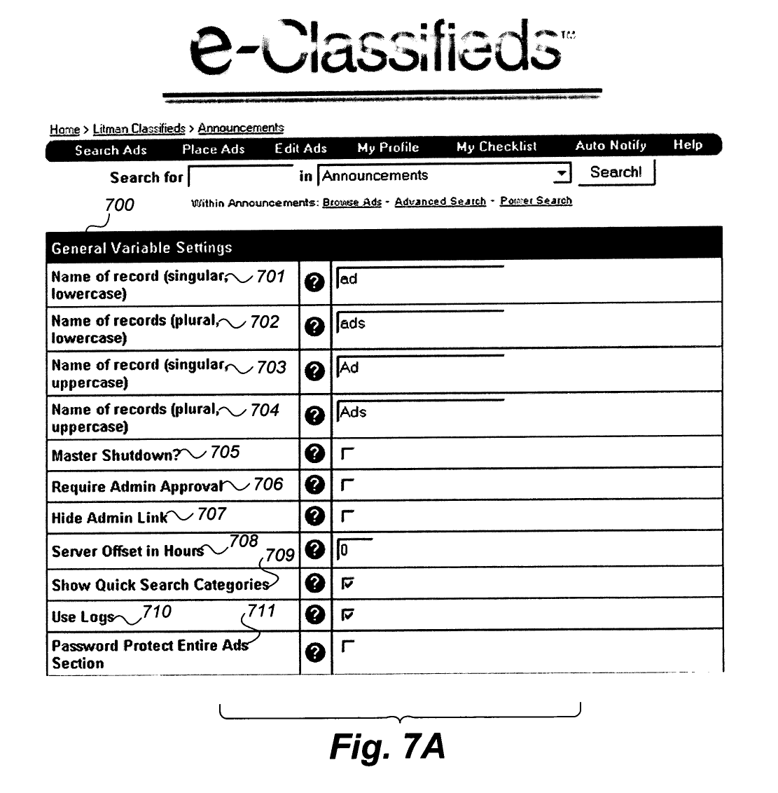

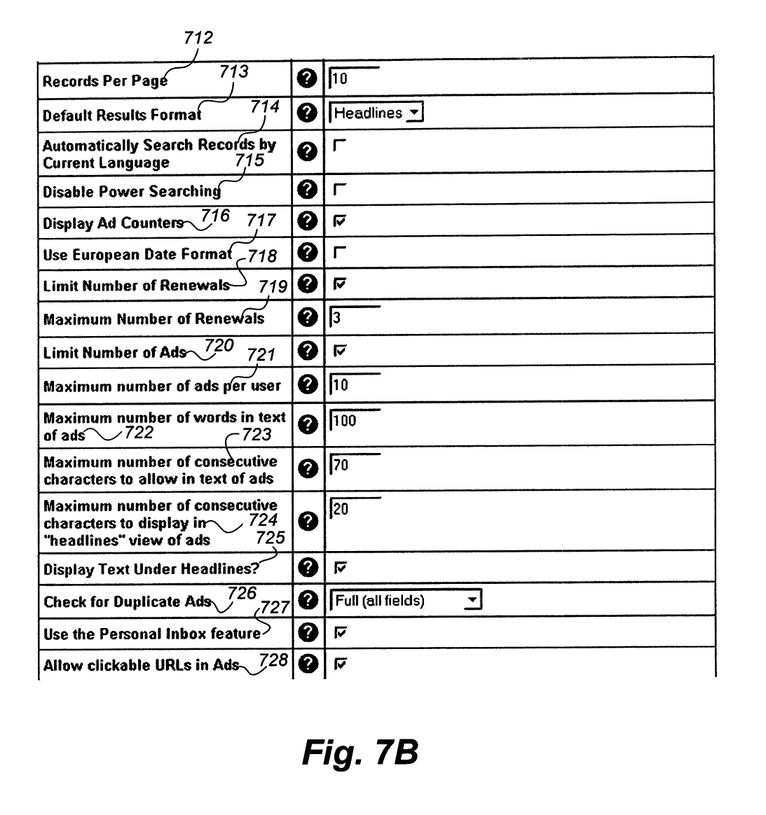

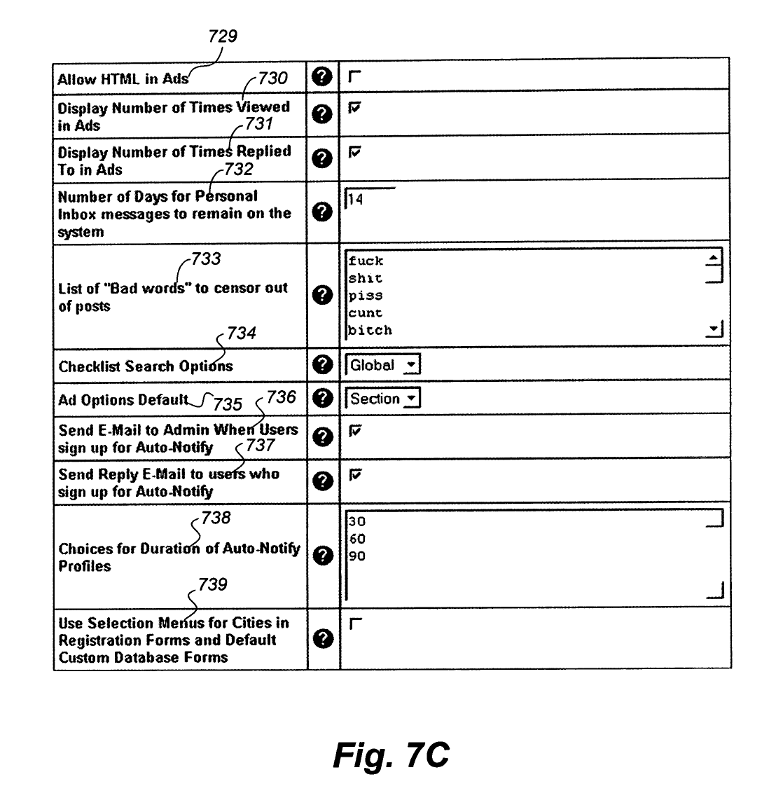

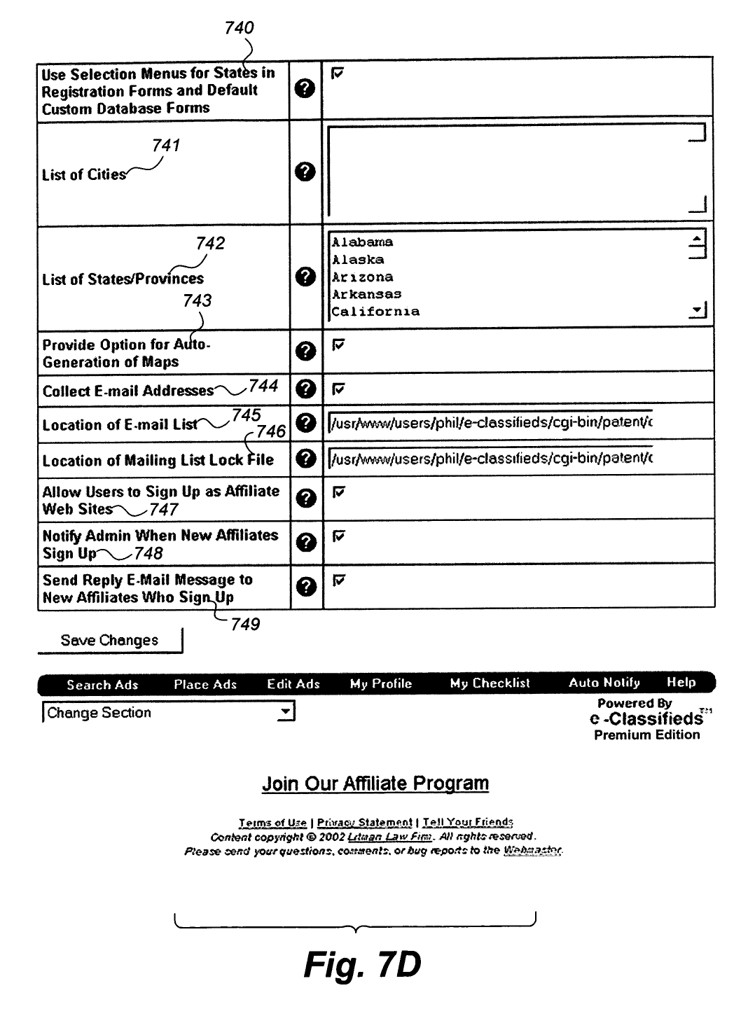

Referring to FIGS. 7A, 7B, 7C and 7D, the General Variable Settings Form 700 variable enables an administrator to set most of the general variables, such as the name of the records, whether to use the European date format and which e-mail messages to send. The Name of Record (singular, lowercase) 701 variable specifies the singular and lower case name of the types of records in the database (such as “ad”, “movie review”, etc.). The Name of Records (plural, lowercase) 702 variable specifies the plural and lower case name of the types of records in the database (such as “ads”, “movie reviews”, etc.). The Name of Record (singular, uppercase) 703 variable specifies the singular and upper case name of the types of records in the database (such as “Ad”, “Movie Review”, etc.). The Name of Records (plural, uppercase) 704 variable specifies the plural and upper case name of the types of records in the database (such as “Ads”, “Movie Reviews”, etc.).

Normally, the administrator leaves the Master Shutdown 705 variable unchecked. If the box is checked, the entire system is turned off. End users then simply see a message indicating that the system is temporarily down for maintenance. This option can be used when the administrator does not want end users seeing or accessing the system, such as when the administrator is upgrading, editing system files, or editing important data files. The Require Admin Approval 706 variable is for requiring administrative approval of new ads before they are viewable and turned off by default.

If the administrator turns this feature on by checking the box, all new ads are assigned a temporary status and are not viewable by end users until they have been approved by the administrator through a special form. This form can be used to approve or delete the new ads. The administrator might want to use this feature to screen new ads before allowing them into the system, or if the administrator wants to temporarily block a spammer from flooding the system with lots of junk ads. The downside is that the administrator has to screen the new ads quite often, or else no new ads show up on the system until they are approved. If the administrator does not wish to use this feature and wants new ads to be displayed immediately, the administrator leaves this feature turned off.

If the Hide Admin Link 707 box is checked, the “admin” link on the pages (if applicable for the template that the administrator is using) is hidden unless a registered administrator has logged in. This hides the admin link from end users. The administrator then accesses the admin area by clicking on the “My Profile” link, logging on as the admin, and then clicking on the “Access Admin Area” link. If this box is left unchecked, the “Admin” link is displayed to all end users on certain templates, and the administrator can simply click on this link to log in and go directly to the control panel 500.

The Server Offset in Hours 708 variable can be used to modify the time obtained by the system where the time on the server varies from the local time for the intended audience. It specifies the number of hours that should be added or subtracted from the time obtained by the server when reporting the current time and date. For example, for a Web site serving Australia that resides on a Web server located in the United States, the system might report the current date as Tuesday, July 10, at 6:00 P.M., even though it is already 8:00 A.M. on Wednesday, July 11 in Australia. By setting this variable equal to “14” for this fourteen hour difference, the administrator can cause the system to report the time as the local (Australia) time of 8:00 A.M. on Wednesday, July 11. To subtract hours, this variable is set to a negative value, such as “−3” to subtract three hours from the server time. If the administrator does not need this feature, this can be left set to “0”.

If the Show Quick Search Categories 709 is checked, the system displays a “Category” drop-down box on the keyword search form. Assuming that the administrator has turned on logging by checking the “Use Logs” 710 box, the system maintains a log of all end user activity on the system, including posting, modifying, and deleting of ads.

These logs can be used as a method of data recovery because they are contained in the *.log files for each section (such as autos.log, employment.log, etc., depending on the section), and since they are not written to at the exact same time as the *.data files for each section (such as autos.data, employment.data, etc., depending on the section), it's possible that the *.log file for a particular section may still be intact even if the *.data file for that section was wiped out. The administrator can download the *.log file, open it up in a text editor, and turn off word-wrapping. The administrator will then see a separate line for each action, with data fields separated by the pipe symbol (the “|” symbol). The line begins with ADD, MODIFY, or DELETE, followed by the end user's IP address. The next field is the first field of the actual ad. By stripping out the first two fields in the ADD lines (the ADD field and the IP address field), the administrator can restore these ads by placing them back into the *.data file for that section.

The last field of each line contains the unique ad number for that ad, so when the administrator is finished, the administrator will want to also make sure that the number in the *.counter file for that section (such as autos.counter, employment.counter, etc., depending on the section) is higher than any of the ad numbers contained in the administrator restored *.data file. Once the administrator has placed all of the ADD lines back into the *.data file, if the administrator wants to be even more thorough, he or she can do so by replacing ads that have been modified. To do so, the administrator would look for the lines in the *.log file for this section that begin with MODIFY and place those ads (stripping out the MODIFY and IP address fields again) into the *.data file for this section, overwriting the ads that have the same ad numbers. The administrator could also look for ads that have been deleted (those ads in the *.log file for this section that begin with DELETE) and remove them from the *.data file.

The Password Protect Entire Ads Section 711 variable determines whether the system password protects the entire ads section by requiring all end users to log on before accessing any pages. If the administrator turns this on by checking this box and also wants to charge for registering, the administrator also turns on the charge for registering variables and sets the amount of the charge. With the Records Per Page 712 variable, the administrator can change the number of ads to be displayed per page in the search results by changing this variable. The Default Results Format 713 variable determines the default method for displaying the ads when the administrator conducts a search. To display them as headlines only, with a link to the full ad, the administrator sets this variable equal to “Headlines”. Otherwise, to display the full ads by default, the administrator can set this value equal to “Full Size”.

If the Automatically Search Records by Current Language 714 box is checked, the system automatically limits all searches conducted by end users to include only those ads posted in the language that the system is currently being used in at the time of the search. If this box is unchecked, searches include ads posted in all languages unless the end user has specifically selected a language to search on in the search form. The system has the ability to support multiple language versions of the system running simultaneously and accessing the same ads databases. The system also enables end users to specify the display of ads in a specific language. The multiple language feature includes double byte support for languages such as Chinese and Japanese. Unlike traditional classified presentations, which are inherently locally or regionally based, this multiple language feature extends the system for use on a global basis.

If the Disable Power Searching 715 variable is checked, the advanced full database searching capabilities of the system are disabled. Normally, the administrator can leave this box unchecked, but if the ads database starts to get really large, the administrator might want to turn this on. Turning this on does not affect normal operations of the system in any way, except that end users are not able to conduct full database searches, and the power search link is removed from the toolbar. If the Display Ad Counters 716 variable is checked, the system displays the current number of ads in each section on the overall front page of the system, as well as the current number of ads in each category on the front page of each section. The administrator has the option of turning this feature off. To do so, the box is left unchecked. The European Date Format 717 is used if the administrator wants to display dates using the European format (day/month/year) instead of the standard (month/day/year) format.

If the Limit Number of Renewals 718 box is checked, the system limits the number of times that a specific ad can be renewed. The Maximum Number of Renewals 719 variable specifies the maximum number of times that an end user may renew his or her ad. This is applicable only if the administrator has checked the limit renewals box. If the Limit Number of Ads 720 box is checked, the system limits the number of ads that can be posted under any one registered username. If the Maximum Number of Ads Per User 721 variable is turned on, this variable determines the maximum number of ads that can be posted under any one registered username. The Maximum Number of Words in Text of Ads 722 variable defines the maximum number of words that may be included in the text section of each ad. If the number of words exceeds this amount, all words after the last allowed word are stripped out from the ad.

This is useful for preventing people from writing novels in their ads and thereby clogging up the system. The Maximum Number of Consecutive Characters to Allow in Text of Ads 723 variable defines the maximum number of consecutive characters to allow in the text of ads. Words that contain more than this number of characters will be stripped into chunks containing the number of characters that the administrator specifies here. This prevents someone from entering a really long line that distorts the ad displays.

The Maximum Number of Consecutive Characters to Display in “headlines” View of Ads 724 variable defines the maximum number of consecutive characters that the system displays for each field in the “headlines” display format of the ads. Fields that contain more than this number of characters only display this number of characters, which is followed by “ . . . ” to indicate that the field contains more characters. This helps to keep the headlines display tidy by preventing really long fields from wrapping around or otherwise distorting the displays. A good default value here is twenty. If the Display Text Under Headlines 725 box is checked, the system displays the full text of each ad underneath its “headlines” display.

The Check For Duplicate Ads 726 variable has three valid values. If set to “Full”, the system does a full database check on every field of the submitted ad and compare this to every field in every ad in the database. If all fields match, the system does not post the new ad, and it informs the end user that the ad is a duplicate of an ad in the database. If set to “Text”, the system compares only the text entered into the text or description field to the same field for each ad in the database. If they match, it also checks the date that the ad in the database was posted. It finds a duplicate only if the description text matches an ad that was posted on the same day. Thus, while the “Text” setting is less thorough than the “Full” setting, it is also faster, which causes the system to use fewer system resources and to post the ads faster. If set to “None”, the system does not do any duplicate checking at all. If the administrator disables the advanced database search features using the disable advanced searching variable, “Full” duplicate checking is disabled, even if the administrator has set it here.

In general, duplicate checking is useful for preventing spammers from attempting to post multiple copies of the same ad, or to inform people who seem to want to hit the “Submit” button several times after their ad has already been posted. The Personal Inbox Feature 727 functions as a full-strength, private, and secure messaging center. Check this box if the administrator wants to hide the e-mail addresses of people who have posted ads. Viewers will instead see a clickable link that says “Reply to Ad”. If they click on it, they will see a response form where they can enter their name, e-mail address, and brief message to send to the person who posted the ad. That person's e-mail address is never revealed to the viewer. When an end user replies to an ad, the poster is notified that they have a reply and is given a URL where they can retrieve it. The e-mail address of the person who replied is not revealed. When the original poster retrieves the reply, he or she has the option of sending a reply back, again without revealing her or her e-mail address. That way, the parties can send messages back and forth through this system without revealing their e-mail addresses or other personal information until they feel comfortable in doing so.

If the administrator would rather just have all e-mail addresses publicly viewable, leave this box unchecked. If the Allow Clickable URLs In Ads 728 box is checked, the system will allow URLs that are included with the ads to be displayed as clickable links. Otherwise, the URLs will be displayed, but they will not be clickable links. If the Allow HTML In Ads 729 box is checked, the system allows end users to include HTML in their ads. In most cases, this should probably be left unchecked. If the Display Number of Times Viewed in Ads 730 box is checked, the system displays a counter in each full size ad that indicates the number of times that this ad has been viewed in the full size format. If the Display Number of Times Replied To in Ads 731 box is checked, and if the administrator is using the Personal Inbox System 727, the system displays a counter that indicates the number of times that this ad has been replied to.

The Number of Days For Personal Inbox Messages to Remain on the System 732 variable specifies the number of days that messages are stored in the personal inbox private messaging system. Messages that are older than this number of days are deleted. The List of “Bad Words” to Censor Out of Posts 733 variable contains the list of “Bad Words” that the administrator wants to prevent end users from being able to enter into their ads. If the administrator does not want to censor end users in any way, the administrator can set this blank. The administrator can also put personal names, company names, phone numbers, e-mail addresses, or other information that may be specific to an end user whom the administrator wants to block from posting ads. Each value is listed on a separate line.

The Checklist Search Options 734 variable determines how the checklist feature will work. Setting it to “Global” causes the checklist feature to display ads from all ad sections that this end user had added to her checklist. While this is the most convenient option for end users, it is extremely server intensive, and it probably should not be used unless the system is running on a dedicated server that has an extremely fast processor and lots of available memory. Otherwise, the administrator should probably set this to “Section”, which causes the checklist to search only the current section and to display checklisted ads for this section. The third possible setting is “Off”, which turns off the checklist feature altogether.

The Ad Options Default 735 variable determines how the ad options (Place ads, modify/renew ads, and delete ads.) and the auto-notify link works from within each section. Setting it to “Global” will cause the ad options and the auto-notify feature to always link back to a page that prompts the end user to select a section before performing this option, even if they were already inside one of the sections. The advantage of this setting is that it helps to make sure that they are posting the ad or undertaking the action in the right section. The disadvantage of this setting is that for end users who are already in the correct section, this requires an extra step before they can post their ads. If the administrator sets this variable to “Section”, the ad options and the auto-notify feature automatically links to the correct page for the section that the end user is in.

Obviously, this is more convenient and saves a step, but if sections are similar, they could end up posting a new ad in the wrong section. For example, if the administrator was operating a personals site and had created several top-level sections related to personal ads, a male end user browsing a section called “Women Seeking Men” might erroneously post his ad in this section, instead of posting it in the “Men Seeking Women” section.

The Send E-Mail to Admin When Users Sign Up For Auto-Notify 736 box is checked if the administrator wants the system to send an e-mail message to the administrator notifying him or her that an end user has signed up for the auto-notify feature. The Send Reply E-Mail to Users Who Sign Up For Auto-Notify 737 box is checked if the administrator wants the system to send a reply e-mail message to new end users who sign up for the auto-notify feature. The Choices For Duration of Auto-Notify Profiles 738 variable contains the choices for end users as to how many days their auto-notify search agent remains in the system before it expires and is purged. If the administrator only wants to give them one choice, then one value is included in this array. Each value is listed on a separate line.

The Use Selection Menus For Cities in Registration Forms and Default Custom Database Forms 739 box is checked if the administrator wants the system to display a pre-defined selection menu of cities that the end users choose from when registering and when posting or searching the ads (if the administrator is using the default custom posting and advanced search forms). If the administrator leaves it unchecked, they simply enter text into a text field. This setting has no effect on auto-generated ad posting and advanced search forms for each database. In other words, if the administrator has set the cities field in the database definition file for a particular section to use a select menu instead of a regular text input field, and if the administrator is auto-generating the post ad or advanced search forms for that section, the settings in the database definition field override this setting here for that particular section (e.g., a dropdown select menu using either the cities that the administrator defines in the database or below in the “List of Cities” variable, if the administrator is using the special cities variable in the database, are displayed even if the administrator unchecks this box here).

The Use Selection Menus For States/Provinces in Registration Forms and Default Custom Database Forms 740 box is checked if the administrator wants the system to display a pre-defined selection menu of states and/or provinces that end users must choose from when posting or searching the ads. If the administrator leaves it unchecked, they simply enter text into a text field. This setting has absolutely no effect on auto-generated ad posting and advanced search forms for each database. In other words, if the administrator has set the states/provinces field in the database definition file for a particular section to use a select menu instead of a regular text input field, and if the administrator is auto-generating the post ad or advanced search forms for that section, the settings in the database definition field override this setting here for that particular section (e.g., a dropdown select menu using either the states/provinces that the administrator defines in the database or below in the “List of States/Provinces” variable, if the administrator is using the special states variable in the database, are displayed even if the administrator unchecks this box here).

If the administrator turned on the use city selection menu variable above, then the administrator needs to define the cities in the List of Cities 741 variable. Each value is listed on a separate line. If the administrator turned on the use state/province selection menu variable above, then the administrator needs to define the states and/or provinces in the List of States and Provinces 742 variable. Each value is listed on a separate line. If the Provide Option for Auto-Generation of Maps 743 box is checked, the system enables end users to check a box when posting their ad that causes the system to automatically generate a map using a link to a mapping service. If this service does not fit the intended audience, the administrator may want to leave this box unchecked. The map generation feature is applicable only in the sections where it has been activated.

The Collect E-Mail Addresses 744 box is checked if the administrator wants the system to display a checkbox that allows people posting ads to select whether they want to have their name and e-mail address added to the mailing list. The Location of E-Mail List 745 variable specifies the location of the text file where the names and e-mail addresses of people selecting to be added to the mailing list are stored.

The Location of Mailing List Lock File 746 variable specifies the location of the lock file that is temporarily created when the system is adding a name to the mailing list. Referring to FIGS. 5A and 5B, the mailing list section 517 of the control panel 500 enables the administrator to manage the mailing list. The administrator can view the list of subscribers to the mailing list by clicking on the view mailing list link. The administrator can clear the mailing list and remove all subscribers by clicking on the clear mailing list link. The administrator can send a mass e-mail message to all subscribers on the list by clicking on the send mass e-mail link and then entering the message in the following form. The View Your Mailing List 518 option enables the administrator to view the mailing list of end users who have signed up for the mailing list by checking the signup box on the form when they posted their ads. Each end user is listed on a separate line, with their e-mail address preceding their name. The administrator can use the “Save” feature of his or her browser to save this file and then rename it as a text file and import it into his or her regular mailing list file or even a spreadsheet system. The Clear Your Mailing List 519 option allows the administrator to clear the mailing list of end users who have signed up for the administrator's newsletter by checking the signup box on the form when they posted their ads. The administrator may want to clear this list periodically after the administrator has viewed it using the form above and has saved the file and imported the list into the administrator's regular mailing list file.

The Send Mass E-Mail 520 option enables the administrator to send a mass e-mail to the administrator's subscribers who have signed up for the administrator's newsletter by checking the signup box on the form when they posted their ads.

As illustrated in FIGS. 5A and 5B, the system log options section 527 of the control panel 500 enables the administrator to view and/or clear the logs that the system creates when end users whom the administrator has blocked by their IP address or username attempt to post ads on the system. Referring back to FIGS. 7A, 7B, 7C, and 7D, the Allow Users to Sign Up As Affiliate Web Sites 747 variable specifies whether end users are able to sign up and create affiliate Web sites through an online signup form. “Affiliate” Web sites are able to contribute end users and ads to the ads database, yet maintain the “look and feel” of their own Web sites. There is no limit on the number of affiliates that the administrator can have, provided that the Web server can handle the additional traffic and number of ads that result from having all of these affiliates.

Referring back to FIGS. 5A and 5B, in order to set up an affiliate site, go to the control panel 500 and refer to the Affiliates Manager section 590. The administrator is presented with three hyperlinked options: Add Affiliates 591, Edit Affiliates 592 and Delete Affiliates 593. By clicking on the “Add Affiliates” link 591, the administrator is presented with on-screen instructions in the online wizard. The administrator can repeat this process for additional affiliates. For each new affiliate Web site, a table is created below for entering the settings. The settings to be entered are as follows:

Short Name refers to the short, one word filename that will be used internally by the program to name all files associated with this affiliate. It is one word only, with no spaces. It consists of only letters, numbers, or the “_” symbol, with no other punctuation marks. Preferably, it uses all lower case letter. This field is mandatory.

Long Name refers to the full name of this affiliate that will be displayed in references to this affiliate. This field is mandatory.

E-Mail Address refers to the e-mail address of the main administrative contact person for this affiliate. This field is mandatory.

Notify of New Ads determines whether the administrator for this affiliate will be notified by e-mail when end users post new ads through this affiliate site.

Notify of Modified Ads determines whether the administrator for this affiliate will be notified by e-mail when end users modify their ads through this affiliate site.

Notify of Deleted Ads determines whether the administrator for this affiliate will be notified by e-mail when end users delete their ads through this affiliate site.

Send Reply to Users determines whether end users who post new ads through this affiliate site will receive an automatic e-mail reply from the system.

Name of Ads Section refers to the full name of the ads section for this affiliate. This field is mandatory.

Name of Your Web Site refers to the full name of the affiliate's main Web site. This field is mandatory.

Administrator's Name refers to the full name of the administrator for this affiliate. This field is mandatory.

Administrator's Title refers to the title of the administrator for this affiliate. This field is mandatory.

URL of Your Web Site refers to the URL for the main Web site for this affiliate. This field is mandatory.

Slogan for Your Web site refers to the slogan or byline for this affiliate.

Owned By specifies the owner of this affiliate. The administrator can modify all affiliate profiles. If the administrator is allowing outside users to set up and edit their own affiliate sites, the administrator lists the username of the owner of this new affiliate site here.

Active? refers to whether the administrator wants this affiliate to be activated immediately. If the administrator checks this box, once this affiliate has been created, it immediately becomes active and visible to end users who go to the proper URL. If the administrator would rather have it be inactive temporarily, then the administrator leaves this box unchecked.

By clicking on Edit Affiliates 592, the administrator is presented with a listing of affiliates. The administrator checks the radio button next to the affiliate below that is to be modified, and then clicks on the display modification form button below. The administrator sees a page that contains a modification form for the affiliate that is selected. This form is filled in with the current attributes for that affiliate and allows changing the attributes of that affiliate (the same attributes that are listed under “add new affiliate”). To edit the “flagship” affiliate, the “default” affiliate is chosen (this is the affiliate for the administrator's main site). The “default” affiliate is highlighted in red.

By clicking on Delete Affiliates 593, the administrator is presented with a listing of affiliates. The administrator checks the box next to each affiliate below that is to be permanently removed from the system, and then clicks on the verify affiliates to remove button below. Removing these affiliates removes all of their associated configuration files and customized templates (if any). The administrator sees a confirmation page before these affiliates are permanently removed. The “flagship” affiliate is highlighted in red. There is a warning not to delete the “flagship” affiliate, and the system does not allow it to be deleted.

Referring back to FIGS. 7A, 7B, 7C, and 7D, additional affiliate system variables include the following. The Notify Admin When New Affiliates Sign Up 748 variable specifies whether the system automatically sends an e-mail notice to the administrator when new affiliate web sites sign up. The Send Reply E-mail Message to New Affiliates Who Sign Up 749 variable specifies whether the system automatically sends a reply e-mail message to new affiliate web sites who sign up.

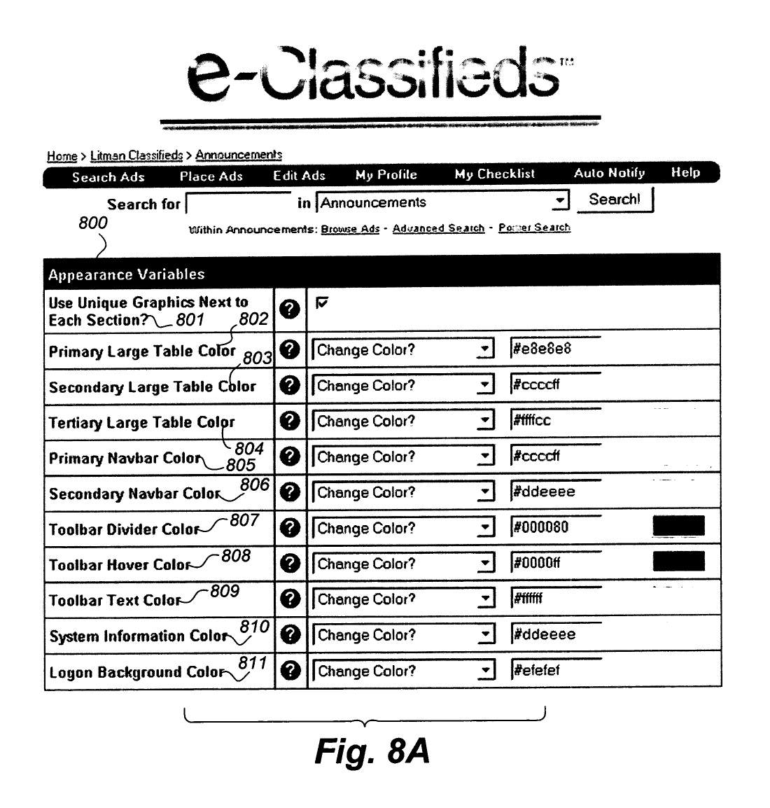

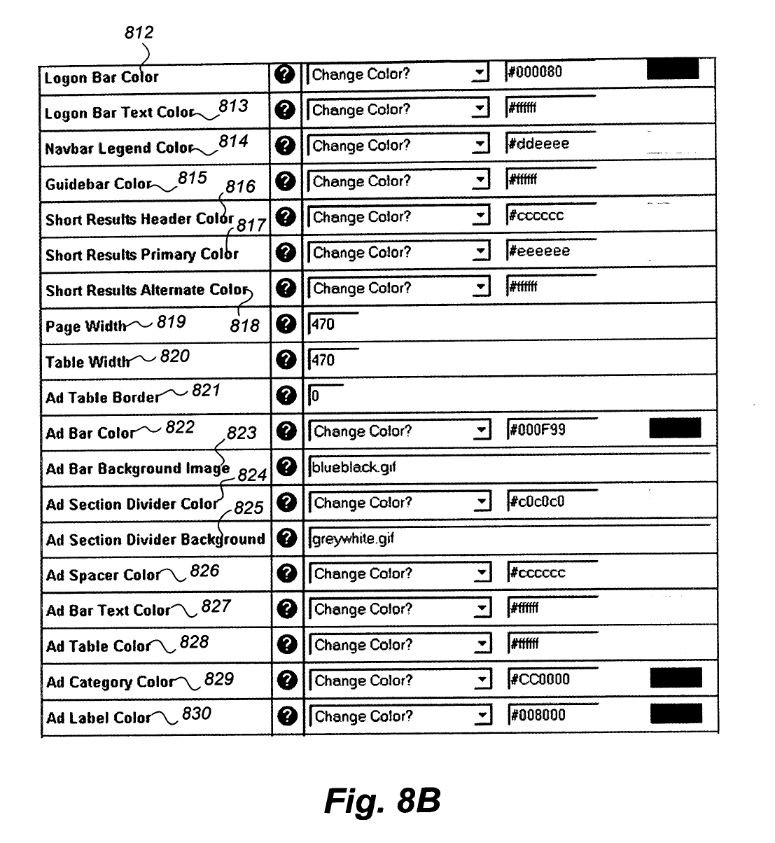

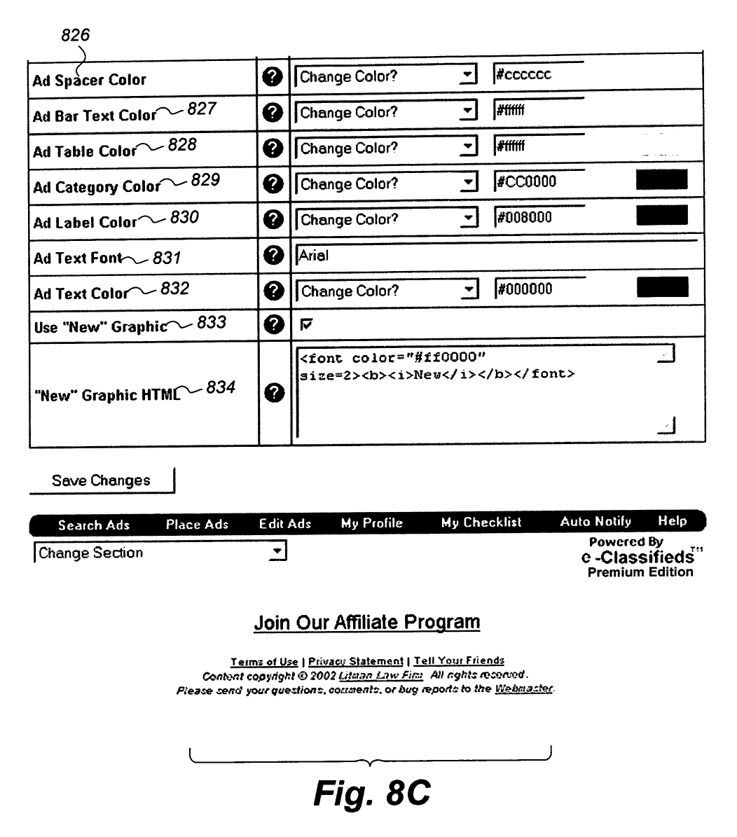

As illustrated in FIGS. 8A, 8B, and 8C, the Appearance Variables 800 form enables the administrator to set the various style and appearance variables for the system, such as fonts, colors, and more. The Use Unique Graphics Next To Each Section 801 box is checked if the administrator wants to use unique graphics next to each section listing on the front page. If the administrator wants to use the generic folder graphic, this box is unchecked. If the administrator checks this box, the administrator needs to create a separate graphic file named “section.gif” for each section and places it in the directory that the administrator has specified as the graphics directory, where “Section” is replaced by the internal file name that the system is using for that section (such as “autos.gif” for the automobiles section, “employment.gif” for the employment section, and so forth).

The Primary Large Table Color 802 variable sets the background color for many of the forms that are displayed throughout the system. The Secondary Large Table Color 803 variable sets the background color for many of the forms that are displayed throughout the system. In many cases, forms on a page may alternate between the primary table color and the secondary table color, so if the administrator wants all forms to use the same color, the administrator can set the values for both of these variables to the same color.

The Tertiary Large Table Color 804 variable sets the background color for a few of the forms that are displayed throughout the system, including the pop-up help windows and the bottom portions of the advanced search form. If the administrator wants all forms to use the same color, the administrator can use the same value for this variable that the administrator used for the primary large table color and secondary large table color variables. The Primary Navbar Color 805 variable sets the primary color for several of the sections in the navigation bar for the template that the administrator is using.

The Secondary Navbar Color 806 variable sets the secondary color for several of the sections in the navigation bar for the template that the administrator is using. The Toolbar Divider Color 807 variable sets the color for the dividers in the toolbar. The Toolbar Hover Color 808 variable specifies the color for the toolbar when the end user is hovering over it with her or her mouse (only on newer browsers that support CSS). The Toolbar Text Color 809 variable sets the color for the text that appears in the dividers in the toolbar (“Ad Options”, etc.). The System Info Color 810 variable determines the background color for the System Info section of the administrative Control Panel 501.

The Logon Background Color 811 variable sets the background color for the forms on the User Logon page (FIGS. 4A and 4B). The Logon Bar Color 812 variable sets the color for the bar at the top of the forms on the User Logon page (FIGS. 4A and 4B). The Logon Bar Text Color 813 variable sets the color for the text that appears in the bar at the top of the forms on the User Logon page (FIGS. 4A and 4B). The Navbar Legend Color 814 variable sets the background color for the legend that is used to explain how to use the various arrows and buttons in the navigation bar that is displayed beneath the search results.

The Guidebar Color 815 variable sets the background color for the guidebar that shows the end user where he or she is currently located within the system. The Short Results Header Color 816 variable sets the color for the header bar above the table that contains the ads in the short results (headlines) format. The Short Results Primary Color 817 variable sets the initial color for the rotating colors used to display ads in the short results (headlines) format. The Short Results Alternate Color 818 variable sets the alternate color for the rotating colors used to display ads in the short results (headlines) format.

The Page Width 819 variable determines the width in pixels for all tables, forms, and text on pages that are generated by the system. The administrator can use this, for example, to squeeze the system's output into a larger general page layout that the administrator would define in the Template Editor. The Table Width 820 variable is set to the pixel width of the tables that display the ads. The Ad Table Border 821 variable determines the size of the border for each ad. The Ad Bar Color 822 variable determines the color of the bar that goes across the top of each ad and that contains the caption for that ad. This is also the color of the “Description” header.

The Ad Bar Background Image 823 variable can optionally point to the URL of the background graphic that is displayed in the bar at the top of each ad. If the administrator specifies a background, it overrides the color that the administrator chose for the Ad Bar Color variable. If the administrator wants to specify a background, the administrator lists the name of the background graphic file that the administrator wants to use, and this file is present in the “graphics” directory for the system. If the administrator does not want to use a background, the administrator can simply leave this blank.

The Ad Section Divider Color 824 variable sets the a background color for the bars that divide the sections within the full size ad display. The Ad Section Divider Background Image 825 variable optionally sets the background graphic for the bars that divide the sections within the full size ad display, as well as on certain other pages, such as the Control Panel. If the administrator specifies a background, it overrides the color that the administrator chose for the Ad Section Divider Color variable. If the administrator wants to specify a background, the administrator lists the name of the background graphic file that the administrator wants to use, and this file is then present in the “graphics” directory for the system. If the administrator does not want to use a background, the administrator can simply leave this blank. The Ad Spacer Color 826 variable specifies the color of the thin line that divides some of the values in the ads. The Ad Bar Text Color 827 variable determines the color of the text (the subject or caption for the Ad) that is displayed in the bar at the top of each ad.

The Ad Table Color 828 variable determines the background color for the main portion of the table (everything except for the bar at the top). The Ad Category Color 829 variable determines the color of the values listed for the “Category” and “Date Posted” sections. The Ad Label Color 830 variable determines the color of the labels for the various fields, such as Categories, Contact, etc. The Ad Text Font 831 variable determines the font for all of the text contained in the ad tables. The Ad Text Color 832 variable determines the color for all of the regular text contained in the full size ads. If the Use “New” Graphic 833 box is checked, the system displays the “New” text or graphic next to sections or categories that have items that have been posted since this end user's last visit.

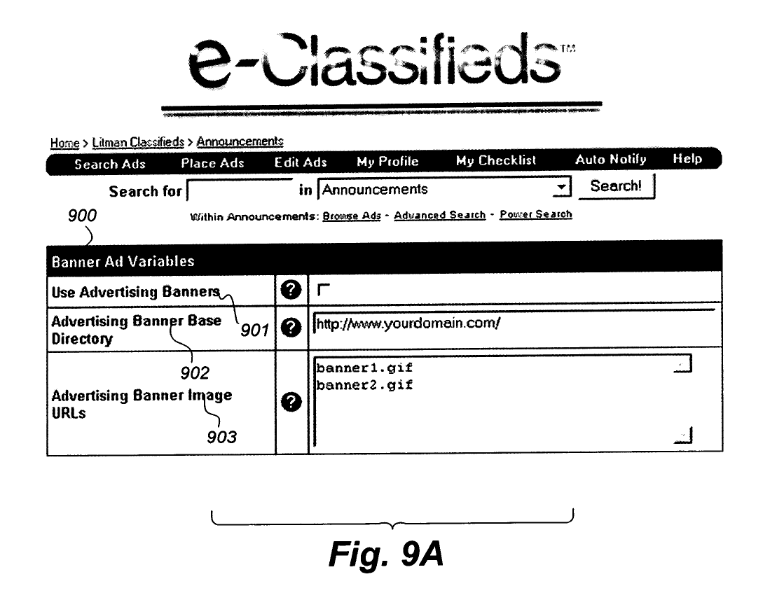

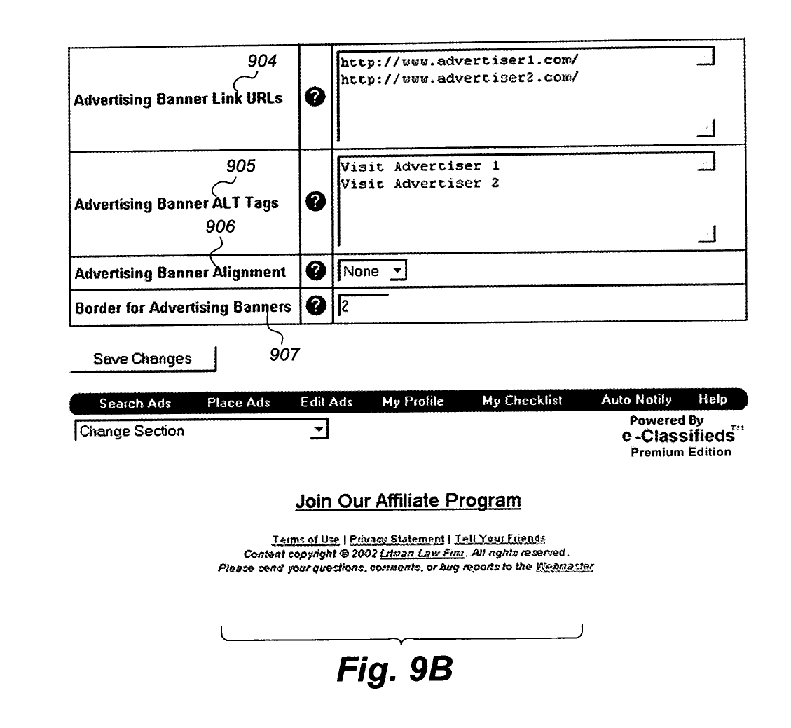

The “New” Graphic HTML 834 variable determines the HTML for the “New” text or graphic that appears next to sections or categories that have items that have been posted since this end user's last visit. As illustrated in FIGS. 9A and 9B, the Banner Ad Variables 900 form enables the administrator to specify whether he or she wants to rotate ad banners throughout the system, and if so, the images, URLs, and “alt” tags for these ad banners. Ad banners are an important form of advertising and payment for Web sites. If the Use Advertising Banners 901 box is checked, the system rotates banners throughout the ads. The Advertising Banner Base Directory 902 variable is set to the URL of the directory where the images are stored.

The Advertising Banner Image URLs 903 array contains the filenames for the banners that the administrator wants to display. The first graphic in Images will be a link to the first URL in URLs and will display the first ALT tag in the Alt array, and so forth. Each value should be listed on a separate line. The Advertising Banner Link URLs 904 array contains the URLs that the administrator wants to link to. The first graphic in Images is a link to the first URL in URLs and displays the first ALT tag in the Alt array, and so forth. Each value should be listed on a separate line.

The Advertising Banner ALT Tags 905 array contains the ALT tags that are displayed on text-based browsers. The first graphic in Images is a link to the first URL in URLs and displays the first ALT tag in the Alt array, and so forth. Each value is listed on a separate line. The Advertising Banner Alignment 906 variable can be set to “Left”, “Center”, or “Right”, depending on how the administrator wants to align the banners. It can also be left set to “None”.

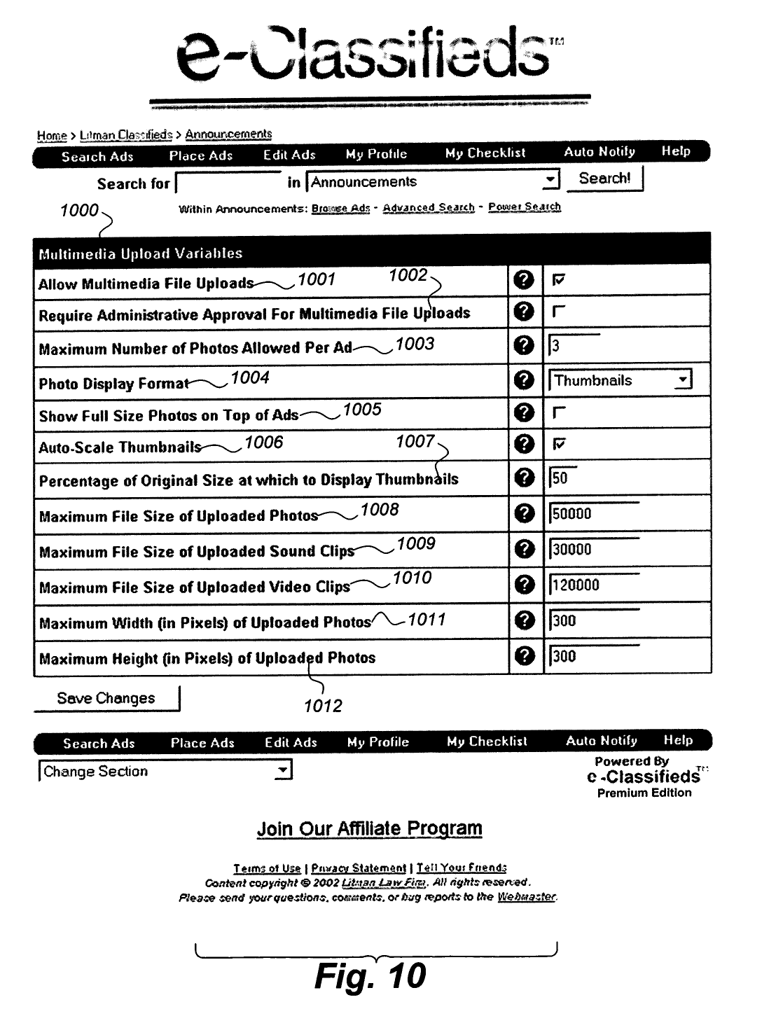

The Border for Advertising Banners 907 variable determines the size of the border around the banners. If the administrator does not want a border, then this variable is set equal to 0. As illustrated in FIG. 10, the Multimedia Upload Variables 1000 form enables the administrator to set various options relating to whether the administrator wants to allow end users to be able to upload multimedia files to their ads, and if so, the file size and pixel size (for images) of these multimedia files, among other options. The Allow Multimedia File Uploads 1001 box is checked if the administrator wants to allow users to upload photos with their ads. If the administrator ever wants to turn this feature off and disallow photo uploads, this box is unchecked. Turning this feature off also causes the ads to no longer display the photos that were previously uploaded. These photos remain on the server until the ads are purged or deleted, however, so they appear with the ads again if the administrator ever turns this feature back on.

The Require Administrative Approval For Multimedia File Uploads 1002 box is checked if the administrator wants to require administrative approval for multimedia file uploads. This option causes uploaded multimedia files to not be immediately viewable when uploaded. Instead, they become viewable in ads only after they have been approved by the administrator. The advantage of this is that the administrator can keep objectionable photos or other files from being included in the ads.

The Maximum Number of Photos Allowed Per Ad 1003 variable determines the maximum number of photos that end users can upload to each ad. For best performance, the recommended setting is one. Setting it to a higher number allows end users to upload multiple photos per ad, but this also has the negative effects of using up more disk space and slowing down the performance of the system substantially. The higher the number, the worse the performance becomes, so the administrator can be judicious in setting this.

The Photo Display Format 1004 variable determines how the photos are displayed in the ads. There are four possible choices here. Setting this variable equal to “Full Size” causes the photos to be displayed at their full size in each ad. If the administrator is allowing large-sized photos, this causes the display to become unwieldy.

The second possible value is “Thumbnails”, which will cause the photos to be displayed as thumbnails. The size of these thumbnails is determined by the values that the administrator chooses for the Auto-Scale Thumbnails and Percentage of Original Size at which to Display Thumbnails variables below. The third possible value is “Icons”, which causes the system to display an icon instead of the photos. Clicking on this icon (or on the photos in the first two scenarios above) shows the viewer the ad with the full-size photo. The final possible value is “No Photo Display”, which turns off the display of photos on the system (but end users are still able to upload photos unless the administrator has turned off the Allow Photo Uploads variable).

The Show Full Size Photos on Top of Ads 1005 box is checked if the administrator selected “Full Size” for the Photo Display Format variable, and if the administrator wants the system to display all of the uploaded photos above the main ad display. This is generally not recommended, but if the administrator is allowing end users to upload large photos (larger than about three hundred pixels wide or so), then the administrator may want to check this box, as the displays can become unwieldy if these large photos are displayed along the left hand side of the main ad display in the usual manner. The Auto-Scale Thumbnails 1006 box is checked if the administrator wants the system to automatically scale the thumbnail images. It attempts to resize the thumbnails so that they are always below a hundred pixels, unless the original photo is over five hundred pixels in width, in which case it is scaled to one fifth of its original size. This variable is relevant only if the administrator set the Photo Display Format variable above equal to “Thumbnails”.

The Percentage of Original Size at Which to Display Thumbnails 1007 variable specifies the percentage of the original size that the administrator wants each thumbnail to be displayed at. It can be set to an integer between one and ninety-nine (in other words, for fifty percent, administrator sets this to “50”, and not to “0.50”). This variable is relevant if the administrator sets the Photo Display Format variable above equal to “Thumbnails” and if the Auto-Scale Thumbnails box is not checked. The Maximum File Size of Uploaded Photos 1008 variable specifies the maximum size in bytes that the image files (photos) uploaded by end users can be.

The Maximum File Size of Uploaded Sound Clips 1009 variable specifies the maximum size in bytes that the audio files (sound clips) uploaded by end users can be. The Maximum File Size of Uploaded Video Clips 1010 variable specifies the maximum size in bytes that the video files (movie clips) uploaded by end users can be. The Maximum Width (in Pixels) of Uploaded Photos 1011 variable should be set to the maximum width (in pixels) that the administrator wants to allow for photos uploaded by people posting ads. The Maximum Height (in pixels) of Uploaded Photos 1012 variable is set to the maximum height (in pixels) that the administrator wants to allow for photos uploaded by people posting ads. This is important for avoiding extremely large photos that would take up too much screen space in the ads.

Referring back to FIGS. 5A and 5B, the Multimedia Options Section of the Control Panel 525 allows an administrator to Preview Multimedia Files 526. If the administrator is requiring new multimedia uploads to be approved by the administrator before they are viewable, this option allows the administrator to preview all newly uploaded multimedia files that are awaiting administrative approval. For each file, the administrator will have the option of approving the file, deleting the file, or deferring action until a later time. If the administrator defers action, the file remains in a temporary state (and thus is not displayed to general viewers) and is displayed again the next time that the administrator runs this preview system.

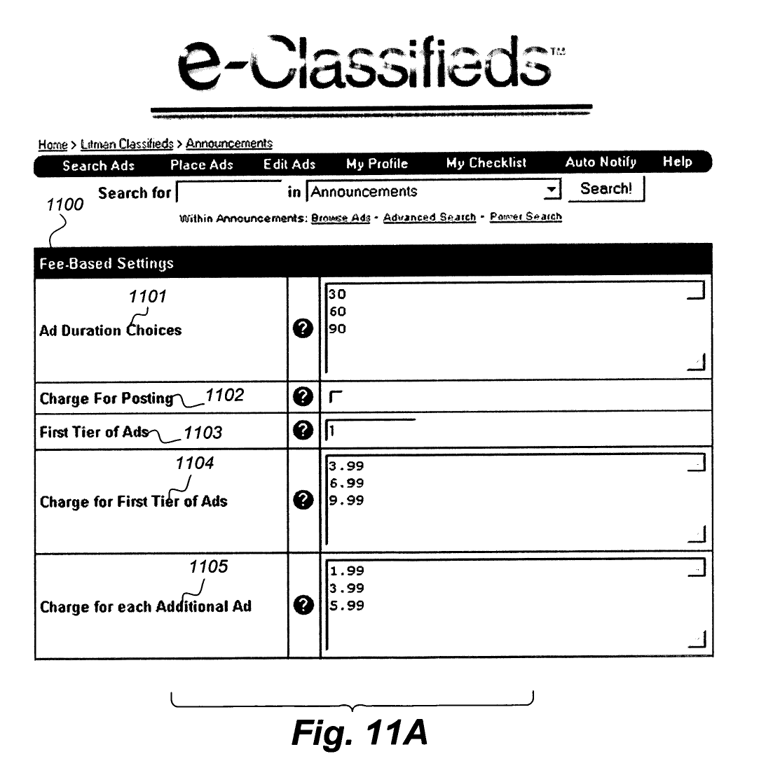

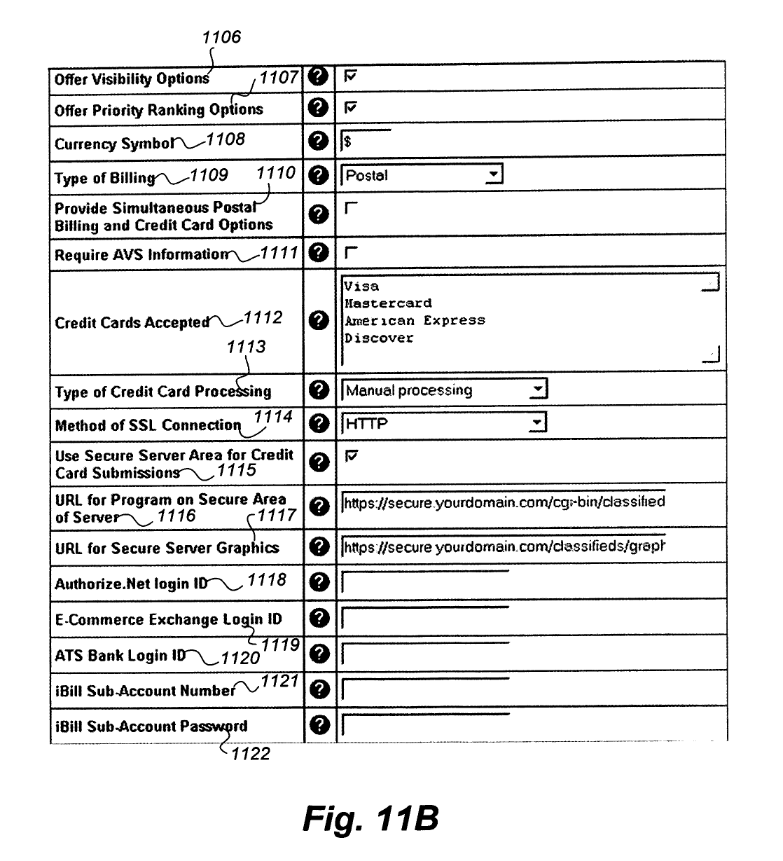

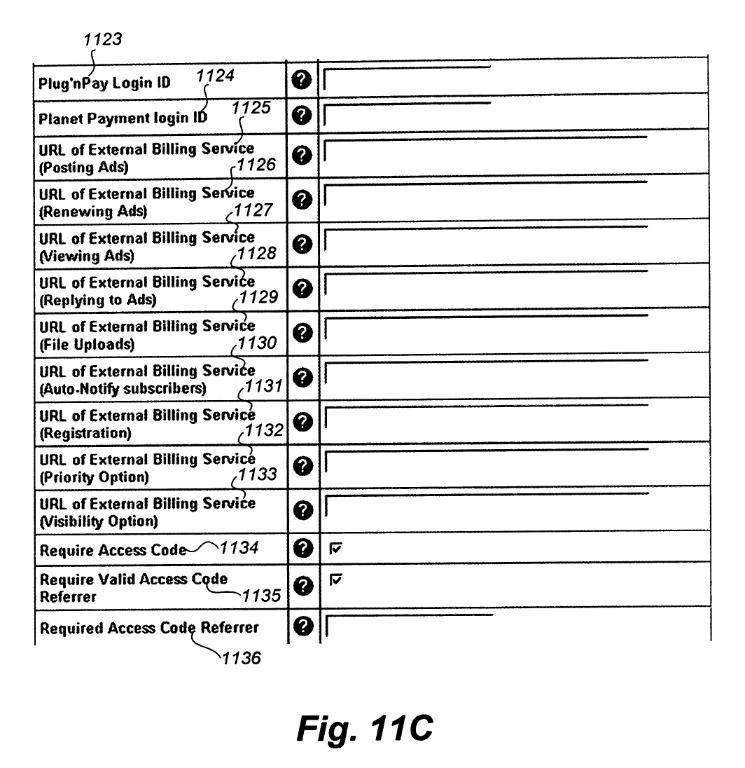

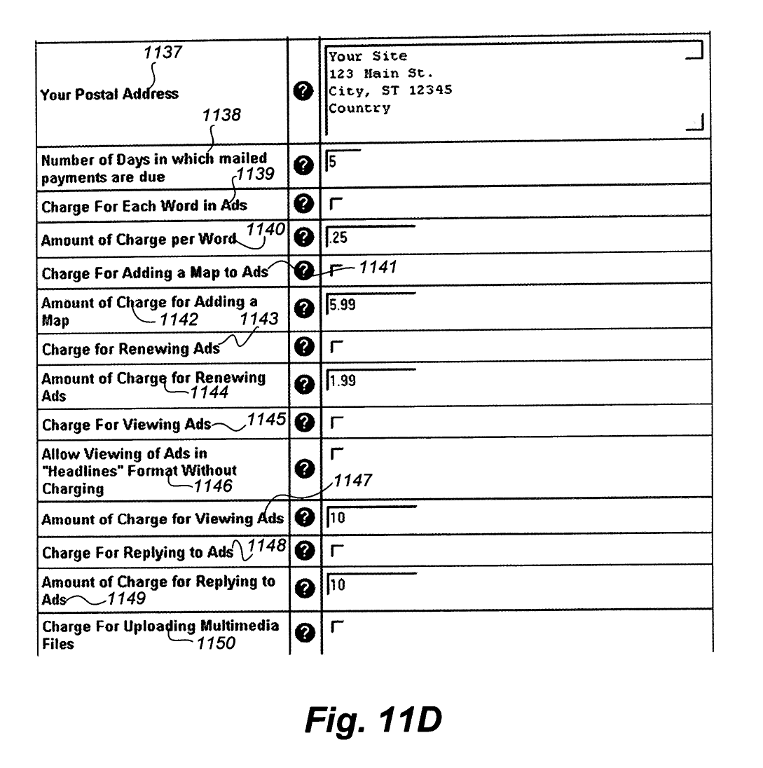

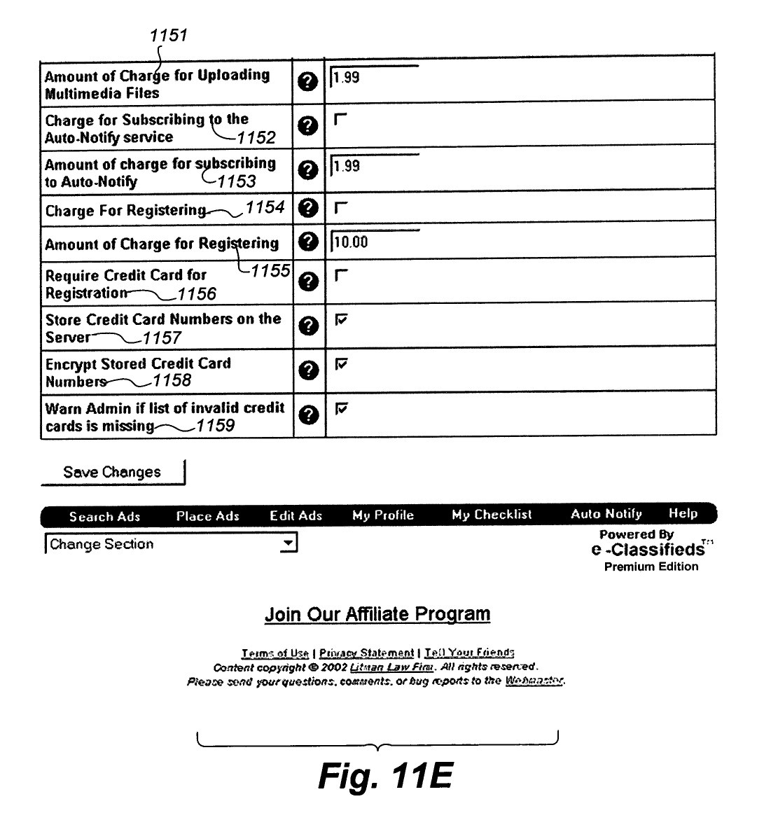

As illustrated in FIGS. 11A, 11B, 11C, 11D, and 11E, the Fee-Based Settings 1100 form allows the administrator to set the various e-commerce and fee-based options for the system. The Ad Duration Choices 1101 variable contains the choices for end users as to how many days their ad remains posted before it expires and is purged. If the administrator only wants to give them one choice, then just include one value in this array. Each value is listed on a separate line. The Charge For Posting 1102 box is checked if the administrator wishes to operate a fee-based system that requires end users to pay for posting new ads. If the administrator does not wish to charge end users for posting new ads, then this box is unchecked. The First Tier of Ads 1103 variable specifies how many ads a user must place before receiving the rates specified below in the Charge for Each Additional Item variable. Until they post the number of ads that the administrator specifies here, they are charged at the rates that the administrator defines below in the Charge for First Tier of Items variable.

The Charge for First Tier of Ads 1104 variable should contain the fees for the first group of ads posted by a registered end user. The number of items in this array is exactly the same as the number of items in the Ad Duration Choices array. The first item in the array below is the cost for the first group of ads posted by an end user for the duration contained in the first item in the Record Duration Choices array above. For example, if the first item in that array is thirty (Ad displayed for thirty days), then the first item here is charged for ads posted for thirty days. This is charged if the administrator turned on the Charge For Posting variable. The administrator does not include dollar signs or any other currency symbol in front of these values, which are numeric values only. Each value is listed on a separate line.

The Charge for each Additional Ad 1105 variable contains the fees for ads posted by a registered end user who has already posted a number of ads equal to the number that the administrator set above in the First Tier of Ads variable. The number of items in this array is exactly the same as the number of items in the Ad Duration Choices and First Ad Cost arrays above. The first item in the array below is the cost for an ad posted by an end user (who has already passed the first tier pricing level) for the duration contained in the first item in the Ad Duration Choices array above. For example, if the first item in that array is thirty (ad displayed for thirty days), then the first item here is charged for ads posted for thirty days. This is charged if the administrator has turned on the Charge For Posting variable. The administrator does not include dollar signs or any other currency symbol in front of these values, which are numeric values only. Each value is listed on a separate line.

The Offer Visibility Options 1106 box is checked if the administrator wishes to offer end users the option of paying extra to have the visibility of their ad raised. The methods of raising visibility (such as bolding ads, etc.) and the amounts of these charges can be defined through the Visibility Options Manager in the Control Panel. If the administrator does not wish to offer any visibility raising options, then leave this box unchecked. The Offer Priority Ranking Options 1107 box is checked if the administrator wishes to offer end users the option of paying extra to have their ads receive priority ranking in the search results. The levels of priority and the amount to charge for each level can be defined through the Priority Ranking Options Manager in the Control Panel. If the administrator does not wish to offer any priority ranking options, then this box is unchecked.

The Currency Symbol 1108 variable specifies the currency unit that is placed in front of all currency values listed by the system. The Type of Billing 1109 variable determines the type of billing that is used by the system if the administrator is charging for certain functions. This is set to “Postal” for postal billing, in which the system sends an e-mail invoice to the end user requesting payment within a certain period of days (as specified in the Mail Payment Days variable). This is set to “Credit Card—Internal” if the administrator plans to use either real-time credit card processing on the backend through Authorize.Net or one of the other supported vendors, or if the administrator plans to use manual credit card processing.

If the administrator uses an external billing system in which the end user enters his or her credit card information on a form maintained outside the system, such as Clickbank or other similar systems, this is set to “Credit Card—External”. The Provide Simultaneous Postal Billing and Credit Card Options 1110 box is checked if the administrator selected “Credit Card—Internal” in the Type of Billing variable above, and if the administrator would like to offer end users the choice of paying by credit card or by check (through an e-mail invoice). This does not work if the administrator chooses “Credit Card—External” in the Type of Billing variable above.

The Require AVS Information 1111 box is checked if the administrator is using credit card billing and wants to require end users to fill out AVS information such as their address, city, state/province, zip/postal code, country, telephone number, and e-mail address. The Credit Cards Accepted 1112 variable specifies the credit cards that the administrator accepts if the administrator is charging for certain features and if the administrator is using credit card billing. Each credit card type is listed on a separate line. If the administrator set the Type of Billing variable to “Credit Card”, specify in the Type of Credit Card Processing 1113 variable the type of credit card processing that the administrator is using. If the administrator is using Authorize.Net version 2.5, set this to “Authorize.Net 2.5”. If the administrator is using Authorize.Net version 3.0, set this to “Authorize.Net 3.0”, etc.

If the administrator is using E-Commerce Exchange version 2.5, set this to “E-Commerce Exchange 2.5”. If the administrator is using E-Commerce Exchange version 3.0, this is set to “E-Commerce Exchange 3.0”. If the administrator is using ATS Bank, this is set to “ATS Bank”. If the administrator is using iBill, this is set to “Ibill”. Also, the administrator uses the “Basic TP” account with Ibill in order to use Ibill here. If the administrator is using Plug'nPay, this is set to “Plug'nPay”. This is set to “Manual processing” if the administrator does not use real-time credit card processing through one of the companies listed above. Setting this to “Manual processing” causes the system to send the administrator the end users' credit card information and/or store it on the server, depending on how the administrator sets the other variables below. The administrator then manually processes the charges to the end users' accounts.

The Method of SSL Connection 1114 variable determines the Secure Sockets Layer (SSL) method that the system uses to contact the secure server for the administrator's outside processor. In order for this contact to be conducted over a fully secure connection, the administrator's web server fully supports either the Net::SSLeay Perl module or the LWP::UserAgent module using a secure connection. The administrator can test for each of these modules on the system by clicking on their links in the pop-up help window. If the server supports the Net::SSLeay module, the value of this variable is specified as “Net::SSLeary”. If the server supports the LWP::End UserAgent module, including the ability of that module to make secure connections, the value is specified as “LWP::UserAgent (SSL)”.

Specifying a module that is either not present or not fully implemented on the server may result in end users always seeing error messages when submitting their credit card information, or even system crashes. If the server is unable to make secure connections using either of these modules, the administrator specifies either LWP::UserAgent (non-SSL) here (if the server has the LWP::UserAgent module installed), or “HTTP” (provided that the server supports the Socket module). In either of these cases, the system contacts the processor's server using a standard HTTP request. This stills works in terms of posting the charges to the end user's credit card and is partially secure if the administrator is running the system on an SSL server, but the administrator should be aware that it is not as secure as using the first two methods.

Using the LWP::UserAgent (non-SSL) option requires that the LWP::UserAgent module be present on the server, and the administrator can test for this by clicking on the appropriate link in the pop-up help window. Using the HTTP connection method requires that the Socket module be present on the server, and the administrator can test for this by clicking on the appropriate link in the pop-up help window. If none of the first four options are available, the administrator selects “None” here, and the administrator is not able to use the automated, real-time credit card processing features of this system. The administrator can also make sure that the Type of Credit Card Processing variable above 1113 is set to “Manual Processing”.

The Use Secure Server Area for Credit Card Submissions 1115 box is checked if the administrator is using credit card billing and wants to have the system use a secure (SSL) area of the computer web server when end users submit their credit card information. The URL for Program on Secure Area of Server 1116 variable is set to the URL of the version of the main system that the administrator installed in the secure area of the Web server. The URL for Secure Server Graphics 1117 variable is set to the URL of the directory that the administrator created in the secure area of the server for the storage of the system graphics. Do NOT add the trailing slash at the end.

The Authorize.Net login ID 1118 is used if the administrator is using Authorize.Net with the administrator specifying the Authorize.Net login ID here. If the administrator is using E-Commerce Exchange, the administrator specifies his or her E-Commerce Exchange Login ID 1119 here. If the administrator is using ATS Bank, the administrator specifies his or her ATS Bank Login ID 1120 here. If the administrator is using Ibill, the administrator specifies his or her Ibill Sub-Account number 1121 here. This number is the Ibill Sub-Account Number issued to the administrator by Ibill's Setup Department.

This Sub-Account number consists of the administrator's Ibill Master Account number followed by an additional 3 digits. On occasion, Ibill formats a Sub-Account with a hyphen (as in 6379-999) when displaying Sub-Accounts on screen for end users to read. When posted as a value for machines to read, a Sub-Account is always run together (as in “6379999”). If the administrator is using Ibill, the administrator specifies here if his or her Ibill password for the Sub-Account number is what the administrator listed above. This Ibill Sub-Account password 1122 is not the same as the Master password the administrator is assigned along with the username by which the administrator may log on to Ibill's Commerce Management (CMI) server.

If the administrator is using Plug'n Pay, the administrator specifies his or her Plug'n Pay Login ID 1123 here. If the administrator is using Planet Payment, the administrator specifies his or her Planet Payment Login ID 1124 here. If the administrator is using an external billing system, the administrator specifies the URL of the page that the system directs end users to when they are paying for posting a new ad to the system 1125.

If the administrator is using an external billing system, the administrator should specify the URL of the page that the system directs end users to when they are paying for renewing an ad on the system 1126. If the administrator is using an external billing system, the administrator specifies the URL of the page that the system directs end users to when they are paying for viewing ads on the system 1127. If the administrator is using an external billing system, the administrator specifies the URL of the page that the system directs end users to when they are paying for replying to ads on the system 1128.

If the administrator is using an external billing system, the administrator specifies the URL of the page that the system directs end users to when they are paying for uploading multimedia files to the system 1129. If the administrator is using an external billing system, the administrator specifies the URL of the page that the system directs end users to when they are paying for subscribing to the Auto-Notify service 1130. If the administrator is using an external billing system, the administrator specifies the URL of the page that the system directs end users to when they are paying for registering as end users on the system 1131.

If the administrator is using an external billing system, the administrator specifies the URL of the page that the system directs end users to when they are paying for priority ranking for a new Ad on the system 1132. If the administrator is using an outside service, the administrator can set one fee and one fee-based priority ranking option.

If the administrator is using an external billing system, he or she specifies the URL of the page that the system directs end users to when they are paying for visibility options for a new ad on the system 1133. If the administrator is using an outside service, the administrator can set one fee and one fee-based visibility option. If the administrator is using an external billing system, and if the administrator's vendor allows the administrator to set up a return URL for a “confirmation” page after successful credit card transactions, the administrator sets up their system to point to the special URL for this system and checks the Require Access Code 1134 box. That way, the system creates a special data file and access code that the end user enters on the payment form before their transaction (posting a new ad, uploading a photo, etc.) is processed. This helps to ensure payment. Otherwise, if the vendor doesn't offer this feature, the administrator leaves this box unchecked.

The administrator manually verifies that payment has been received for each service or transaction, since the system has no way of performing this verification beforehand, since it has no way of knowing whether the end user successfully posted the credit card payment. This is similar to the type of post-transaction verification that is necessary if the administrator were using postal billing via e-mail invoices.

If the administrator is using an external billing system, if the administrator's vendor allows the administrator to set up a return URL for a “good” page after successful credit card transactions, if the administrator has set up their system to point to the special URL for this system, and if the administrator checked the Require Access Code box above, then the administrator may want to check the Require Valid Access Code Referrer box 1135. Checking this box causes the system to require that the referring URL be from the credit card vendor in order to create the special access code for the end user. If the administrator knows the referring domain name of the vendor, the administrator can check this box, as it provides extra security in that it prevents end users from creating bogus access codes by simply entering the right URL. If the administrator checks this box, then the administrator specifies the valid referring domain in the variable below.

If the administrator has checked the Require Access Code Referrer 1135 variable above, and if the administrator knows the domain name of the server where the administrator's vendor refers users back to the administrator from, the administrator enters that domain name in the Required Access Code Referrer field 1136. This provides extra security in that it prevents end users from creating bogus access codes by simply entering the right URL.

The Your Postal Address 1137 variable contains the postal address where the administrator wants end users to mail their payments for various actions that they have taken if the administrator is operating a fee-based system and is using postal billing instead of credit card billing. The Number of Days in Which Mailed Payments Are Due 1138 variable specifies the number of days in which end users who have posted ads on the administrator's site must mail in their payments to the address above. The Charge For Each Word in Ads 1139 box is checked if the administrator wants to charge end users by the word for each word contained in ads that they post. Otherwise, it is left unchecked.

If the administrator is charging end users for each word contained in ads that they post, the Amount of Charge Per Word 1140 variable specifies the charge per word. Dollar signs or any other currency symbol are not be put in front of these values, which are numeric values only. The Charge For Adding a Map to Ads 1141 box can be checked if the administrator wants to charge end users for adding a map to ads that they post. If the administrator is charging end users to add a map to their ads, the Amount of Charge For Adding a Map 1142 variable specifies the charge for each ad that they add a map to.

Dollar signs or any other currency symbol are not placed in front of these values, which are numeric values only. The Charge For Renewing Ads 1143 variable specifies whether or not the system charges end users who renew their ads. This box is checked to enable charging for renewals. Otherwise this box is left unchecked.

If the administrator has enabled charging for renewals by checking the box above, the Amount of Charge For Renewing Ads 1144 variable specifies the amount of the charge. No dollar signs or any other currency symbol is put in front of this value, which is a numeric value only. The Charge For Viewing Ads 1145 box is checked if the administrator wants to charge end users for viewing ads. Otherwise, it is left unchecked. The Allow Viewing of Ads in “Headlines” Format Without Charging 1146 box, is checked if the administrator has turned on the Charge For Viewing Ads variable above but only wants to charge for viewing the full-size ad, while allowing end users to see the short results format ads (“headlines”). If the administrator wants to charge for both formats, this box is left unchecked.

If the administrator is charging end users to view ads, the Amount of Charge For Viewing Ads 1147 variable specifies the charge for allowing end users to view ads for a subscription period equal to the number of days that the administrator specified in the Registration Expiration Days variable. No dollar signs or any other currency symbol is included in front of these values, which are numeric values only. The Charge For Replying to Ads 1148 box is checked if the administrator wants to charge end users for replying to ads on the system.

This requires that the administrator also checks the Use Personal Inbox variable box. Otherwise, the e-mail addresses themselves are visible. If the administrator does not wish to charge for replying to the ads, then this box is left unchecked. If the administrator is charging end users to reply to Ads, the Amount of Charge For Replying to Ads 1149 variable specifies the charge for allowing end users to reply to ads for a subscription period equal to the number of days that the administrator specified in the Registration Expiration Days variable.

The Charge For Uploading Multimedia Files 1150 box is checked if the administrator wants to charge end users for uploading multimedia files (photos, sound clips, or video clips) to their ads. If the administrator does not wish to charge for uploading multimedia files, this box is left unchecked. The Amount of Charge for Uploading Multimedia Files 1151 variable specifies the fee to be charged for each uploaded multimedia file (photo, sound clip, or video clip). This is activated if the administrator has checked the box for the Charge For Uploading variable.

The Charge for Subscribing to the Auto-Notify service 1152 box is checked if the administrator wants to charge end users for subscribing to the Auto-Notify personal search agent. If the administrator does not wish to charge for the Auto-Notify feature, this box is left unchecked. The Amount of Charge for Subscribing to Auto-Notify 1153 variable specifies the fee to be charged for each Auto-Notify search agent that the administrator sets up. This is activated if the administrator has set the Charge For Auto-Notify variable equal to “on”. No dollar signs or any other currency symbol are in front of this value, which is a numeric value only.

The Charge For Registering 1154 variable determines whether the system charges end users who register. If the administrator turns this on, the administrator sets the amount of the registration charge in the Amount of Charge for Registering variable. This charge is for a subscription period equal to the number of days that the administrator specifies in the Registration Expiration Days variable. If the administrator is charging end users to register, the Amount of Charge For Registering 1155 variable specifies the charge for allowing end users to register for a subscription period equal to the number of days that the administrator specifies in the Registration Expiration Days variable.

If the Require Credit Card for Registration 1156 box is checked, the system requires end users who register to enter their credit card information. Depending on the values that the administrator sets for the variables below, this information is either be e-mailed to the administrator when the end user registers, or it is stored on the server in a file (the administrator can set encryption for this file below).

If the Store Credit Card Numbers on the Server 1157 box is checked, the system stores the credit card numbers and other information entered by end users who register in the user registration database. Unless the administrator is on a secure server (and probably still even then), the administrator also wants to turn on the Encrypt Credit Card variable. This feature is active if the administrator has turned on the Require CC For Registration variable above. If the Encrypt Stored Credit Card Numbers 1158 box is checked, the system encrypts end users' credit card numbers that are stored in the user registration database for fee-based systems. If the Warn Admin if list of invalid credit cards is missing 1159 box is checked, the system e-mails the administrator a warning when it can't find the stolen card list file.

As illustrated in FIGS. 5A and 5B, the Payments Manager section 580 of the control panel 500 enables the administrator to record payments that the administrator has received for ads posted on the system, record refunds that the administrator has issued, send past due notices to end users who have not paid for their ads on time, and reviews payment statistics. The Post Payments 581 option enables the administrator to record payments that the administrator has received from end users who have posted ads. The Post Refunds 582 option enables the administrator to record refunds that the administrator has issued to end users who have posted ads.

The Send Past Due Notices 583 option enables the administrator to send past due notices to end users who have posted ads on the system and have not paid their invoices on time. The Review Payment Statistics 584 option enables the administrator to review various payment statistics, including revenues from new ads and renewals, current receivables and any past due receivables as well as any refunds that the administrator may have issued.

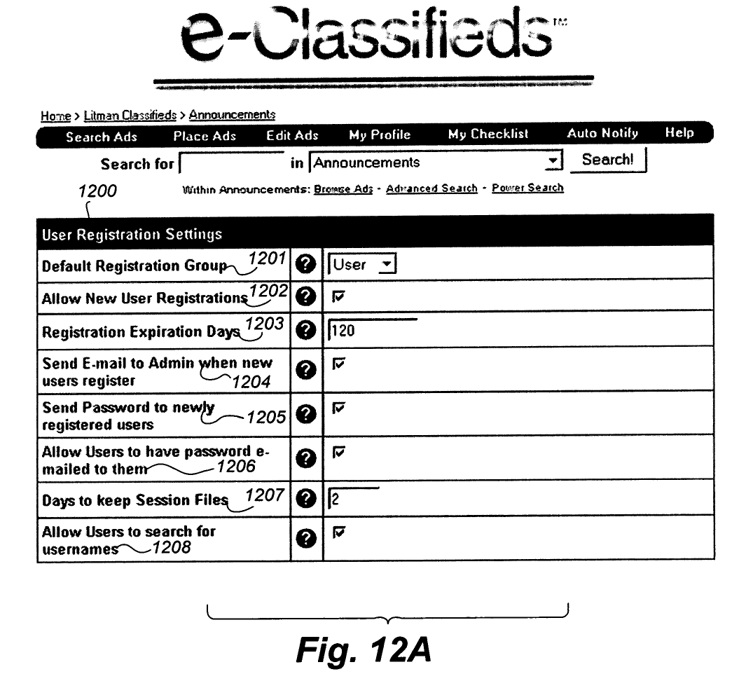

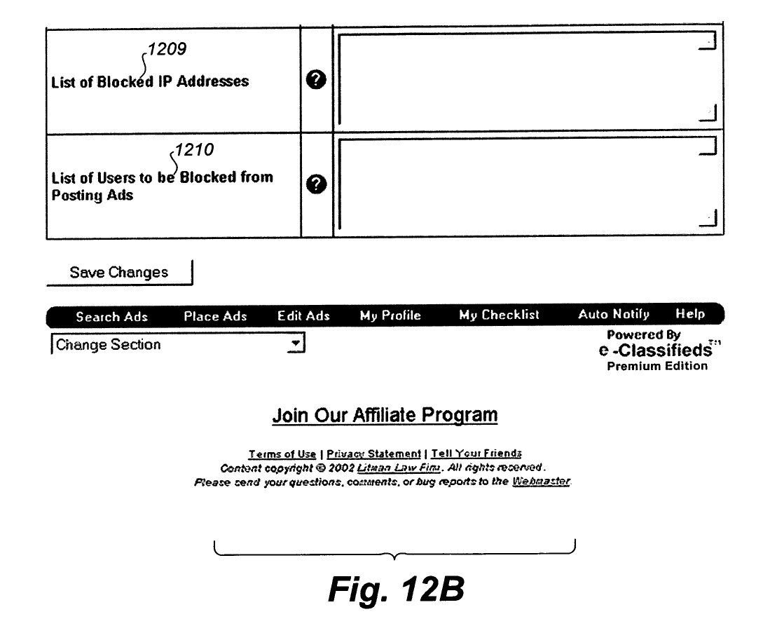

Referring to FIGS. 12A and 12B, the User Registration Settings form 1200 enables the administrator to set various options related to the end user registration system. The Default Registration Group 1201 variable specifies the default group for new end users who register. This should normally be set to “User”. If the administrator wants to register another administrator, the administrator can set this to “Admin”, save the changes, and register the new user as the admin. The original administrator then goes back to the User Registration Settings form and changes this setting back to “User”. Otherwise, the administrator risks giving outside end users “administrator” status. Thus, this aspect of the system enables for multiple tiered end user registrations (including multiple classifieds administrators) with unique privileges for each.

The Allow New User Registrations 1202 variable determines whether new end users can register. This is normally turned on by checking this box, but the administrator can turn it off (by unchecking this box) if the administrator does not want to allow registrations. Unchecking the box results in the “Register for Account” link not being displayed on the logon form. The Registration Expiration Days 1203 variable specifies the number of days before a user registration expires if there is no activity. This number should be set to a higher number of days than the highest value that the administrator set for the Ad Duration variable, because the administrator doesn't want to purge the registration information for users who still have current ads in the system.

If the Send E-mail to Admin When New Users Register 1204 box is checked, the system e-mails the admin whenever a new user registers on the system. If the Send Password to Newly Registered Users 1205 box is checked, the system e-mails a welcome notice to new users that includes their username and password. If the Allow Users to Have Password E-Mailed To Them 1206 box is checked, the system allows users who forget their passwords to have them e-mailed to them based on their username, and it adds a link for this purpose to the logon form. The Days to Keep Session Files 1207 variable specifies the number of days that session files is kept before they are automatically deleted. If the Allow Users to Search For Usernames 1208 box is checked, the system enables users to search for their username based upon their e-mail address. Unchecking it removes the “Forgot Username” link on the logon form.

As illustrated in FIGS. 5A and 5B, in the Users Maintenance section of the Control Panel 521, the Edit User Registrations 522 option enables the administrator to edit the registration information for any of the users. This includes modifying any of their information or deleting their registration altogether. The Purge Expired User Registrations 523 option enables the administrator to purge all end users from the registration database whose accounts have had no activity within the past one hundred and twenty days, as specified in the global configuration variables. The administrator might want to run this option periodically if the user registration database (contained in the default.users file in the “users” subdirectory) becomes large. The Delete All User Registrations 524 option enables the administrator to delete all users from the registration database.

Referring back to FIGS. 12A and 12B, the List of Blocked IP Addresses 1209 variable contains the list of IP addresses of users that the administrator wants to block access to. If the administrator does not want to block access to any users, the administrator can leave this blank. Since some users may have dynamic IP addresses (IP addresses that are different each time they logon to the Internet), the administrator may want to set this equal to the first three sections of digits of their IP address (such as 111.222.333 for an IP address of 111.222.333.444). The List of Users to be Blocked from Posting Ads 1210 variable contains the list of user names that the administrator wants to block access to. If the administrator doesn't want to block access to any users, the administrator can leave this blank. The system compares the user names specified here against the session user name of the current user (which is the user name that they specified when registering) and prevents that user from posting new ads if there is a match. Each value is listed on a separate line.

As illustrated in FIGS. 5A and 5B, in the System Log Options area 527 of the control panel 500, the View Log of Blocked IP Addresses 528 option enables the administrator to view the log of failed attempts to post new ads by users whose IP addresses were blocked. Each failed attempt is listed on a separate line, with the content of their failed ad contained on that line. The administrator can use the “Save” feature of his or her browser to save this file. If there are no entries in this log, the administrator may see a blank screen or receive a “Document contains no data” message. The Clear Log of Blocked IP Addresses 529 option allows the administrator to clear the log of failed attempts to post new ads by users whose IP addresses were blocked. The administrator may want to clear this log periodically after the administrator has viewed it using the form above.

The View Log of Blocked Usernames 530 option allows the administrator to view the log of failed attempts to post new ads by users whose usernames were blocked. Each failed attempt is listed on a separate line, with the content of their failed ad contained on that line. The administrator can use the “Save” feature of the administrator's browser to save this file. If there are no entries in this log, the administrator may see a blank screen or receive a “Document contains no data” message. The Clear Log of Blocked Usernames 531 option enables the administrator to clear the log of failed attempts to post new ads by users whose usernames were blocked. The administrator may want to clear this log periodically after he/she has viewed it using the form above.

As illustrated in FIGS. 5A and 5B, the Set System Maintenance Options section 510 of the control panel 500 enables the administrator to set various options related to the maintenance of the system, such as which routines should be run automatically, at what intervals, and other variables related to these settings. There are several different ways that the administrator can activate these features, although the preferred and easiest method is to use the system's built-in routines. The system can automatically run its own built-in category counter, total ad counter, warn, purge, Auto-Notify, Auto-Notify purge, user purge, HTML page creation, backup, and DataGuard routines at periodic intervals. These can be set up very easily by checking the appropriate boxes and setting a few of the other related variables, such as the intervals during which these routines should be run.

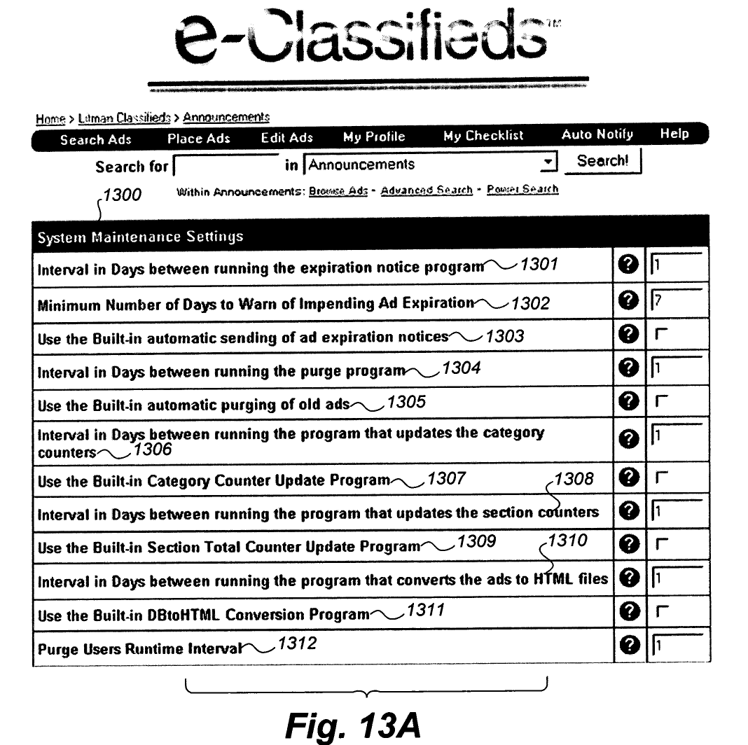

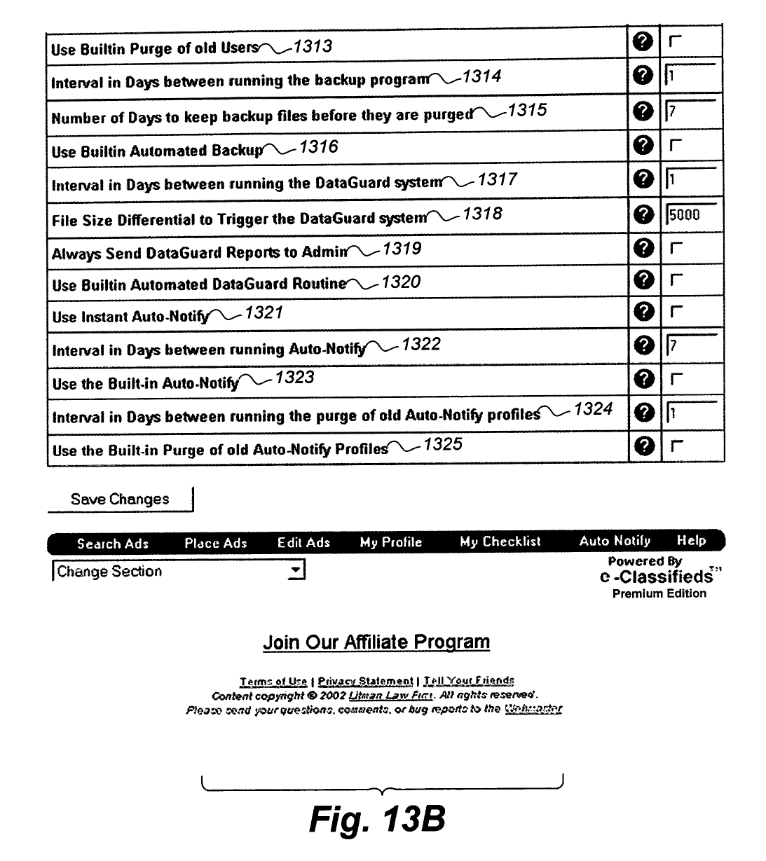

As illustrated in FIGS. 13A and 13B, the Interval in Days Between Running the Expiration Notice Program 1301 variable specifies the minimum number of days in between each time that the administrator wants to run the “warn” routine that sends out warning notices to those users whose ads are about to expire. That way, it won't be run more often, causing unnecessary system overhead for the server and causing users to receive multiple, annoying e-mail messages.

If the administrator is running the warn routine as a cron job, the value here is exactly the same as the number of days in between each time that the administrator is running the cron job. In other words, if it runs each day, this value is set equal to “1”. If it runs once a week (every seven days), this value is set equal to “7”. It is suggested that the administrator run the cron job once a day and set the value here equal to “1”. The Minimum Number of Days to Warn of Impending Ad Expiration 1302 variable sets the minimum number of days before each end user's ad is about to expire that the system should send this end user the e-mail notice warning him or her of the imminent expiration of the ad. If the administrator is able to run the “warn” system daily (either as a cron job, manually, or because the administrator's site gets enough traffic that the system is run in each section on each day so that the built-in warn system for that section is run each day) and thus has set the Warn Runtime Interval variable below equal to “1”, then all of the users receives this warning notice exactly on the number of days before the ad expires that the administrator specifies here.

The Use the Built-in Automatic Sending of Ad Expiration Notices 1303 box should be checked only if the administrator is not using the separate warn.???.pl files and the administrator cannot or does not want to have to manually run the warn routine each day. If this is turned on by checking the box, the system periodically warns end users whose ads are about to expire (the interval depends on the number of days that the administrator specifies in the Warn Runtime Interval). If the administrator is running Unix and has access to “cron” jobs, the administrator can use cron to automatically run the warn.???.pl files to send out the warning notices and can leave this box unchecked.

This is because the built-in version causes additional server overhead and may not run at the exact time periods that the administrator likes because it is dependent on user actions (it can run only when the system is actually being used). As a result, some users may not receive warning notices before their ads expire. Therefore, the administrator checks this box if the administrator has no other choice and cannot or does not want to manually run the warn routine on a regular, periodic basis (meaning every three days, every seven days, etc.). The Interval in Days Between Running the Purge Program 1304 variable specifies the minimum number of days in between each time that the administrator wants to run the “purge” routine that purges all ads that are older than the number of days that the administrator specified in the variable. That way, it won't be run more often, causing unnecessary system overhead for the server. If the administrator is not sure how to set this, then the administrator leaves it set equal to “1”.

The Use the Built-In Automatic Purging of Old Ads 1305 box should be checked only if the administrator is not using the separate purge.???.pl files and the administrator wants the system to automatically purge ads that have expired. If the administrator is running Unix and has access to “cron” jobs, the administrator should use cron to automatically run the purge.???.pl files to purge old ads and can leave this box unchecked. This is because the built-in version causes additional server overhead and may not run at the exact time periods that the administrator likes because it is dependent on end user actions (it can run only when the system is actually being used).

The Interval in Days Between Running the Program That Updates the Category Counters 1306 variable specifies the minimum number of days in between each time that the administrator wants to run the “category counter” system that counts the number of ads that are placed in each category and updates the display of these numbers on the front page of each section. That way, it won't be run more often, causing unnecessary system overhead for the server. If the administrator is not sure how to set this, it is suggested that the administrator leave it set equal to “1”.

The Use the Built-in Category Counter Update Program 1307 box should be checked only if the administrator is not using the separate catcount.???.pl file and the administrator wants the system to automatically update the category counters for each section. If the administrator is running Unix and has access to “cron” jobs, it is suggested that the administrator use cron to automatically run the catcount.???.pl files to update the category counters and that the administrator leave this box unchecked. This is because the built-in version causes additional server overhead and may not run at the exact time periods that the administrator likes because it is dependent on end user actions (it can run only when the system is actually being used).

The Interval in Days Between Running the Program That Updates the Section Counters 1308 variable specifies the minimum number of days in between each time that the administrator wants to run the “total counter” system that counts the total number of ads that have been placed in this section and updates the display of this number on the overall front page of the system. That way, it won't be run more often, causing unnecessary system overhead for the server. If the administrator is not sure how to set this, it is suggested that the administrator leave it set equal to “1”.

The Use the Built-in Section Total Counter Update Program 1309 box is checked if the administrator is not using the separate total.???.pl files and the administrator wants the system to automatically update the counters for the total number of ads in each section. If the administrator is running Unix and has access to “cron” jobs, it is strongly suggested that the administrator use cron to automatically run the totalcount.???.pl files to update the section total counters and that the administrator leave this box unchecked. This is because the built-in version causes additional server overhead and may not run at the exact time periods that the administrator likes because it is dependent on user actions (it can run only when the system is actually being used).

The Interval in Days Between Running the Program That Converts the Ads to HTML Files 1310 variable specifies the minimum number of days in between each time that the administrator wants to run the “DBtoHTML” system that converts the ads to HTML files. That way, it won't be run more often, causing unnecessary system overhead for the server. If the administrator is not sure how to set this, the administrator should leave it set equal to “1”. The Use the Built-in DBtoHTML Conversion Program 1311 box should be checked only if the administrator is not using the separate dbtohtml.???.pl files and the administrator wants the system to automatically convert the ads to HTML files periodically.

If the administrator is running Unix and has access to “cron” jobs, it is strongly suggested that the administrator use cron to automatically run the DBtoHTML.???.pl files to convert the ads to HTML files and that the administrator leave this box unchecked. This is because the built-in version causes additional server overhead and may not run at the exact time periods that the administrator likes because it is dependent on end user actions (it can run only when the system is actually being used).

The Purge Users Runtime Interval 1312 variable specifies the minimum number of days in between each time that the administrator wants to run the user purge system. That way, it won't be run more often, causing unnecessary system overhead for the server. If the administrator is not sure how to set this, it is suggested that the administrator leave it set equal to “1”. The Use Built-in Purge of Old Users 1313 box is checked if the administrator is not using the separate USERPURGE.PL file and the administrator wants the system to automatically purge end users who have had no activity for a specific period of days (as defined in the Registration Expiration Days variable) and who are not currently signed up for Auto-Notify in any of the database sections.

As illustrated in FIGS. 5A and 5B, if the administrator has had the system create backups periodically, and if these are still intact, the administrator can restore from these backups through the Control Panel 585. The administrator has the option of restoring whole backups or individual files from these backups.

Referring again to FIGS. 13A and 13B, these backup variables are explained in greater detail below. The Interval in Days Between Running the Backup Program 1314 variable specifies the minimum number of days in between each time that the administrator wants to run the “backup” system that creates a backup of all of the administrator's important data files. That way, it won't be run more often, causing unnecessary system overhead for the server. If the administrator is not sure how to set this, we suggest that the administrator leave it set equal to “1”. The Number of Days to Keep Backup Files Before They Are Purged 1315 variable specifies the number of days that the system will keep old backup files before they are automatically purged.

If the backup files are never purged, the amount of disk space that they take up can become quite large, since each system backup creates backup files for all of the ads databases, Auto-Notify profiles, and registered end users. Thus, it is important to allow the system to periodically purge these files. On the other hand, they can be kept long enough so that the administrator has time to restore an older, clean backup if the administrator doesn't discover a data problem right away and some of the more recent backups are corrupted. A good default value might be seven days.

The Use Builtin Automated Backup 1316 box is checked if the administrator is not using the separate BACKUP.PL file and the administrator wants the system to automatically back up the administrator's important data files, which includes the ads databases, the Auto-Notify profiles, and user registration database. The Interval in Days Between Running the DataGuard System 1317 variable specifies the minimum number of days in between each time that the administrator wants to run the “DataGuard” system that checks all of the administrator's important data files to see if they have unexpectedly shrunk in size, which can indicate that they have been corrupted or deleted. That way, it won't be run more often, causing unnecessary system overhead for the server. If the administrator is not sure how to set this variable, it is suggested that the administrator leave it set equal to “1”.

The File Size Differential to Trigger the DataGuard System 1318 variable specifies the file size differential that triggers the DataGuard system to display or e-mail a warning message to the administrator. In other words, if the current data file is smaller than the last equivalent backup data file by this many bytes or more, the warning system is triggered, which can alert the administrator to potential corruption or deletion of an important data file. If the administrator is not sure how to set this variable, it is recommended that the administrator leave it set equal to “5000”.

The Always Send. DataGuard Reports to Admin 1319 box is checked if the administrator wants the DataGuard system to always send e-mail reports to the administrator, even when it doesn't find any problems. If this box is not checked, the DataGuard system sends e-mail reports to the administrator when it detects potential problems with one or more of the administrator's important data files. The Use Built-in Automated DataGuard Routine 1320 box should be checked only if the administrator is not using the separate DATAGUARD.PL file and the administrator wants the system to automatically run the DataGuard routine that checks the administrator's important data files to see if they have shrunk unexpectedly, which can indicate that they have been corrupted or deleted. These files include the ads databases, the Auto-Notify profiles, and the user registration database.

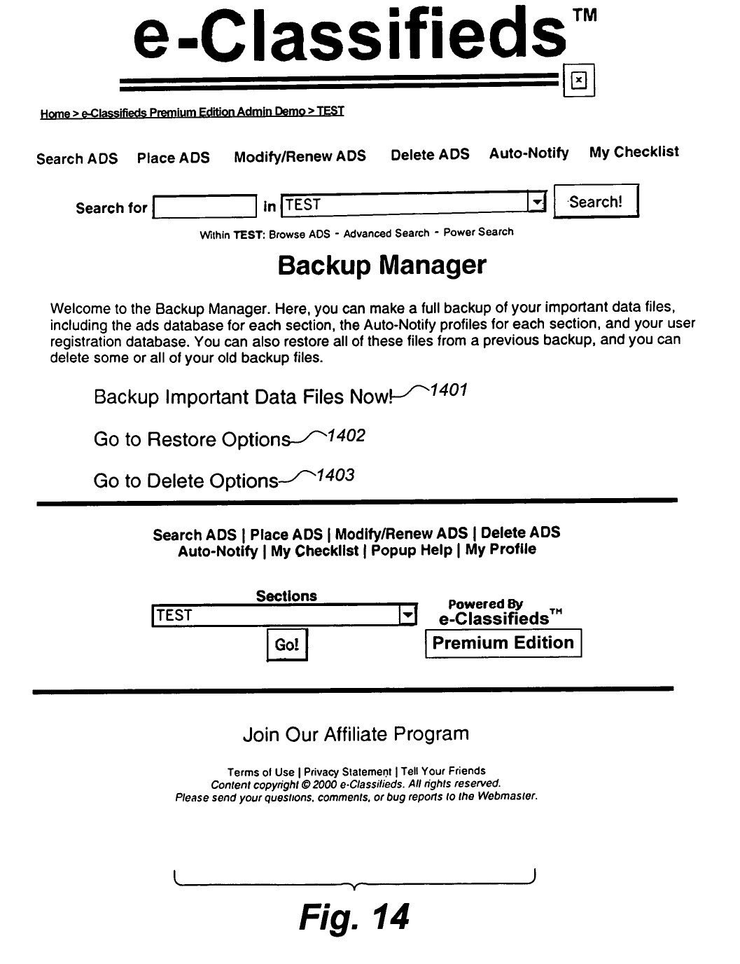

Referring to FIG. 14, the Backup Options section of the Control Panel 585 enables the administrator to backup the administrator's important data files, restore from a previous backup, and run the DataGuard routine that checks the administrator's current data files to see if they have been corrupted. The administrator is presented with three options using the Backup Manager 586: Backup Important Data Files Now 1401, Go to Restore Options 1402 and Go to Delete Options 1403. Clicking on Backup Important Data Files Now 1401 causes the system to make a full backup of important data files, including the ad database for each section, the Auto-Notify profiles for each section, and the user registration database. The administrator can restore all of these files from a previous backup, and the administrator can delete some or all of the old backup files.

Clicking on Go to Restore Options 1402 causes the current backups (if any) to be displayed based on the time that they were created. If the administrator wants to restore important data files from one of these backups, the radio button next to the backup group that the administrator would like to restore is chosen. This action overwrites all of the data files including all of the ad databases, all of the Auto-Notify profiles, and the entire end user registration database. If the administrator wants to restore an individual file, rather than the entire backup set, he/she clicks on the View All Individual Backup Files link to view all of the individual backup files. Clicking on Go to Delete Options 1403 lists current backups (if any) based on the time that they are created. The admin can delete one or more of these backups by checking the box next to each backup group that is to be deleted. If the admin wants to delete all backup files, click on the “Delete All Backups” link. Once these files are deleted, they cannot be recovered.

Referring back to FIGS. 5A and 5B, the DataGuard 587 option runs the DataGuard system, which checks all of the administrator's important data files to see if they have unexpectedly shrunk in size, which can indicate that they have been corrupted or deleted. If there are no backups created, a message appears stating that the DataGuard routine is not able to compare current data to backups because there are currently no backups.

Referring back to FIGS. 13A and 13B, the Always Send DataGuard Reports to Admin 1319 box is checked only if the admin wants the DataGuard system to always send e-mail reports to him or her, even when it doesn't find any problems. If this box is not checked, the DataGuard system sends e-mail reports to the admin when it detects potential problems with one or more important data files.

The Use Builtin Automated DataGuard Routine 1320 box is checked if the admin is not using the separate DATAGUARD.PL file and he or she wants the script to automatically run the DataGuard routine that checks the important data files to see if they have shrunk unexpectedly, which can indicate that they have been corrupted or deleted. These files include the ads databases, the Auto-Notify profiles, and the user registration database. The Auto-Notify system enables the administrator to run the Auto Notify system that sends the ads that match each end user's pre-defined criteria.

The Use Instant Auto-Notify 1321 variable determines whether the system runs the Auto-Notify system immediately after a new ad is posted. The advantage of checking this box is that subscribers are notified of new ads matching their search criteria immediately. The disadvantage is that the Auto-Notify routines run every time a new ad is posted, which can start to use a lot of system resources if the system gets a lot of new ads. In that case, the administrator might want to leave this box unchecked and then run the Auto-Notify system at regular timed intervals using the variables below. If this box is checked, the regular version of Auto-Notify that runs at timed, periodic intervals and that is defined by the variables below are automatically disabled by the system in order to prevent subscribers from receiving multiple notices for the same new ad.

Also, if the administrator is requiring administrative approval of new ads and thus has set the Require Admin Approval variable equal to “on” by checking its box, the administrator can turn off the Use Instant Auto-Notify variable, as there is no point in running it since it won't send ads that have not yet been approved out to subscribers. Also, if the administrator uses Instant Auto-Notify, the options for being notified only of ads with photos, sound clips, or video clips are disabled, since these are not actually included in the ad until after it has been posted, and after the Instant Auto-Notify engine is run.

The Interval in Days Between Running Auto-Notify 1322 variable specifies the number of days in between each time that the administrator wants to run the Auto-Notify system. That way, it won't be run more often, causing users to receive multiple, annoying e-mail messages. If the administrator wants to run Auto-Notify once a week, for example, the administrator would set this variable equal to “7”, for a seven day interval. This also specifies the number of days back that the ads are included in the periodic notices. In other words, if the administrator set this equal to “7”, then the search agent will retrieve only those ads that match the user's search criteria and that were posted within the past seven days.

The Use the Built-in Auto-Notify 1323 box is checked if the administrator wants the system to automatically use its built-in Auto-Notify feature. If the administrator has access to “cron jobs” or some other process that can automatically run the separate autonotify.pl files, the administrator can leave this box unchecked. The Interval in Days between running the purge of old Auto-Notify profiles 1324 variable specifies the minimum number of days in between each time that the administrator wants to run the “Auto-Notify purge” system that purges the Auto-Notify profiles that have expired. That way, it won't be run more often, causing unnecessary system overhead for the server.

If the administrator is not sure how to set this, we suggest that the administrator leave it set equal to “1”. The Use the Built-in Purge of Old Auto-Notify Profiles 1325 box is checked if the administrator wants the system to automatically use its built-in purging of old Auto-Notify profiles. If the administrator has access to “cron jobs” or some other process that can automatically run the separate autonotify_purge.pl files, the administrator can leave this box unchecked.

Referring to FIGS. 5A and 5B, the Auto-Notify Maintenance Section of the Control Panel 570 contains a Run Auto Notify Program 571 option that enables the administrator to run the Auto Notify system, which causes the system to perform a search for each end user who has signed up for the Auto-Notify feature and e-mail that person with a message containing a short description of all ads matching his or her search criteria that have been posted in the past seven days. The message contains links to the full ads in the database. The Purge Old Auto-Notify Profiles 572 option enables the administrator to purge all Auto-Notify profiles that have expired. The Edit Users' Auto-Notify Profiles 573 option enables the administrator to modify or delete the Auto-Notify profiles that users have set up on the system.

The administrator might want to do this if the administrator is receiving bounced mail back from an e-mail address that a user specified when setting up their profile, but that is no longer valid. Each Auto-Notify message that is sent out contains the ID number for that profile, as well as the section that it was created in, so the administrator can enter this profile ID number in the form that the administrator sees after he or she clicks on the “Modify” or “Delete” button. The administrator can modify or delete any user's profile. The Delete All Auto-Notify Profiles 574 option enables the administrator to delete all Auto-Notify profiles for the particular section.

As illustrated in FIGS. 5A and 5B, the Template Editor 511 enables the administrator to modify the HTML for the general page layout of all pages generated by the system. The Template Editor 511 also enables the administrator to create customized page displays for each of the top-level sections, as well as for each affiliate Web site (and even for each section within each affiliate Web site). There are several pre-defined templates to choose from, or an administrator can create their own either by entering the raw HTML code or importing it from a file created by another HTML editor such as Dreamweaver or Frontpage.

It is also possible to modify the HTML and system code contained in the “Objects” used in the Template Editor 511. The administrator can also move “objects” for various items such as advertising banners, the navigation bar, and more around the page. Other template driven systems are typically more restrictive in allowing these type of changes.

The Set Visibility Options option 512 enables the administrator via the Control Panel to define the visibility options, if any, that are available to ad posters who wish to pay an extra fee to raise the visibility of their ad. These options might include displaying the ad in bold text, in red text, with an extra graphic, or in some other manner.

The Set Priority Ranking Options area 513 of the control panel 500 enables the administrator to define priority ranking options, if any, that are available to ad posters who wish to pay an extra fee to enable their ad to be displayed higher up in the search results. The administrator can also set multiple tiers and pricing levels if desired.

The Sections Manager section of the Control Panel 575 enables the administrator to create new sections 576 in addition to the default sections that come with the system or to modify 577 or delete existing sections 578. After making a selection, an online wizard helps to complete these actions.

The Ads Maintenance section of the Control Panel 550 provides a number of options relating to the ads posted by end users on the system. The administrator can modify or delete any ad posted by any end user by clicking on the Modify User Ads 552 or Delete User Ads 553 links. If the administrator has turned ad moderation on, the administrator can also preview new ads that have been posted by clicking on the Preview New Ads 551 link.

The administrator can modify the multimedia files that end users have uploaded to their ads by clicking on the Edit Multimedia Files in User Ads link 554. To send out expiration notices to end users whose ads are about to expire, click on the Send Out Expiration Notices link 555. The administrator can also purge old ads via the Purge Old Ads 556 option. If the administrator wants to delete all ads on the system, the administrator can do so by clicking on the Delete All Ads 557 link. The administrator can also update the counters for both the total number of ads in this section 559, as well as in each subcategory 558. The administrator can also view 560 or clear the logs 561 created by the system when ads are posted, modified, or deleted and the administrator can create HTML pages for all ads in the system 562.

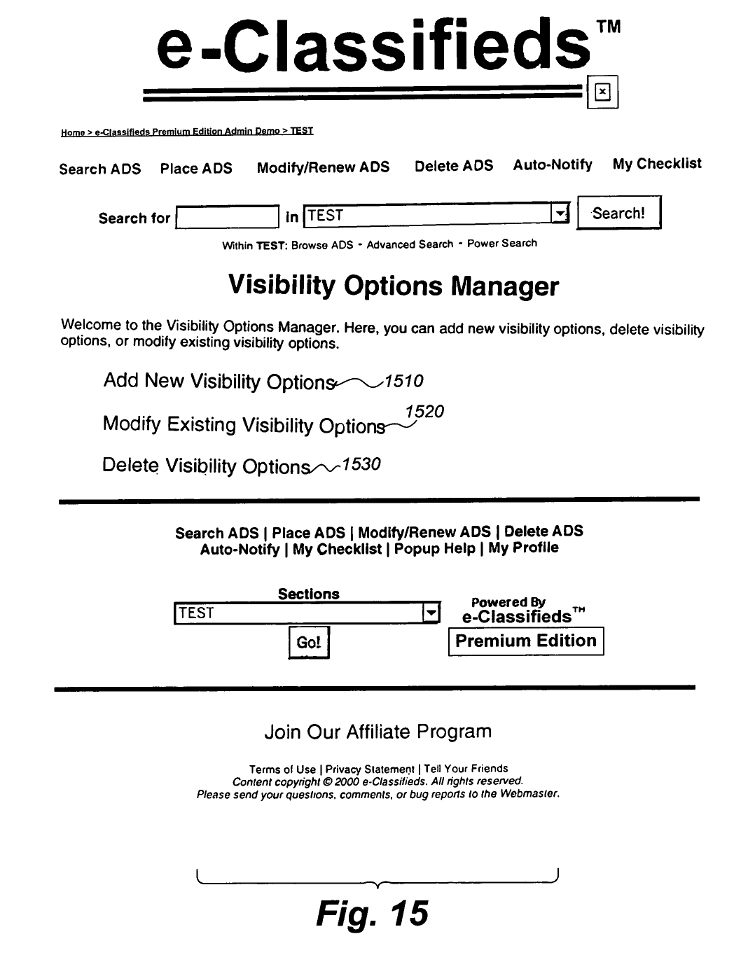

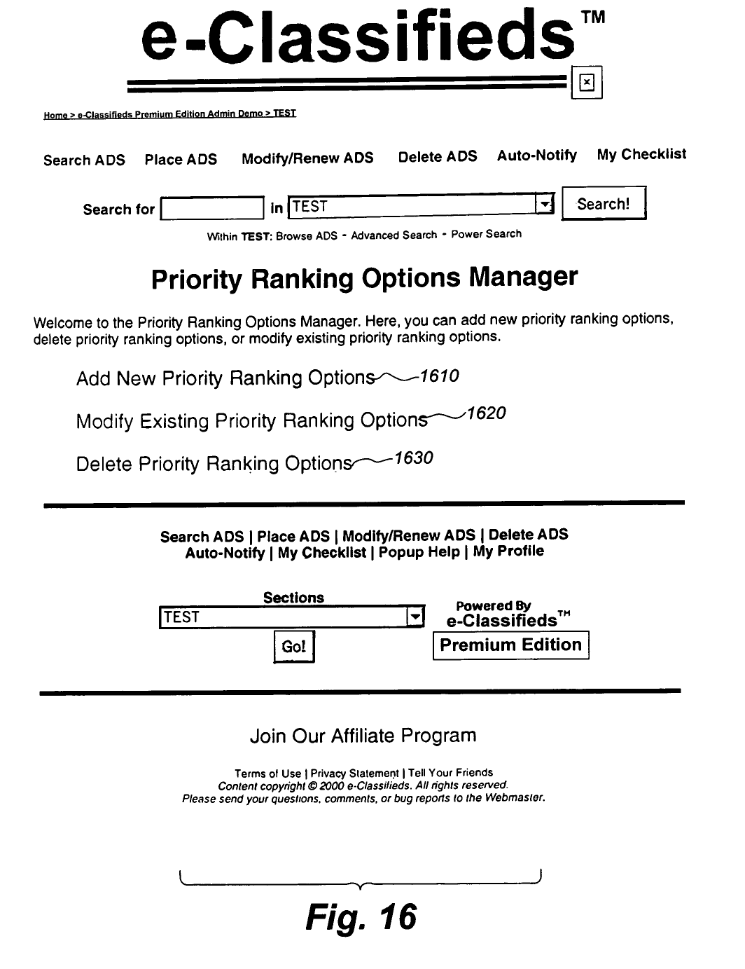

As illustrated in FIG. 15, the administrator chooses through the Visibility Options Manager 1500 whether he or she wants to Add New Visibility Options 1510, Modify Existing Visibility Options 1520 or Delete Existing d Visibility Options 1530. As illustrated in FIG. 16, the administrator can add New Priority Ranking Options 1610, Delete Priority Ranking Options 1630 or Modify Existing Priority Ranking Options 1620.

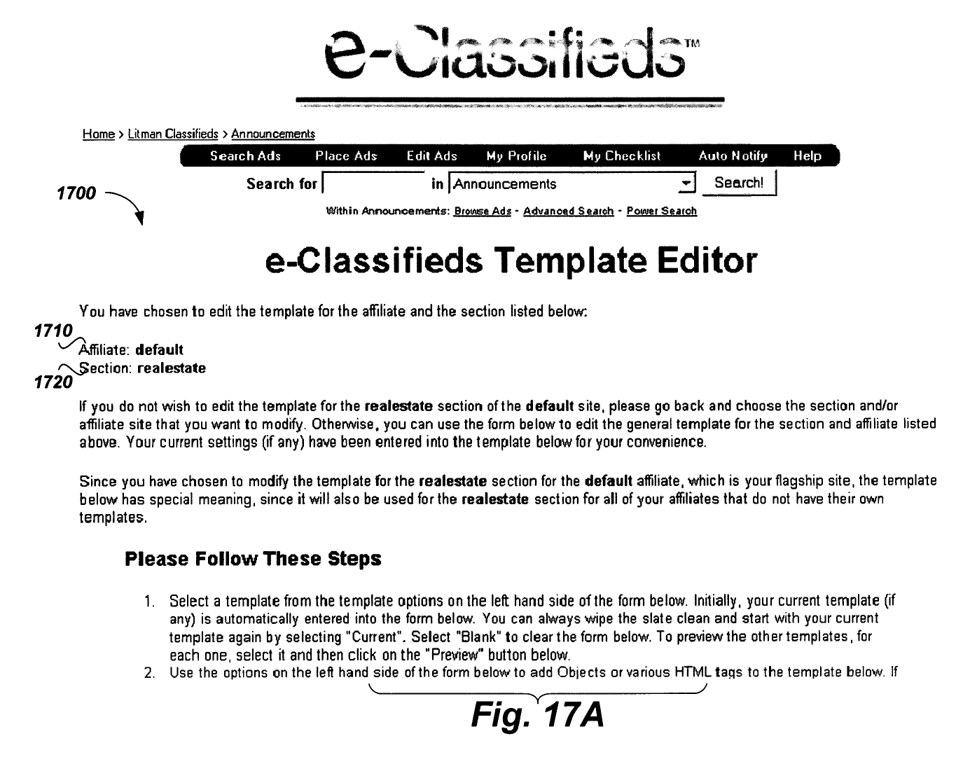

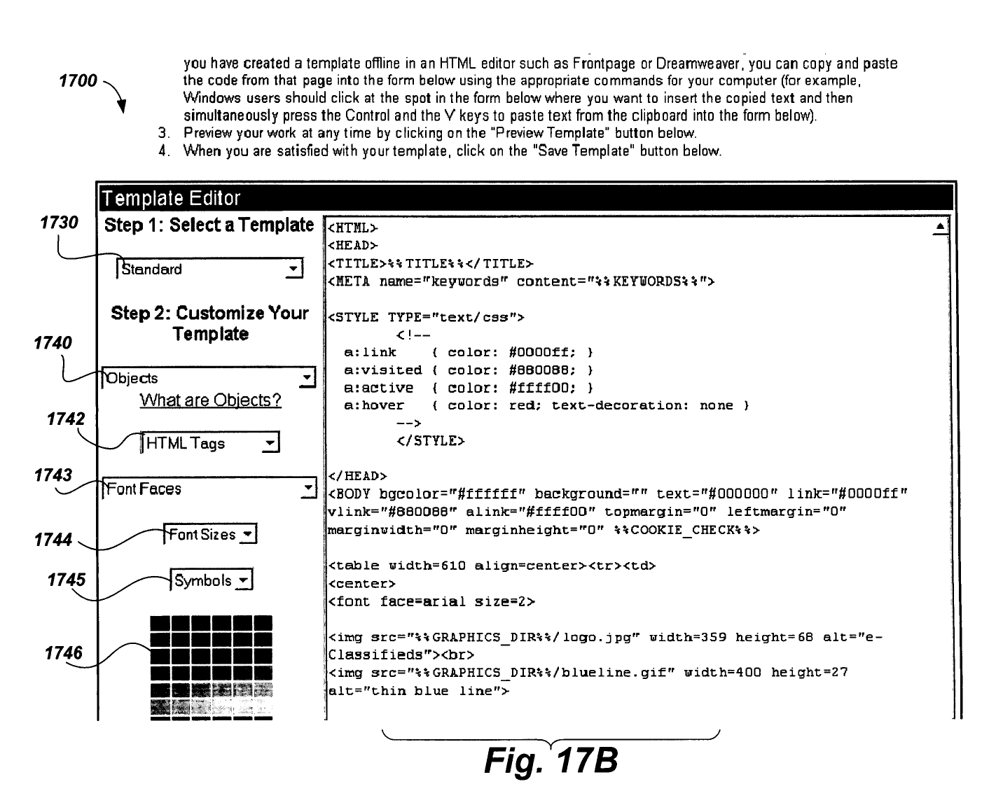

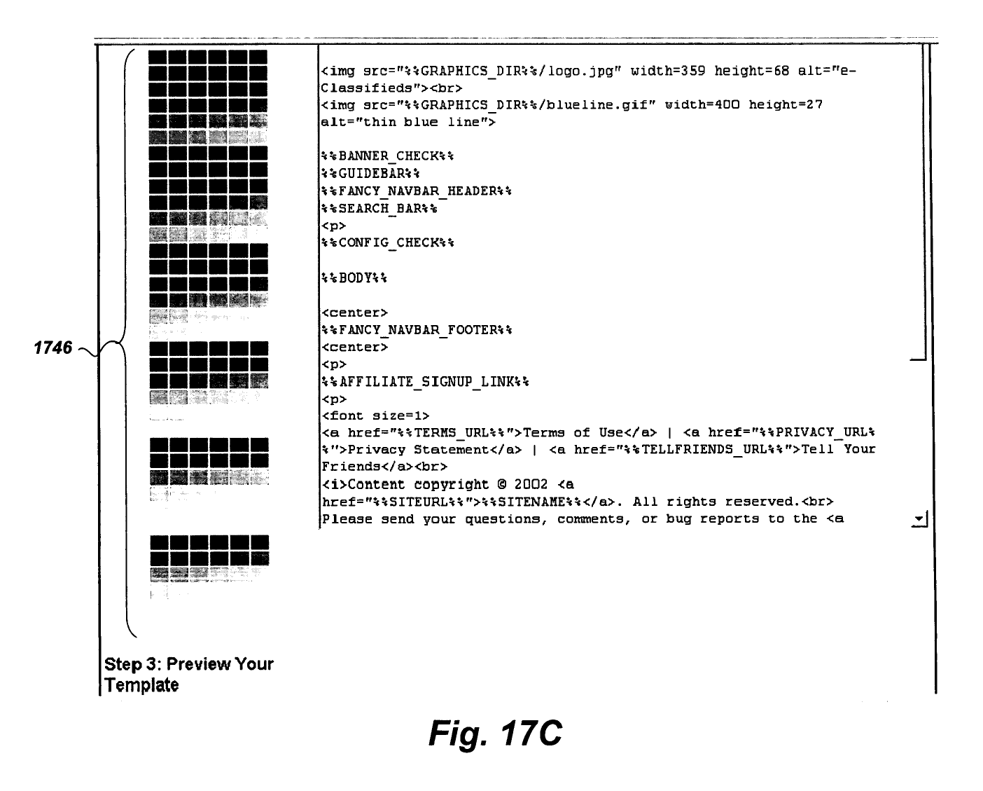

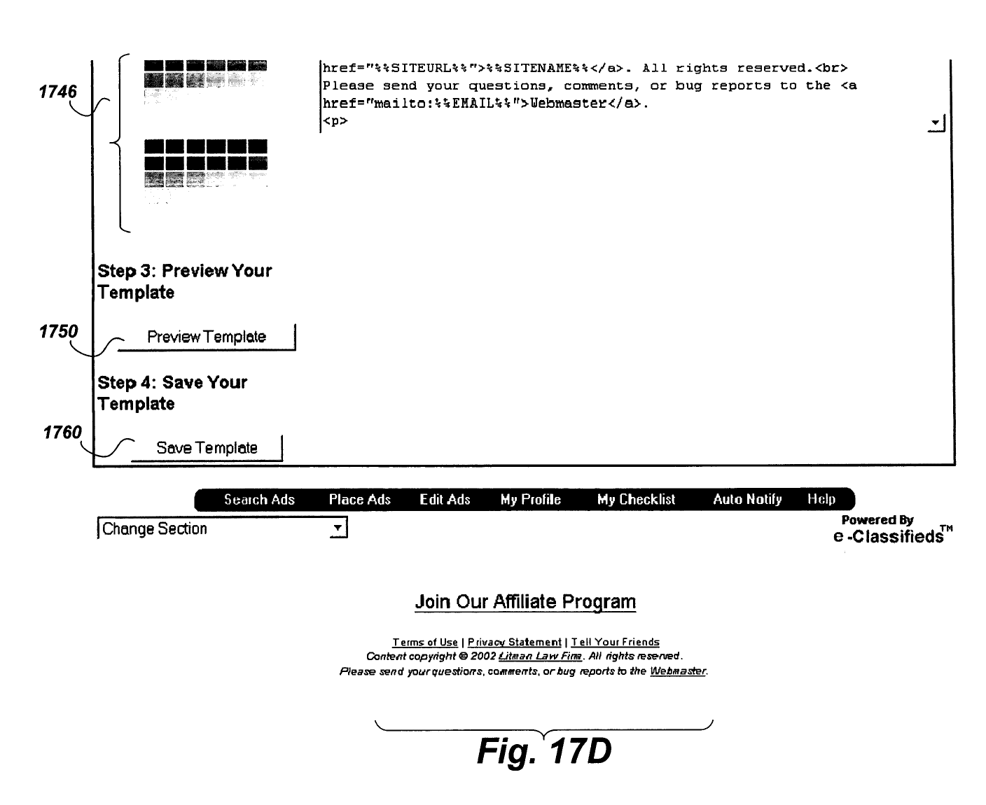

FIGS. 17A, 17B, 17C, and 17D illustrate a template editor 1700 that involves the following steps, as outlined in the margin of FIGS. 17B, 17C, and 17D. The template editor 1700 is used to edit the template for the chosen affiliate (default) 1710 of a chosen section (real estate) 1720. FIGS. 17A and 17B outline the steps needed for using the template editor 1700. First, a user selects a template from the first dropdown menu 1730 on the left side margin of the screen shot on FIG. 17B.

Initially, the current template being used by the user is automatically entered into the template editor 1700. A standard template is provided in addition to other templates that can be selected and previewed by the user. The template can then be customized using the objects dropdown menu 1740, the HTML tags dropdown menu 1742, the font faces dropdown menu 1743, the font sizes 1744 dropdown menu, the symbols dropdown menu 1745 and the color bar menu 1746. The template can then be previewed on the adjacent area to the left margin, as it is being edited by clicking on the preview template button 1750. The template can also then be easily saved by clicking on the save template button 1760.

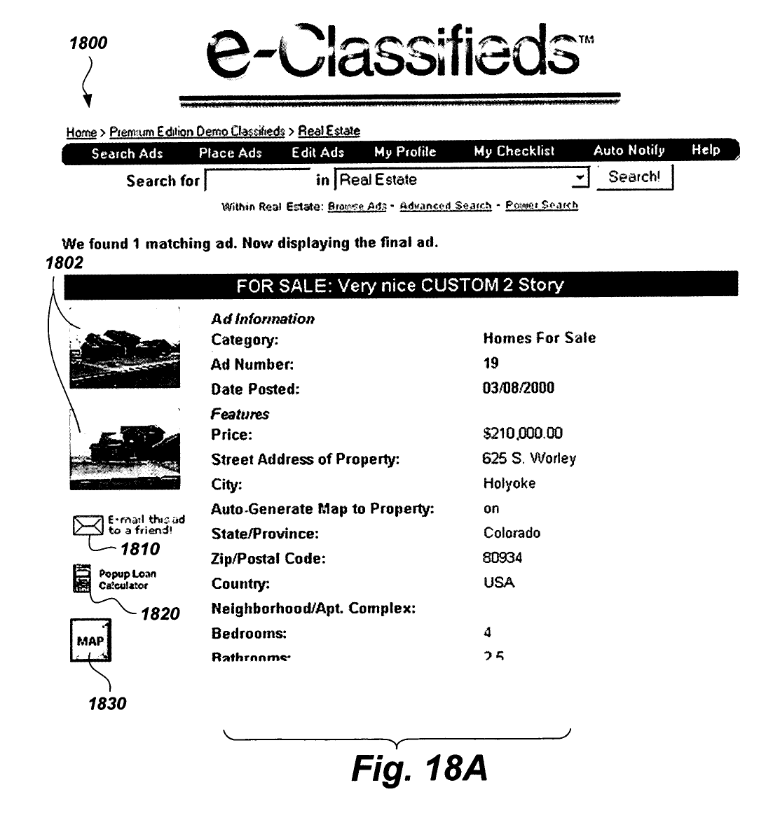

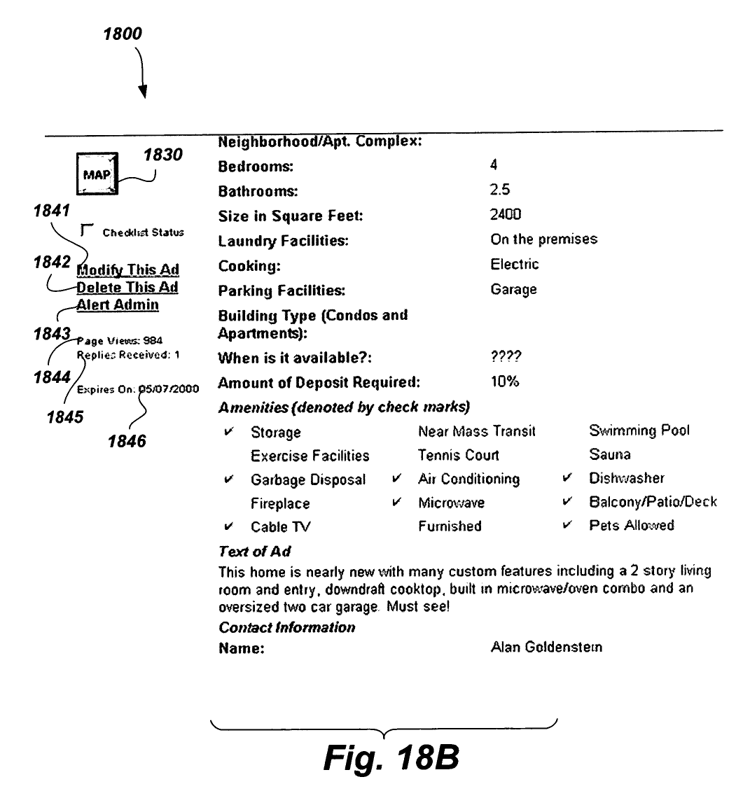

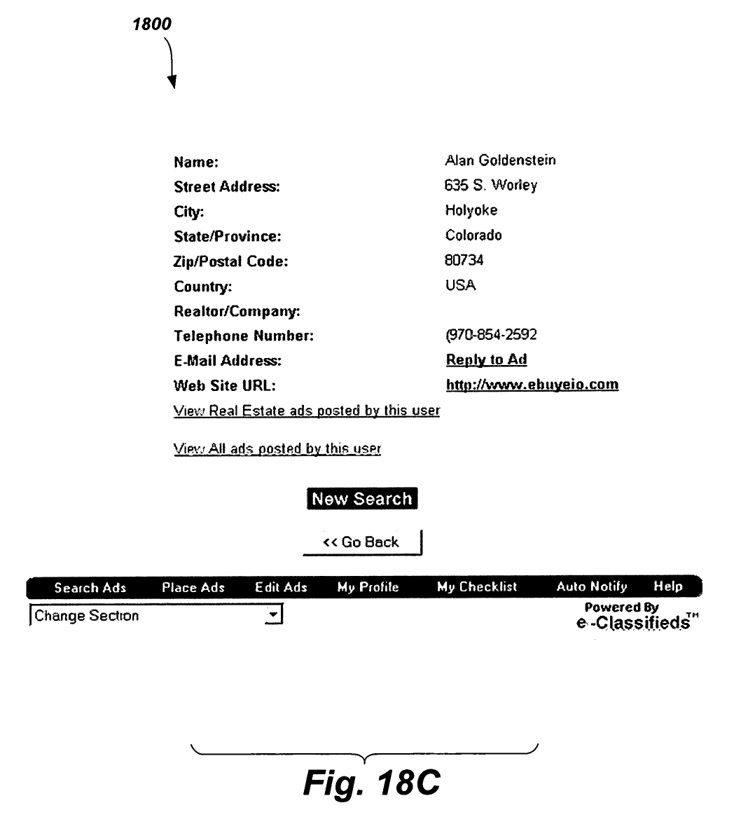

FIGS. 18A, 18B, and 18C illustrate an example of an ad from the real estate section 1800. The ad has several convenient features such as an e-mail icon 1810 to e-mail the ad shown, an icon for a loan calculator 1820, an icon for a map 1830 to the property being described, links to modify the ad 1841, delete the ad 1842 and alert administrators 1843, as well as information on the number of page views 1844, replies received 1845 and when the ad expires 1846. Photos of the property 1802 are also provided in addition to all of the property details that can be edited as outlined in FIGS. 18A, 18B, and 18C.

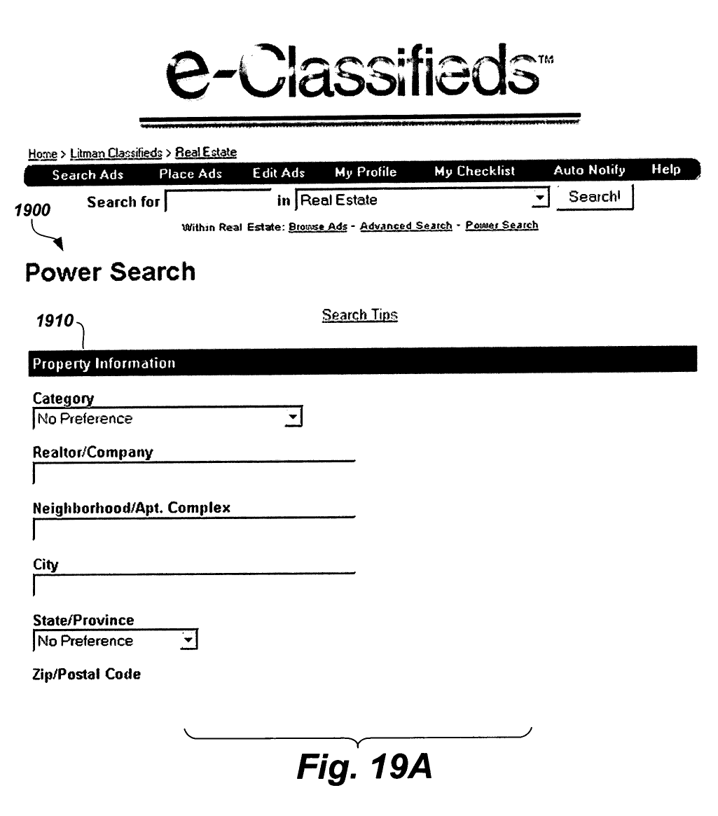

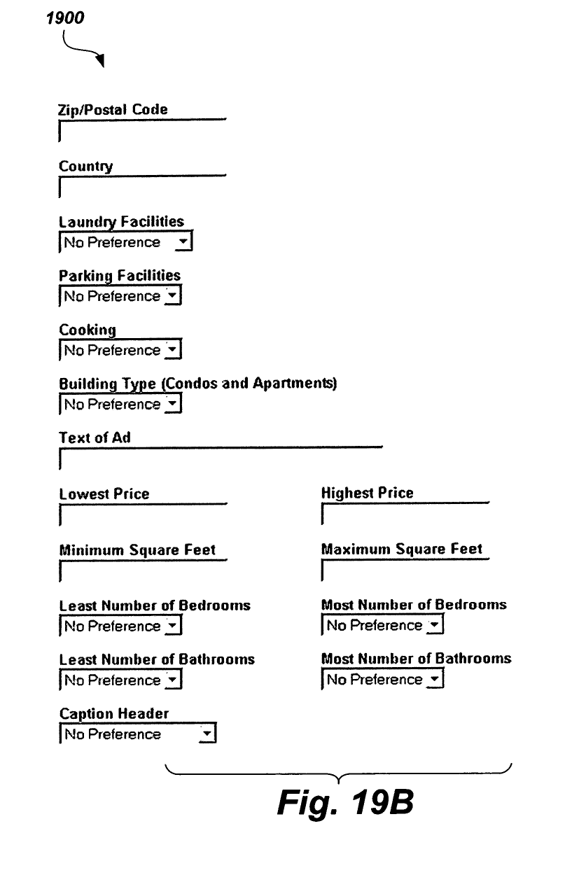

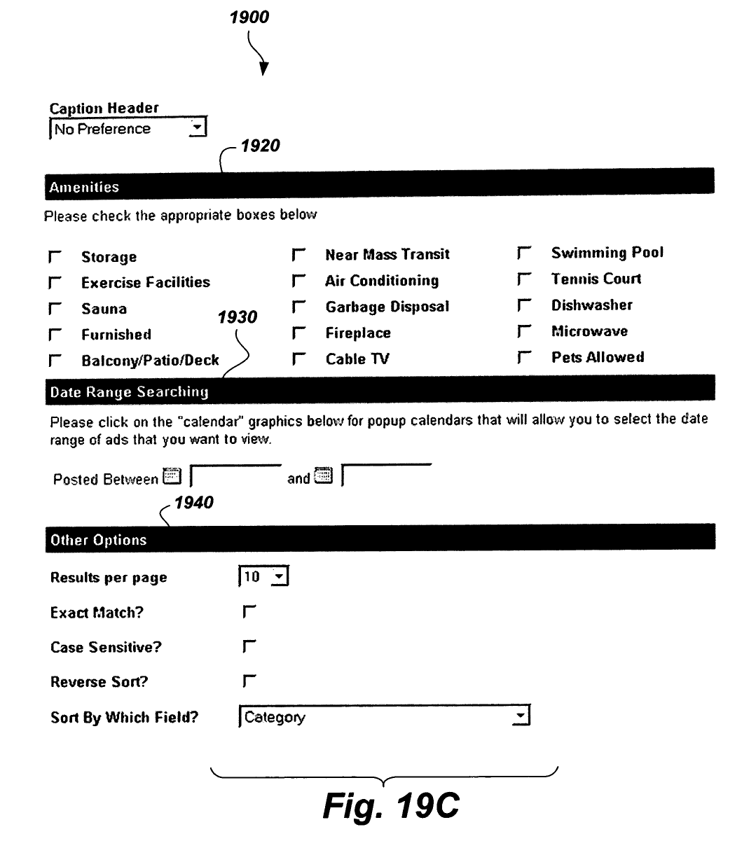

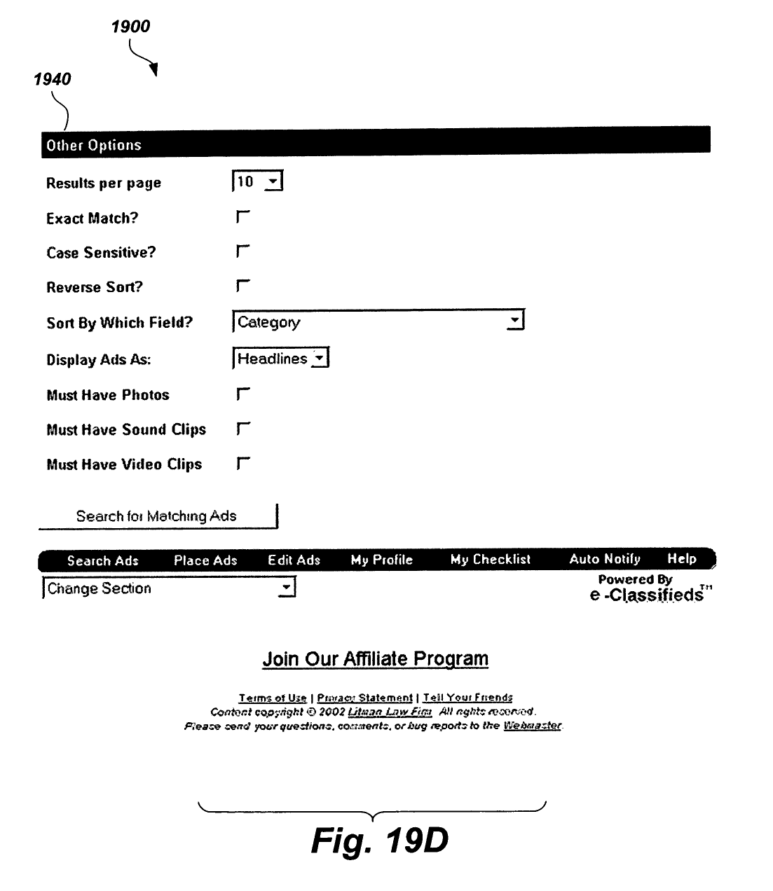

FIGS. 19A, 19B, 19C, and 19D illustrate the power search feature 1900 in the real estate section. Specific property information 1910, specific amenities 1920, date range searching 1930 and other indicated options 1940 are outlined to complement a variety of dropdown menus, fill-in boxes and check boxes that specify specific search parameters. Specific property information 1910 includes a specified chosen category of real estate, the name of the realtor, the name of the apartment or condo complex, city, state/province, zip code, country, presence of laundry facilities, parking facilities, presence of cooking equipment and indication of building type (condo or apartment).

An acceptable lowest price floor and highest price ceiling, a minimum square footage and maximum square footage, a least desired number of bedrooms and bathrooms and a maximum number of bedrooms and bathrooms are all included as part of the property information. Specific amenities 1920 desired include storage, exercise facilities, sauna, furnished facilities, balcony or patio, proximity to mass transit, air conditioning, garbage disposal, fireplace, cable TV, swimming pool, tennis court, dishwasher, microwave and allowing of pets. A date range searching 1930 capability is also provided that enables the user to select the date range of ads wanted for review. A list of other options 1940 are also provided and include sorting capabilities as well as a display function for displaying ads. Inclusion for photos, sound clips and video clips are also part of the other options features.

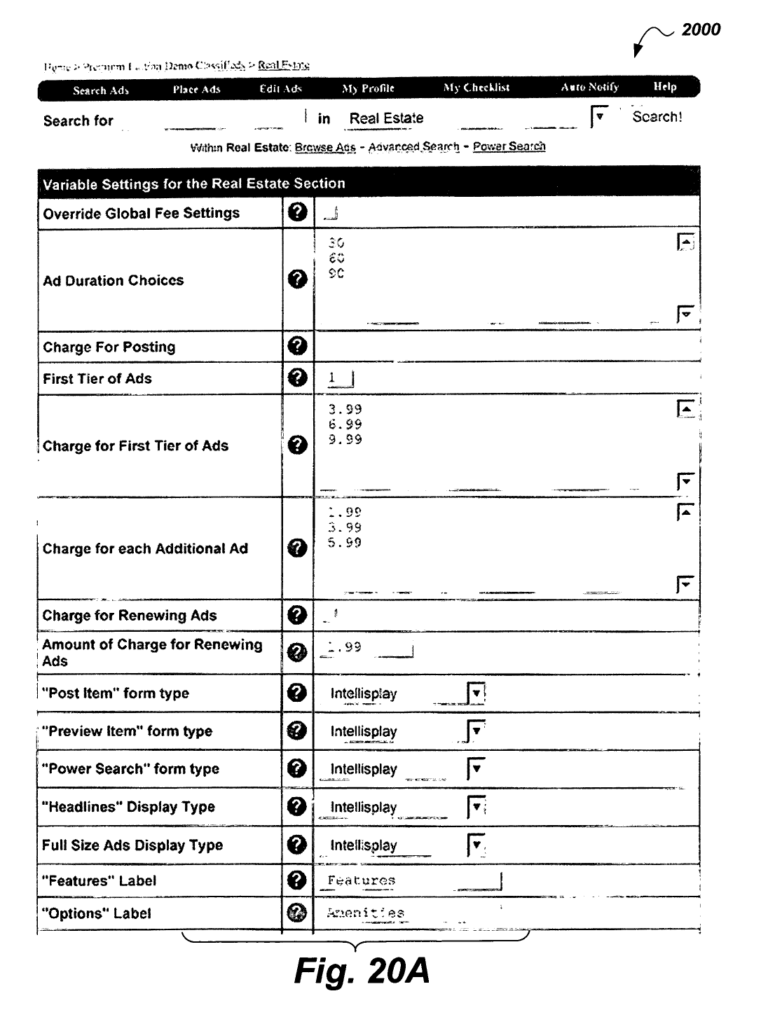

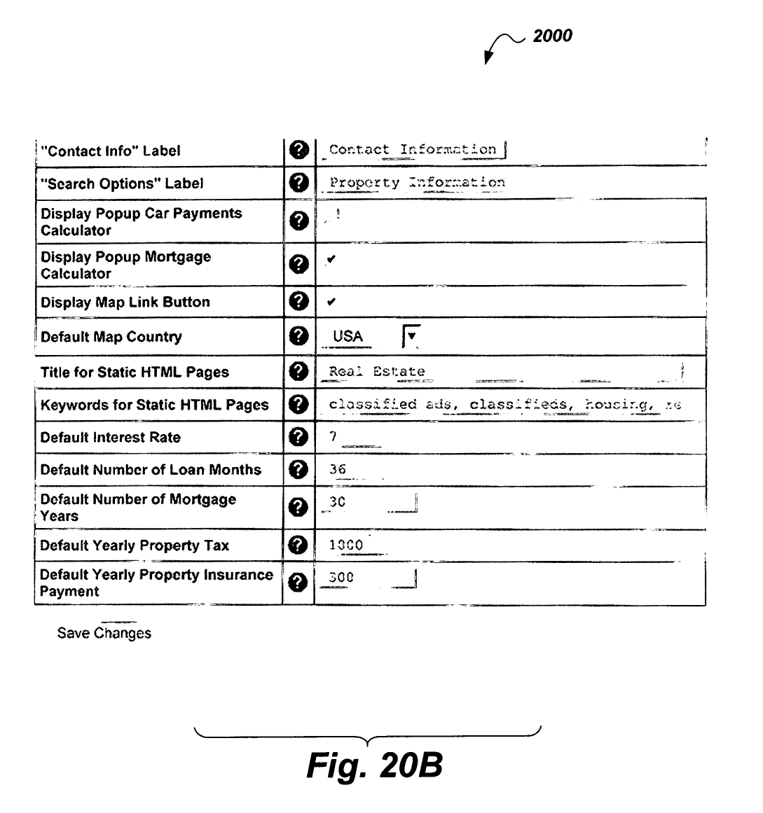

FIGS. 20A and 20B outline the variable settings for the real estate section 2000. These settings can be customized for each section. Specific settings include over-riding global fee settings, ad duration choices, charge for posting, number of first tier of ads, charge for first tier of ads, charge for each additional ad as well as the amount of the charge for renewing ads. There are also three form types for a “post item” form type, a “preview item” form type, a “power search” form type, a “headlines” display form type and full size ads display type. These form types are custom predefined, auto-generate and Intellisplay. A custom predefined form type is a manual edit format with full text, while an auto-generate form type utilizes simple check boxes and dropdown menus. The Intellisplay form type employs a combination of full text and simple check boxes and dropdown menus. The Intellisplay option makes intelligent guesses about where in these forms to display the various database fields for this section, based upon settings in the database definition file.

Several labels are also outlined in the variable setting format. The “features” label, the “options” label, the “contact info” label and the “search options” label, all have type-in entries to name the label used on the form types. Other supplementary features include a pop-up car payments calculator, a pop-up mortgage calculator, a map link button, a default map country setting dropdown menu, a title for static HTML pages and keywords for static HTML pages, which are in the form of typed-in text. A default interest rate, a default number of loan months, a default number of mortgage years, a default yearly property tax and a default yearly property insurance payment can also be entered.

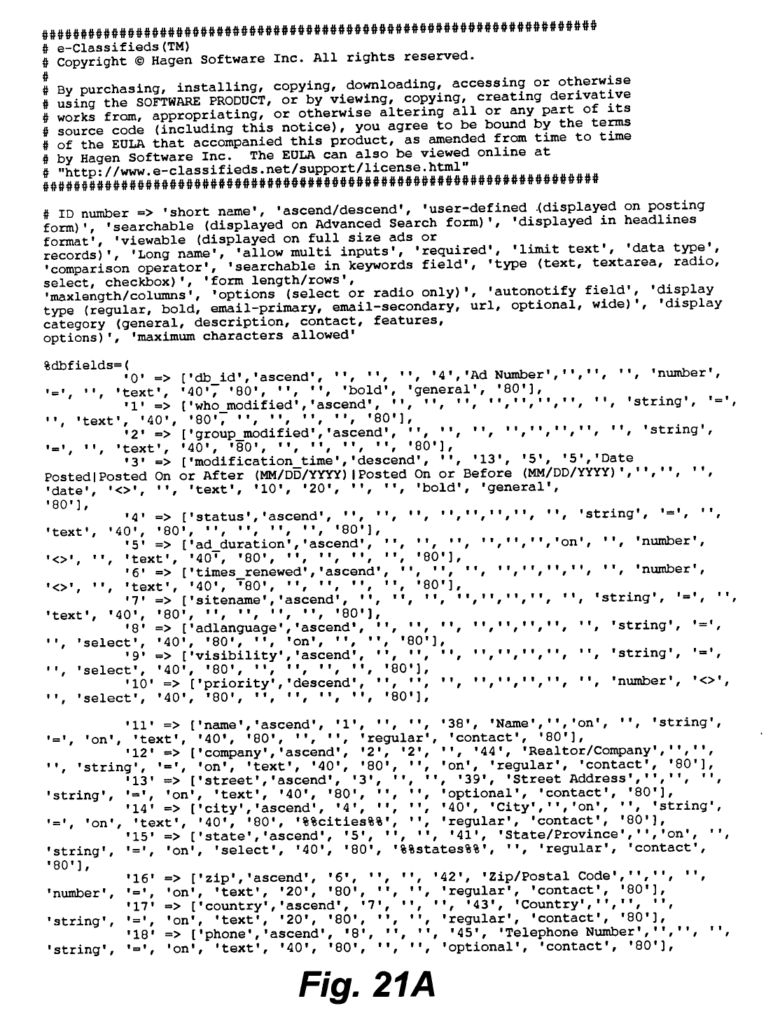

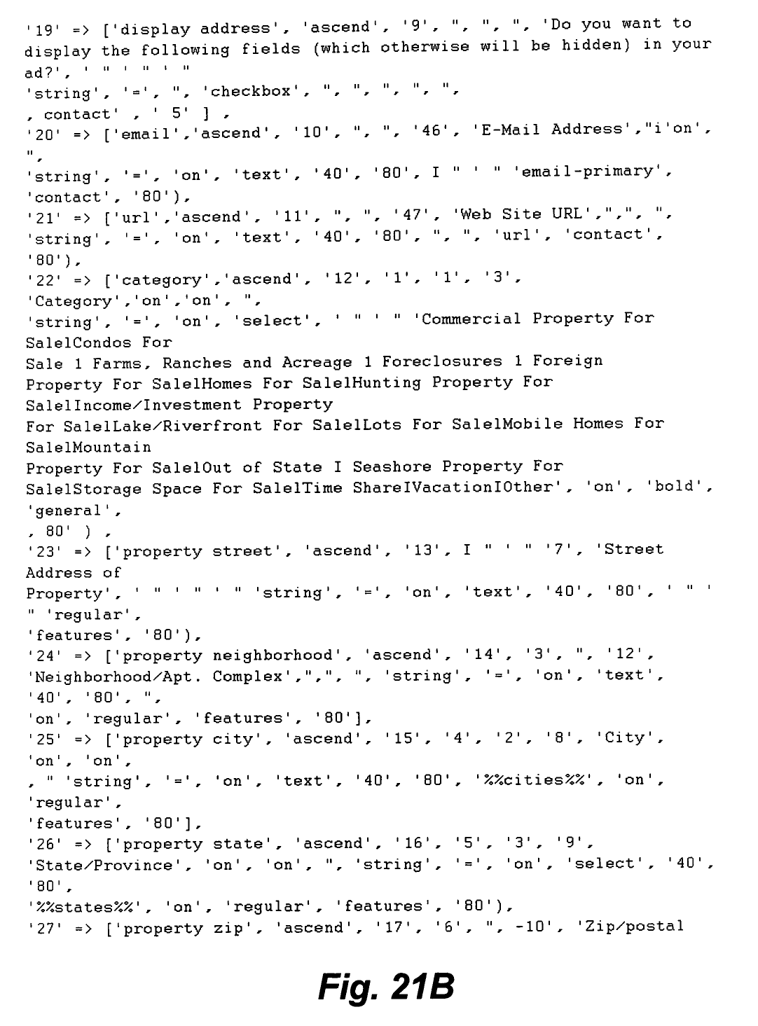

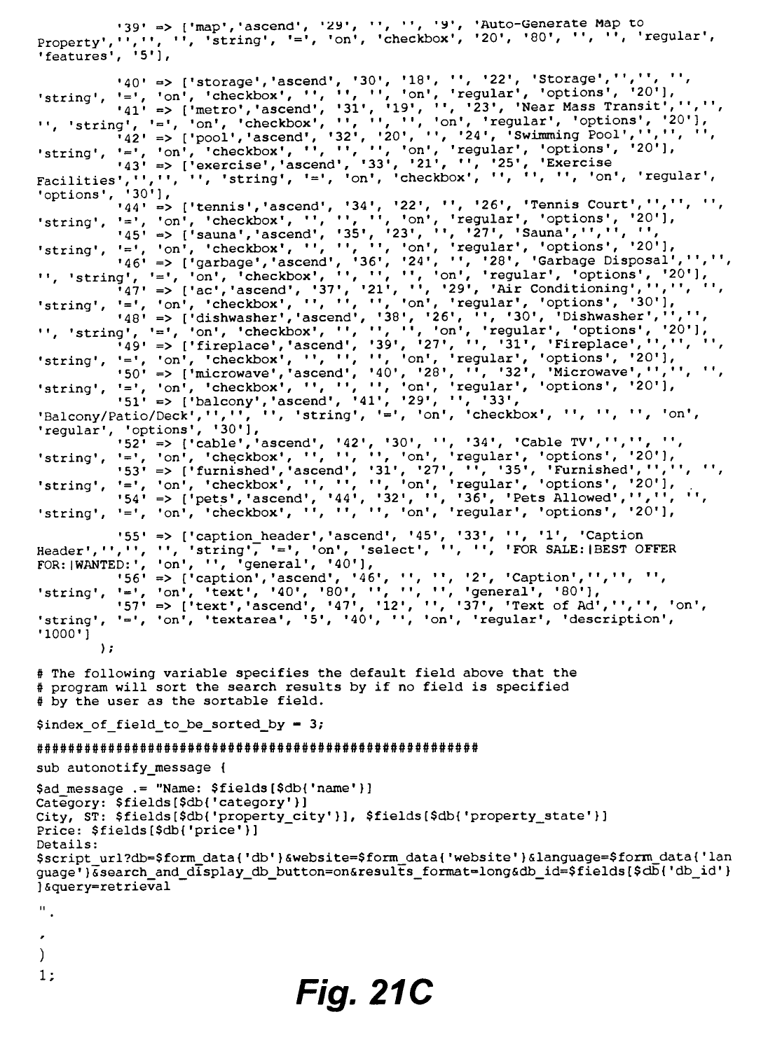

FIGS. 21A-21C depict the database definition file. The database definition file enables the administrator to customize the database fields for each classified ads section. This is achieved through the usage of a database definition file that describes the fields for each section, along with twenty-two characteristics that can be defined for each database field. These characteristics include the unique database field number, the short name for this field, whether the data for this field should be displayed in ascending or descending order by default, whether this field will be displayed on the Post Ad form, whether this field will be included in the Power Search form, whether this field will be displayed in the headlines (short) format for the ad displays, whether this field will be displayed in the long (full size) format for the ad displays, the long name for this field.

These characteristics also include whether users will be able to search on multiple values from dropdown select menus for this field in the Power Search form, whether users will be required to enter a value for this field when posting the ads, the data type for this field (string, number or date), the comparison operator used by the program when conducting searches, whether this field will be among the fields that are searched when users conduct a general keyword search, the HTML form input type for this field (such as text, textarea, radio, select or checkbox), the length for text input fields or the number of rows in the textarea box, the maximum number of characters that users may enter in the text field or the number of columns in the textarea box, the default values for dropdown menus or radio buttons, whether this field should be an auto-notify field, the display method for this field in the ads displays, the display category for this field if Intellisplay is being used, and the maximum number of characters that users will be able to enter into the database for this field.

The system also contains a powerful search engine that has been optimized for nine different types of searches. Specifically, it can conduct searches where the user is browsing all ads; keyword searches on a particular keyword or phrase that the user enters; advanced searches on several criteria such as keywords, category, type, date range, boolean terms (any keywords, all keywords or exact phrase), and multimedia attachments (photos, sound clips, video clips); category searches for ads in a specific category within a section; searches for all ads in this section or across all databases posted by a particular user; retrieval of a specific ad by its ad number; searches for all ads that have been checklisted by the current user; searches for a specific ad to be edited by the current user; and power searches that can search across all fields in a particular database, including fields that have been custom-defined for this particular database by the admin.

Unlike most database systems, the system contains the ability to conduct a keyword search not only with a specific database, but across multiple databases. Once a user has registered with the system and has logged on, the system has the ability to remember this user's username and password and to automatically enter them into the logon forms the next time that this user uses the system and attempts to log on again.

Once a user has registered with the system, it stores a number of items for this user, including the user's contact information, such as his or her street address, city, state, zip code, country, telephone number, e-mail address and Web site URL (if any). In order to simplify the process of posting an ad and save the user from having to enter redundant information each time that user posts an ad on the system, it can automatically insert the user's contact information in the appropriate fields on the Post Ad form. The system also enables a user who is posting a new ad to the system to preview the ad before actually posting it to the system. That way, the user can see how the ad looks in the system and go back and make any necessary changes before committing the ad.

As illustrated in FIGS. 5A and 5B, the Template Editor 511 enables the Administrator to modify the HTML for the general page layout of all pages generated by the system. The Template Editor 511 also allows the administrator to create customized page displays for each of the top-level sections, as well as for each affiliate web site (and even for each section within each web site). There are several pre-defined templates to choose from, or an administrator can create their own either by entering the raw HTML code or importing it from a file created by another HTML editor such as Dreamweaver or Frontpage, etc. It is also possible to modify the HTML and system code contained in the “Objects” used in the Template Editor 511. The administrator can also move “objects” for various items such as advertising banners, the navigation bar, and more around the page. Other template driven systems are typically more restrictive in allowing these types of changes.

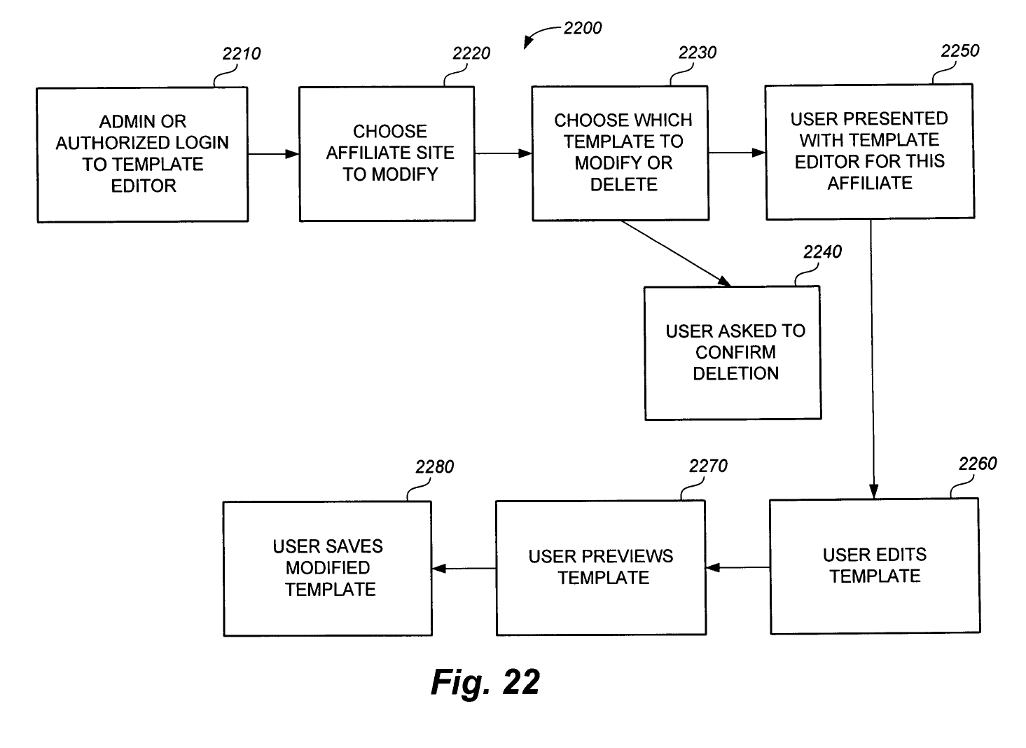

The Template Editor flow 2200 is illustrated in FIG. 22. When the page layout for a particular section is to be modified, the administrator or authorized user logins to the Template Editor 2210 and the appropriate section is selected 2220. For a default template, if a template already exists for that section, the option exists of editing or deleting that template via the “Edit” and “Delete” buttons 2230. If a template does not currently exist for that section, these buttons are not displayed, and a “Create” button is displayed instead.

If the administrator chooses to modify the default template for the default affiliate, which is the flagship site of a user, the template presented has special meaning, since it is used for all sections that do not have their own templates, as well as for all other affiliates that do not specify their own templates. In other words, the templates that are created are the ultimate “fallback” templates that are used whenever a particular section and/or affiliate does not have a template of its own.

A template is selected from the template options on the left hand side of the form 2230. Initially, the current template (if any) is automatically entered into the form below. A new template can be used by selecting “Current”. “Blank” can be selected to clear the form below. To preview the other templates, each one can be selected and then the “Preview” button below can be clicked.

The options on the left hand side of the form that are created are used to add Objects or various HTML tags to the template. If a template is created offline in an HTML editor such as Frontpage or Dreamweaver, the code from that page can be copied and pasted into the form below using the appropriate commands for a computer (for example, Windows users can click at the spot in the form below where they want to insert the copied text and then simultaneously press the Control and the V keys to paste text from the clipboard into the form below).

The work can be previewed at any time by clicking on the “Preview Template” 2270. If the template is satisfactory, the “Save Template” button can be clicked below 2280. This process can be repeated for new templates.

As illustrated in FIGS. 5A and 5B, the Set Visibility Options option 512 enables the administrator via the Control Panel to define the Visibility options, if any, that are available to Ad posters who wish to pay an extra fee to raise the visibility of their Ad. These options might include displaying the Ad in bold text, in red text, with an extra graphic, or in some other manner.

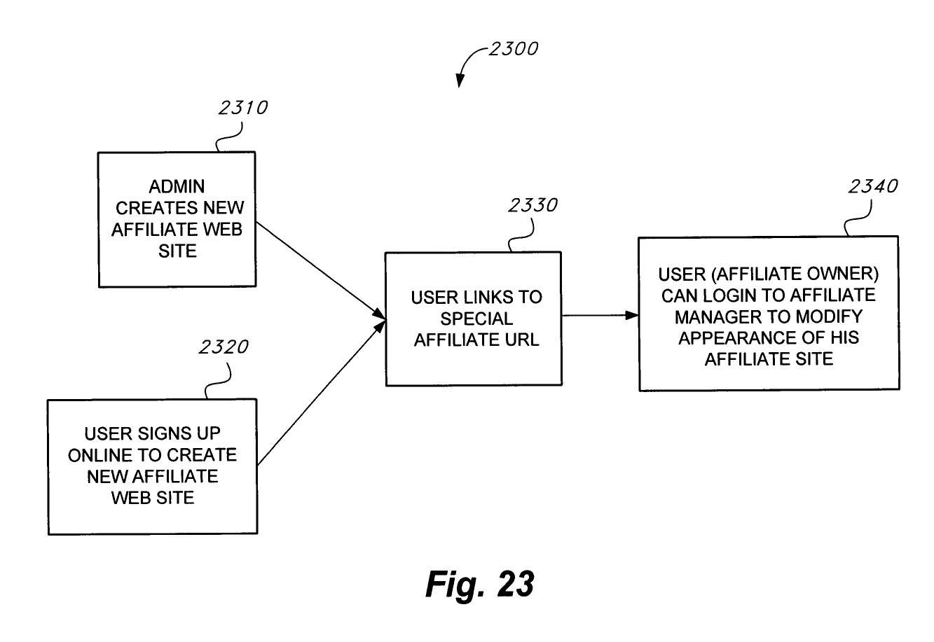

FIG. 23 illustrates affiliate web site signup by end users 2300. If the administrator has allowed and created affiliate web sites 2310, an end user sees a link for signing up as an affiliate web site 2320. The link takes the end user to a signup form developed by the administrator 2330. After signup, the new affiliate owner can modify the appearance of his/her site while still accessing one database 2340.

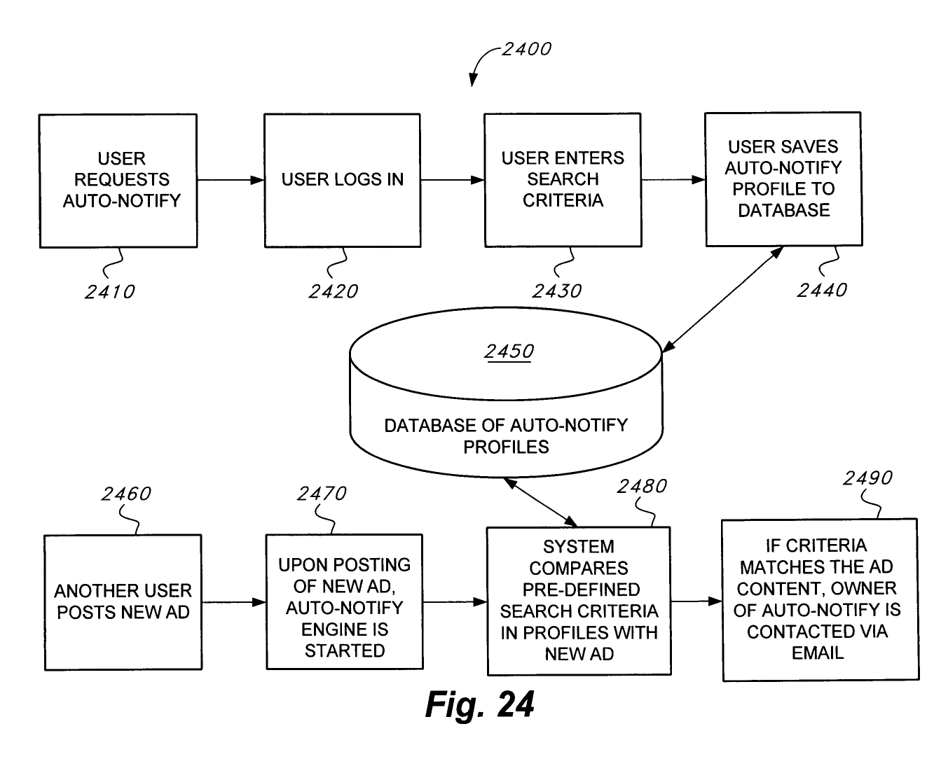

As illustrated in FIG. 24, subscribing to the Auto-Notify feature 2400 enables an end user to set up a personal search agent that automatically sends an end user new Ads that match the keywords or the full database criteria that an end user defines here. An end user is able to set the number of days that their personal search agent should operate before it automatically expires. To set up an Auto-Notify agent 2410, the Auto-Notify link in the navigation bar is clicked.

From the Auto-Notify options page, the Create Agent button is clicked. An end user is prompted to log in. If an end user has already registered, an end user can enter their username and password in the logon form 2420. If an end user has not already registered, the end user must register in order to use this feature. Once an end user has logged in, keywords and other criteria 2430 are specified (such as the category or type of Ads) that their search agent uses when looking at new Ads. If an end user wants to define a sophisticated database search, an end user can do so by clicking on the “Advanced Search” link. An end user is then be able to set up a sophisticated search agent specifying specific criteria, such as the city, number of bedrooms, specific amenities, or other options, depending on the section that an end user is in. An end user can also specify ranges, such as retrieval only of Ads for apartments that cost between $600 and $900 per month, that have at least one but not more than three bedrooms, that are located in a specific city or neighborhood, and that have a fireplace and are near mass transit. The end user then saves his Auto-Notify profile 2440.

The system responds to the receipt of a new ad by storing the new ad in the ad database 2450, and by comparing the new ad to personal search agents 2480, to determine if any of the ads match the search agents. If a match is determined to exist, the system generates output data that includes the new ad, plus delivery data from the matching ads. When new Ads are posted to the system that match the criteria, an end user is notified by e-mail, including a link to the Ads 2490.

An end user can modify or delete their Auto-Notify search agent at any time by logging on to the system using their username and password (if not already logged in) and clicking on the Auto-Notify link in the navigation bar and then choosing Modify Agent or Delete Agent from the Auto-Notify options page. An end user logs on to the system in order to modify or delete their profile.

The significant advantages provided by the present invention are apparent from the above description. The present invention provides a computer based system that is significantly more convenient for administrators, advertisers and end users. In contrast to the conventional newspaper system, the system of the present invention does not require the buyer to scan a large number of ads, or to repeatedly scan new editions of the newspaper. The ability to search all of the information in an ad using conventional text database techniques is combined with the convenience of audio and video output. New ads are instantly available, creating a real time system. Thereafter, whenever a lister places a new ad, an end user may be automatically and immediately notified of the contents of the new ad.

It is important to note that the present invention and all of the features described above are not limited to classified advertising such as the sale or lease of real estate. Instead, the service and convenience provided by the system are equally applicable for matching the requirements of parties to any transaction involving the display, transfer, matching, swap or exchange of an interest or item, for virtually any type of personal or real property. For example, it should be apparent that the present invention can also be employed in the sale or lease of used automobiles or boats, horses, etc.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A computerized classified advertising system comprising:
at least one server computer having a processor, an area of main memory for executing program code under the direction of the processor, a storage device and read only memory for storing data and program code and a bus connecting the processor main memory and the storage device;
at least one database format stored on said storage device;
a communications device connected to said bus for connecting said server computer to the Internet;
a cursor control device to manipulate and control a cursor;
a keyboard to enter letters and numbers;
a display monitor to illustrate information and program code; and
a classified advertising computer code stored in said storage device and executing in said main memory under the direction of the processor, the computer program including:
means for performing system search functions;
means for updating an ad profile;
means for setting system variables, general variables, appearance variables, ad banner variables and multimedia variables;
means for establishing a fee based ad;
means for registering a user;
means for setting up maintenance options;
means for setting up a backup manager, a visibility options manager and a priority ranking options manager; and
means for setting up an affiliated Web site and an auto-notify function.

2. The system according to claim 1, wherein links to an overall site home page, the system home page, a current section and a current category are provided.

3. The system according to claim 2, wherein the current sections include an announcement section, an automobile section, a business opportunities and services section, a collectibles section, a computers section, an employment opportunities section, a general merchandise section, a personal ads section, a real estate section and a rentals and roommates section.

4. The system according to claim 1, wherein a navigation bar and supplemental links are provided.

5. The system according to claim 4, wherein the supplemental links are to search ads, to place ads, to edit current ads, to go to a control panel, to establish a checklist link, to establish an auto-notification link and to receive help.

6. The system according to claim 5, wherein to establish a checklist link includes marking ads that have been selected for future recall and viewing by the system.

7. The system according to claim 5, wherein to establish an auto-notification link includes allowing a user to create, modify or delete a personal search agent that will automatically send new ads by e-mail to the user that match a predefined criteria.

8. The system according to claim 1, wherein a search box is provided with links that allow a user to browse ads, to perform keyword searches with Boolean options, case sensitive searching, date range searching and searching for ads with multimedia attachments (photos, sound clips and video clips) and to perform database searches on specific criteria and ranges.

9. The system according to claim 1, wherein said system utilizes common gateway interface binaries (CGI-BIN) and common gateway interface script.

10. The system according to claim 1, wherein a correct mail system and e-mail system for the user's server is provided.

11. The system according to claim 1, wherein a capability to disable all of the system's e-mail is provided.

12. The system according to claim 1, wherein a capability for a master shutdown of the system is provided.

13. The system according to claim 1, wherein a server offset is used to modify the time obtained by the system.

14. The system according to claim 1, wherein a log of all end user activity on the system can be provided.

15. The system according to claim 1, wherein users can exchange e-mail without revealing their respective e-mail addresses.

16. The system according to claim 1, where offensive words can be prevented from being in any of the ads.

17. The system according to claim 1, where the color, size and format of any ads are set.

18. The system according to claim 1, wherein ad banners are rotated throughout the system.

19. The system according to claim 1, wherein photos, sound clips, video clips and multimedia clips can be uploaded onto the system.

20. The system according to claim 1, wherein the file size and format for uploaded photos, sound clips, video clips and multimedia clips are set.

21. The system according to claim 20, wherein photos are displayed as thumbnails.

22. The system according to claim 1, wherein a spam guard is provided.

23. The system according to claim 1, wherein a credit card processing secure transaction service is provided.

24. The system according to claim 1, wherein a secure sockets layer method is utilized when users submit their credit card information.

25. The system according to claim 1, wherein revenue, current receivables, past due receivables and refunds receipts are automatically tabulated.

26. The system according to claim 1, wherein specific users are blocked from registering on the system.

27. The system according to claim 1, wherein allowed users can automatically search for other usernames.

28. The system according to claim 1, wherein the number of ads in a section are indicated.

29. The system according to claim 1, wherein the number and length of new users is limited.

30. The system according to claim 1, wherein a password is sent to newly registered users.

31. The system according to claim 30, wherein a password is e-mailed to newly registered users.

32. The system according to claim 1, wherein ad expiration notices are automatically sent to users.

33. The system according to claim 1, wherein expired ads are automatically purged from the system.

34. The system according to claim 1, wherein an automatic backup of files is provided.

35. The system according to claim 1, wherein an installation wizard is utilized to install the system.

36. The system according to claim 1, wherein users can sign up and create affiliated Web sites through an online signup form.

37. The system according to claim 1, wherein said system performs a global text search across a plurality of databases.

38. The system according to claim 1, wherein a user can preview an ad before it is posted.

39. The system according to claim 1, wherein said system has customizable database fields.

40. The system according to claim 1, wherein said system has the ability to remember a user's username and password for logging onto during future visits.

41. The system according to claim 1, wherein a user registration system automatically inserts a user's contact information into appropriate fields on a Post Ad form.

42. The system according to claim 41, wherein said user's contact information is the user's contact information includes a street address, city, state, zip code, country, telephone number, e-mail address and Web site URL.

43. A computer program product that includes a medium readable by a processor, the medium having stored thereon a set of instructions for a computerized classified advertising system, comprising:
a first sequence of instructions which, when executed by the processor, causes said processor to perform system search functions;
a second sequence of instructions to update an ad profile;
a third sequence of instructions to set system variables, general variables, appearance variables, appearance variables, ad banner variables and multimedia variables;
a fourth sequence of instructions to establish a fee based ad;
a fifth sequence of instructions to register a user;
a sixth sequence of instructions to set up maintenance options;
a seventh sequence of instructions to set up a back up manager, a visibility options manager and a priority ranking options manager; and
an eighth sequence of instructions to set up an affiliated Web site and an auto-notify function.

44. A computerized method for a classified advertising system over the Internet, said method comprising the steps of:
performing system search functions;
updating an ad profile;
setting system variables, general variables, appearance variables, ad banner variables and multimedia variables;
establishing a fee based ad;
registering a user;
setting up maintenance options;
setting up a backup manager, a visibility option manager and a priority ranking options manager; and
setting up an affiliated Web site and an auto-notification function.
